(19) United States
(12) Patent Application Publication
(10) Pub. No.: US 2023/0028034 A1
(43) Pub. Date: Jan. 26, 2023

(54) MULTI-ZONE AUTOMATED STORAGE AND RETRIEVAL SYSTEM

(71) Applicant: ATTABOTICS INC., CALGARY (CA)

(72) Inventors: SCOTT GRAVELLE, CALGARY (CA); ROBERT WINSTON HOPE, CALGARY (CA); DARIN ROUSSEAU, CALGARY (CA); SUNDEEP DHALIWAL, CALGARY (CA); DOUGLAS LANGEN, CALGARY (CA)

(21) Appl. No.: 17/681,762

(22) PCT Filed: Aug. 25, 2020
(86) PCT No.: PCT/IB2020/057931

§ 371 Date: Feb. 26, 2022

Related U.S. Application Data
(60) Provisional application No. 62/891,549, filed on Aug. 26, 2019.

(51) Int. Cl. B65G 1/137

(52) U.S. Cl. CPC B65G 1/1373

(57) ABSTRACT

A multi-zone automated storage and retrieval system (ASRS) and a method for controlling operation of robotic storage/retrieval vehicles (RSRVs) therein are provided. The multi-zone ASRS includes first and second storage zones isolated by at least one barrier and including first and second groups of storage locations respectively for accommodating storage units therein. The multi-zone ASRS includes one or more portals opening through the barrier(s) between the storage zones, and at least one track layout. The track layout(s) includes first and second track areas occupying the first and second storage zones respectively, and one or more connective track segments interconnecting the first and second track areas through the portal(s). The RSRVs deposit and retrieve the storage units to and from the storage locations and travel on the first and second track areas via the connective track segment(s) to respectively access the first and second groups of storage locations therefrom.

### CROSS-REFERENCE TO RELATED APPLICATIONS

This application is a national stage application of the Patent Cooperation Treaty (PCT) international application titled “Multi-zone Automated Storage and Retrieval System”, international application number PCT/IB2020/057931, filed in the Receiving Office of the International Bureau of the World Intellectual Property Organization (WIPO) on Aug. 25, 2020, which claims priority to and the benefit of the provisional patent application titled “Multi-Zone ASRA Structure, and Auto-Induction Processes Employing Bin Consolidation and Bin Exchange Techniques”, application No. 62/891,549, filed in the United States Patent and Trademark Office (USPTO) on Aug. 26, 2019. The specifications of the above referenced patent applications are incorporated herein by reference in their entirety.

### BACKGROUND

### Technical Field

The embodiments herein, in general, relate to automated storage and retrieval systems, order fulfillment, and supply chain logistics. More particularly, the embodiments herein relate to a multi-zone automated storage and retrieval system and auto-induction processes employing consolidation and exchange of storage units.

### Description of the Related Art

A conventional supply chain comprises a series of discrete transactional entities, for example, manufacturers, producers, suppliers, vendors, warehouses, transportation companies, distribution centers, order fulfillment centers, retailers, etc. Supply chain management allows sourcing and delivery of inventory from manufacturers and producers to end customers and end users. Several technologies have emerged that are altering conventional methods of managing a supply chain. Customer demand for individualized products and stronger granularization of orders are growing. Customers also rely on the availability of product items that can be purchased in different temperature states, for example, chilled, refrigerated and frozen states. As electronic commerce (e-commerce) continues to grow at a significant rate and overtake conventional brick and mortar retail practices, many businesses are facing notable challenges of maintaining or gaining relevance in an online marketplace and being able to compete with prominent players in the space.

Supply chain management require systems that execute storage and retrieval of a large number of different products. For example, e-commerce and retail platforms that sell multiple product lines require systems that are able to store hundreds of thousands of different product lines having different temperature requirements. Different product items need to be maintained at different prescribed temperatures within a storage system, while the product items are stored and/or transported, and/or while orders are fulfilled. Some product items need to be maintained in a chilled or frozen environment to ensure freshness, while other product items can be stored or transported at ambient temperature. Conventional systems typically require a walk-in cooler or freezer to be pre-constructed or additional components to be installed around a storage system, which substantially expands a two-dimensional (2D) footprint of the storage system and increases the cost and complexity of installing and operating the storage system across multiple environmentally controlled zones. There is a need for a freestanding, high density, automated storage and retrieval system with multiple integrated, environmentally controlled zones that eliminates construction of walk-in, environmentally controlled zones to buildings and installation of separate storage systems operating independently within each environmentally controlled zone.

Moreover, supply chains and warehouse operations of conventional e-commerce and retail platforms are substantially dependent on their ability to organize, control, store, retrieve, and return product items to various storage units. In some of these implementations, robotic or automated mechanisms are used for managing the storage units and operations related to the contents of the storage units. These mechanisms navigate through one or more grids of conveyor systems and transportation paths to access the storage units for a variety of different operations, for example, inducting a storage unit into a storage system, retrieving a storage unit from the storage system, moving the storage unit from one location or workstation to another for handling, conducting operations upon the storage unit, returning the storage unit to a location or a workstation in a warehouse or to the storage system, etc. There is a need for optimally coordinating the movement of one or more robotic or automated mechanisms with respect to a storage system for improving storage and retrieval of a large number of different product items having different temperature requirements. Some systems require different groups or classes of robotic handlers that are configured to operate in different environmentally controlled zones of a storage system. There is a need for a common class of robotic handlers that are configured to operate in all the different environmentally controlled zones with optimized buffering of the robotic handlers within the storage system when the robotic handlers transition between the different environmentally controlled zones.

Furthermore, there is a need for providing convenient access to storage units within a storage system and maintaining the prescribed temperature of the storage units containing product items that require a cooled temperature by avoiding exposure of the storage units to an uncooled environment which may affect the quality and freshness of these product items. Some conventional storage facilities comprise storage systems and a fleet of robotic handlers disposed in a cooled, chilled or freezer environment. In these facilities, the robotic handlers reside and operate in the cooled, chilled or freezer environment on a full-time basis, which may substantially affect the operating characteristics of the robotic handlers. Other conventional systems allow robotic handlers to traverse only an upper track of a storage system, thereby allowing operation of the robotic handlers in generally ambient temperature conditions when riding atop the track, and exposure to colder temperatures of cooled storage columns when operating over the cooled storage columns from which insulating covers have been removed to access the storage units therein. There is a need for reducing exposure of robotic or automated mechanisms to non-ambient, cooled, chilled or freezer environments while these mechanisms operate in a storage system, as increased exposure may adversely affect their circuitry and componentry and reduce their throughput performance. Moreover, there is a need for optimal positioning of workstations with respect to a storage system, continuous to all environmentally controlled zones, such that all robotic or automated mechanisms and therefore all storage units from each environmentally controlled zone are accessible at all workstations, thereby allowing order pickers to work in the comfort of ambient temperatures while picking product items that are chilled or frozen. Furthermore, storage units are typically stacked on top of each other and accessed with an unstacking method. The stacking method constrains air flow and requires a plenum to circulate cold air throughout the storage units in storage and a large number of air circulating devices.

Furthermore, a conventional supply chain does not incorporate material handling equipment in all its entities for performing various supply chain activities and inventory exchanges between the entities. There is a need for an exchange technique of forward and reverse storage units during auto-induction at a transactional entity, for example, a micro-fulfillment center from a servicing distribution center during a replenishment process. There is a need for improving shipping and receiving processes and eliminating associated staging areas in micro-fulfillment and distribution center sites to substantially reduce labor, real estate and resource requirements while streamlining logistics, and to make operations predictable, orderly, and easier to monitor in real time over disorderly, chaotic approaches used in conventional supply chains.

Hence, there is a long-felt need for a self-contained, freestanding, multi-zone automated storage and retrieval system having different, vertically delineated, environmentally controlled zones for storing multiple different product items requiring varying degrees and types of environmental control parameters, and optimally controlled robotic storage/retrieval vehicles and conveniently accessible storage units configured to operate in these different environmentally controlled zones, which address the above-recited problems associated with the related art.

### SUMMARY

This summary is provided to introduce a selection of concepts in a simplified form that are further disclosed in the detailed description. This summary is not intended to determine the scope of the claimed subject matter.

The embodiments herein address the above-recited need for a self-contained, freestanding, multi-zone automated storage and retrieval system (ASRS) having different, vertically delineated, environmentally controlled zones for storing multiple different product items requiring varying degrees and types of environmental control parameters, and optimally controlled robotic storage/retrieval vehicles (RSRVs) and conveniently accessible storage units configured to operate in these different environmentally controlled zones. The environmentally controlled zones are temperature zones, for example, ambient, chilled and freezer zones of varying environmental control parameters. The environmentally controlled zones in the multi-zone ASRS do not share the same footprint. The multi-zone ASRS maintains different product items at different prescribed temperatures therewithin, while the product items contained within storage units are stored and/or transported, and/or while orders are fulfilled. The multi-zone ASRS is a freestanding, high density, ASRS with multiple integrated, environmentally controlled zones.

The multi-zone ASRS disclosed herein comprises a plurality of storage locations configured to accommodate placement and storage of storage units therein. The multi-zone ASRS further comprises a first storage zone, a second storage zone, at least one barrier, one or more portals, at least one track layout, and one or more RSRVs. The first storage zone comprises a first group of storage locations. The second storage zone comprises a second group of storage locations. In an embodiment, the first storage zone and the second storage zone differ from one another in environmental control equipment installed therein or operating characteristics of the environmental control equipment. In another embodiment, the first storage zone or the second storage zone is a cooled storage zone having a lower environmental operating temperature than the other of the first storage zone and the second storage zone.

The barrier(s) isolates the second storage zone from the first storage zone. The portal(s) opens through the barrier(s) between the first storage zone and the second storage zone. The track layout(s) comprises a first track area occupying the first storage zone, a second track area occupying the second storage zone, and one or more connective track segments interconnecting the first track area and the second track area through the portal(s) configured in the barrier(s). In an embodiment, the track layout comprises an upper track layout positioned above the storage locations. In this embodiment, the barrier(s) comprises an upper portion standing upright from the upper track layout, and the portal(s) is configured to open through the barrier(s) at the upper portion thereof to accommodate a connective track segment of the upper track layout that interconnects the first track area and the second track area of the upper track layout. In an embodiment, the barrier isolating the second storage zone from the first storage zone comprises an upright barrier wall separating the first storage zone and the second storage zone. The connective track segment(s) spans through the portal(s) from one side of the upright barrier wall to another side of the upright barrier wall.

In another embodiment, the track layout comprises a lower track layout positioned below the storage locations. In this embodiment, the barrier(s) comprises a lower portion standing upright from the lower track layout, and the portal(s) is configured to open through the barrier(s) at the lower portion thereof to accommodate a connective track segment of the lower track layout that interconnects the first track area and the second track area of the lower track layout. In an embodiment, the storage units stored in the first group of storage locations and the second group of storage locations are accessible by any one of a plurality of workstations attached to the lower track layout that extends continuous to the first storage zone and the second storage zone. The multi-zone ASRS provides convenient access to the storage units and maintains a prescribed temperature of the storage units containing product items that require a cooled temperature by avoiding exposure of the storage units to an uncooled environment. The embodiments herein implement optimal positioning of workstations with respect to the multi-zone ASRS, continuous to all environmentally controlled storage zones, such that all RSRVs and therefore all storage units from each environmentally controlled storage zone are accessible at all workstations, thereby allowing order pickers to work in the comfort of ambient temperatures while picking product items that are chilled or frozen.

In an embodiment, the track layout(s) is positioned above the storage locations of the multi-zone ASRS. In this embodiment, the second storage zone comprises an enclosed attic space positioned above the track layout(s) and isolated from the first storage zone. The enclosed attic space is delimited by boundary walls of the second storage zone. At least one of the boundary walls is separate and discrete from building walls of a facility that accommodates the multi-zone ASRS. The enclosed attic space is isolated from the first storage zone and from a surrounding space of the facility. In an embodiment, the boundary walls of the enclosed attic space are separate and discrete from the building walls of the facility. In an embodiment, the boundary walls are mounted to frame members of a gridded storage structure of the multi-zone ASRS that delimits the second group of storage locations. In another embodiment, the first storage zone is free of the enclosed attic space and is open to a surrounding environment of the facility that accommodates the multi-zone ASRS. In this embodiment, the environmental control equipment is mounted in the enclosed attic space of the second storage zone.

The multi-zone ASRS comprises a common class of robotic handlers or RSRVs that are configured to operate in all the different environmentally controlled storage zones with optimized buffering of the RSRVs within the multi-zone ASRS when the RSRVs transition between the different environmentally controlled storage zones. The upper track layout and the lower track layout of the multi-zone ASRS allow transitioning of the RSRVs to the different environmentally controlled storage zones. The RSRV(s) is configured to deposit and retrieve the storage units to and from the storage locations. The RSRV(s) is further configured to travel on the track layout(s) on both the first track area and the second track area to respectively access the first group of storage locations and the second group of storage locations therefrom. The RSRV(s) is further configured to travel between the first track area and the second track area via the connective track segments connected therebetween. In an embodiment, the storage locations of the multi-zone ASRS are arranged in storage columns configured to receive the placement of the storage units therein. The RSRV(s) is configured to travel on at least one track layout between access locations at which different storage columns are accessible by the RSRVs to deposit and retrieve the storage units into and from the storage columns. In an embodiment, the access locations comprise unoccupied access shafts around which the storage columns are clustered and through which the RSRVs are configured to travel to access multiple levels of the storage columns. Each of the unoccupied access shafts is neighbored by at least one of the storage columns to and from which the storage units are placeable and retrievable by the RSRVs from within each of the unoccupied access shafts.

In an embodiment, the multi-zone ASRS further comprises a third storage zone isolated from both the first storage zone and the second storage zone by at least one additional barrier. The third storage zone comprises a third group of storage locations. The multi-zone ASRS further comprises at least one additional portal opening through the additional barrier(s) between the third storage zone and at least one of the first storage zone and the second storage zone. The additional portal(s) is configured to accommodate travel of the RSRV(s) therethrough. In an embodiment, the additional portal(s) comprises portals opening to both the first storage zone and the second storage zone. In an embodiment, the additional barrier(s) comprises an upper portion standing upright from the upper track layout of the multi-zone ASRS. In this embodiment, the additional portal(s) comprises at least one upper portal opening through the additional barrier(s) at the upper portion thereof. The first storage zone, the second storage zone, and the third storage zone differ from one another in environmental control equipment installed therein or operating characteristics of the environmental control equipment. The first storage zone, the second storage zone, and the third storage zone are accessible by the RSRV(s).

In an embodiment, the multi-zone ASRS further comprises one or more buffer spots. Each of the buffer spots is positioned at a location on the track layout(s) and accessible by the RSRV(s) from the track layout(s). Each of the buffer spots is configured to temporarily hold one of the storage units thereon. In an embodiment, at least one of the buffer spots is positioned proximal to a respective one of the portals. In an embodiment, one or more buffer spots comprise a plurality of buffer spots. In this embodiment, at least one of the buffer spots is positioned in each of the first storage zone and the second storage zone.

The multi-zone ASRS further comprises a computerized control system (CCS) in operable communication with the RSRVs. The CCS comprises a network interface coupled to a communication network, at least one processor coupled to the network interface, and a non-transitory, computer-readable storage medium communicatively coupled to the processor(s). The non-transitory, computer-readable storage medium of the CCS is configured to store computer program instructions, which when executed by the processor(s) of the CCS, cause the processor(s) to control operation of the RSRVs in the multi-zone ASRS. As part of a retrieval task associated with the second storage zone requiring retrieval of a targeted one of the storage units stored in the second storage zone, the CCS assigns the retrieval task associated with the second storage zone to a first RSRV selected from among the RSRVs located in the first storage zone; and issues commands to the first RSRV to: (a) travel into the second storage zone via one of the portals opening thereinto from the first storage zone; and (b) during the travel, prior to entering the second storage zone through that portal, drop off one of the storage units currently carried on the first RSRV at one of the buffer spots in the first storage zone.

In additional steps of the retrieval task associated with the second storage zone, the CCS further issues commands to the first RSRV to: upon entry into the second storage zone, pick up a buffered storage unit from one of the buffer spots in the second storage zone; travel from that buffer spot in the second storage zone toward an access location in the second storage zone from which the targeted storage unit stored in the second storage zone is retrievable; and prior to retrieving the targeted storage unit at the access location, deposit the picked up storage unit into an available one of the storage locations in the second storage zone. In an embodiment, the CCS selects the available storage location in the second storage zone from among any of the storage locations available upstream and positioned en route from the buffer spot in the second storage zone to the access location, and/or any of the storage locations available downstream and positioned en route from the access location to an exit portal.

The CCS completes the retrieval task associated with the second storage zone by issuing commands to the first RSRV to retrieve the targeted storage unit stored in the second storage zone and perform delivery of the targeted storage unit to a workstation to facilitate picking of product from the targeted storage unit at the workstation. Subsequent to the completion of the retrieval task associated with the second storage zone and picking of the product from the targeted storage unit carried by the first RSRV, the CCS issues commands to the first RSRV or a different RSRV to deposit the targeted storage unit onto one of the buffer spots in the second storage zone and then exit the second storage zone. As part of a subsequent retrieval task associated with the second storage zone and assigned to a second RSRV selected from among the first RSRV and a different RSRV, to retrieve another targeted storage unit stored in the second storage zone, the CCS issues commands to the second RSRV to: (a) enter the second storage zone; (b) pick up the deposited storage unit from the buffer spot in the second storage zone; (c) travel from the buffer spot in the second storage zone toward an access location in the second storage zone from which the other targeted storage unit is retrievable; and (d) prior to retrieving the other targeted storage unit at the access location, deposit the picked up storage unit from the buffer spot in the second storage zone into an available one of the storage locations in the second storage zone. In an embodiment, the CCS selects the available storage location in the second storage zone from among any of the storage locations available upstream and positioned en route from the buffer spot in the second storage zone to the access location, and/or any of the storage locations available downstream and positioned en route from the access location to an exit portal.

In an embodiment, the CCS assigns a task of depositing an unneeded one of the storage units stored in the second storage zone into one of the storage locations in the second group, to one of the RSRVs that is assigned to retrieve a needed one of the storage units stored in the second storage zone from the second group of the storage locations.

In an embodiment, the second storage zone is characterized by a harsher operating environment for the RSRVs than the first storage zone. In this embodiment, during the selection of one of the RSRVs to assign to any retrieval task associated with the second storage zone, the CCS prioritizes the RSRVs of a longer absence from the second storage zone over the RSRVs of a more recent presence in the second storage zone. In an embodiment, the CCS records an exit time at which any of the RSRVs last exited the second storage zone. In this embodiment, during the selection of the RSRVs for any retrieval task associated with the second storage zone, the CCS compares exit times of the RSRVs for prioritizing the RSRVs of the longer absence from the second storage zone over the RSRVs of the more recent presence in the second storage zone. The embodiments herein reduce exposure of the RSRVs to non-ambient, cooled, chilled or freezer environments while the RSRVs operate in the multi-zone ASRS, thereby protecting their circuitry and componentry and maintaining their throughput performance.

In an embodiment, the storage units containing product inventory are received at a receiving facility on a transport vehicle from a supply facility and automatically inducted into an ASRS, for example, the multi-zone ASRS or a single-zone ASRS, at the receiving facility. The multi-zone ASRS or the single-zone ASRS is of a type compatible with a predetermined type of each of the storage units. In this embodiment, the storage units containing the product inventory are exchanged for outgoing storage units, for example, empty storage units, from the receiving facility, thereby loading the outgoing storage units onto the transport vehicle for transit from the receiving facility. Both the storage units containing the product inventory and the outgoing storage units are of the same predetermined type compatible with the ASRS of the receiving facility. The embodiments herein implement a 1:1 exchange technique of forward and reverse storage units during auto-induction at the receiving facility, that is, a micro-fulfillment center, during a replenishment process. The embodiments herein improve shipping and receiving processes and eliminate associated staging areas in micro-fulfillment and distribution center sites to substantially reduce labor, real estate and resource requirements while streamlining logistics, thereby making operations predictable, orderly, and easier to monitor in real time.

The multi-zone ASRS optimally coordinates the movement of the RSRVs for improving storage and retrieval of a large number of different product items having different temperature requirements. Disclosed herein is also a computer-implemented method for controlling operation of the RSRVs in the multi-zone ASRS disclosed above. The method disclosed herein employs the CCS configured to operably communicate with the RSRVs. In the method disclosed herein, for a deposit process in the second storage zone involving a deposit of a first storage unit in the second storage zone to a first storage location in the second storage zone, the CCS divides the deposit process into a first entrance task of carrying the first storage unit into the second storage zone and a second placement task of placing the first storage unit into the first storage location. The CCS then assigns the first entrance task and the second placement task to a first RSRV and a second RSRV respectively, selected from among the RSRVs positioned outside the second storage zone. The CCS then issues commands to the first RSRV and the second RSRV to execute the first entrance task and the second placement task. In an embodiment, the first entrance task comprises a drop-off of the first storage unit in the second storage zone by the first RSRV, and a prompt exit of the first RSRV from the second storage zone after the drop-off. The drop-off performed by the first RSRV in the first entrance task comprises placement of the first storage unit at a buffer spot in the second storage zone for later retrieval of the first storage unit from the buffer spot by the second RSRV.

In an embodiment, the CCS assigns a retrieval task associated with the second storage zone to the second RSRV. In this embodiment, the second storage zone is characterized by a harsher operating environment for the RSRVs than the first storage zone. For example, the second storage zone is a cooled storage zone having a lower environmental operating temperature than the first storage zone. The retrieval task comprises retrieving a second storage unit from a second storage location in the second storage zone. The second storage location from which to retrieve the second storage unit is selected from among any of the storage locations available upstream and positioned en route from a buffer spot in the second storage zone to the second storage locations in the second storage zone, and/or any of the storage locations available downstream and positioned en route from the second storage location in the second storage zone to an exit portal of the second storage zone.

In an embodiment of the computer-implemented method disclosed herein, the CCS assigns a retrieval task associated with the second storage zone to a first RSRV selected from among the RSRVs positioned outside the second storage zone. The CCS then issues commands to the first RSRV to travel into the second storage zone; retrieve a first storage unit from a first storage location in the second storage zone; and exit the second storage zone and carry the first storage unit to a workstation positioned outside the second storage zone. After performance of product placement to or product extraction from the first storage unit at the workstation, the CCS commands the first RSRV or a different RSRV to transport the first storage unit from the workstation back into the second storage zone, and to drop off the first storage unit at a buffer spot in the second storage zone that is distinct from the storage locations of the second storage zone. The CCS issues commands to the first RSRV or the different RSRV to promptly exit the second storage zone after dropping off the first storage unit at the buffer spot in the second storage zone. The CCS issues commands to another RSRV to enter the second storage zone from the first storage zone, pick up the first storage unit from the buffer spot in the second storage zone, and deposit the first storage unit into one of the storage locations in the second storage zone. The CCS issues commands to the other RSRV to, after depositing the first storage unit into one of the storage locations in the second storage zone, retrieve a second storage unit from a second storage location in the second storage zone different from that in which the first storage unit was deposited. The CCS selects one of the storage locations in the second storage zone into which to deposit the first storage unit from among any of the storage locations in the second storage zone available upstream and positioned en route from the buffer spot to the second storage location in the second storage zone from which the second storage unit is to be retrieved, and any of the storage locations available downstream and positioned en route to an exit of the second storage zone from the second storage location from which the second storage unit is to be retrieved.

In one or more embodiments, related systems comprise circuitry and/or programming for executing the methods disclosed herein. The circuitry and/or programming are of any combination of hardware, software, and/or firmware configured to execute the methods disclosed herein depending upon the design choices of a system designer. In an embodiment, various structural elements are employed depending on the design choices of the system designer.

### BRIEF DESCRIPTION OF THE DRAWINGS

The foregoing summary, as well as the following detailed description, is better understood when read in conjunction with the appended drawings. For illustrating the embodiments herein, exemplary constructions of the embodiments are shown in the drawings. However, the embodiments herein are not limited to the specific structures, components, and methods disclosed herein. The description of a structure, or a component, or a method step referenced by a numeral in a drawing is applicable to the description of that structure, component, or method step shown by that same numeral in any subsequent drawing herein.

FIG. 1 illustrates a top perspective view of a multi-zone automated storage and retrieval system (ASRS), showing an upper track layout of a three-dimensional (3D) gridded storage structure employed by the multi-zone ASRS, according to an embodiment herein.

FIG. 2 illustrates an enlarged, partial view of a top end of the multi-zone ASRS, according to an embodiment herein.

FIG. 3 illustrates a cutaway, perspective view of the multi-zone ASRS, showing partial sections of the upper track layout and a lower track layout of the 3D gridded storage structure employed by the multi-zone ASRS, according to an embodiment herein.

FIG. 4 illustrates a top isometric view of the 3D gridded storage structure employed by the multi-zone ASRS, according to an embodiment herein.

FIG. 5A illustrates a robotic storage/retrieval vehicle (RSRV) and a compatible storage unit employed in the multi-zone ASRS, according to an embodiment herein.

FIG. 5B illustrates the RSRV and the compatible storage unit of FIG. 5A, showing an extension of an arm of a rotatable turret of the RSRV for engaging with the storage unit to push or pull the storage unit off of or onto the RSRV, according to an embodiment herein.

FIG. 6A illustrates a top perspective view of the multi-zone ASRS, showing a workstation attached to a storage zone to allow a worker to operate on product items having non-ambient temperatures in an ambient environment, while maintaining a storage unit containing the product items in the storage zone, according to an embodiment herein.

FIG. 6B illustrates an enlarged view of the workstation shown in FIG. 6A, according to an embodiment herein.

FIG. 7 illustrates a group of interconnected facilities in a supply chain or distribution network, including a supply facility that supplies replenishing inventory to numerous smaller, receiving facilities at which customer orders are fulfilled from an ASRS, according to an embodiment herein.

FIG. 8 illustrates an architectural block diagram of a system for executing an inventory replenishment workflow comprising a 1:1 exchange of transportable storage units, according to an embodiment herein.

FIG. 9 illustrates an architectural block diagram of a system for managing orders and controlling operation of RSRVs in the multi-zone ASRS using a computerized control system (CCS), according to an embodiment herein.

FIGS. 10A-10B illustrate a database schema of a central database of the system shown in FIG. 8, according to an embodiment herein.

FIG. 10C illustrates a database schema of a local facility database of the CCS, according to an embodiment herein.

FIG. 10D exemplarily illustrates data stored in a robot information table of the local facility database of the CCS, according to an embodiment herein.

FIG. 10E illustrates a database schema of a local vehicle database of a vehicle management system shown in FIG. 8, according to an embodiment herein.

FIG. 11 illustrates a flowchart of a computer-implemented method for controlling operation of RSRVs in the multi-zone ASRS, according to an embodiment herein.

FIG. 12 illustrates a flowchart of a computer-implemented method for controlling operation of RSRVs in the multi-zone ASRS, according to another embodiment herein.

FIG. 13 illustrates a flowchart of a computer-implemented method for executing an order fulfillment workflow, according to an embodiment herein.

FIG. 14 illustrates a flowchart of a computer-implemented method for selecting an RSRV for a task to be executed in the multi-zone ASRS, according to an embodiment herein.

FIG. 15 illustrates a top plan view of the multi-zone ASRS, showing travel routes of an RSRV and a storage unit configured by the CCS for retrieving and returning the storage unit from a storage zone of the multi-zone ASRS, according to an embodiment herein.

FIG. 16 illustrates a flowchart of a method executed by an RSRV, in response to commands from the CCS, for retrieving and returning a storage unit from a storage zone of the multi-zone ASRS based on the configured travel routes shown in FIG. 15, according to an embodiment herein.

FIG. 17 illustrates a flowchart of a method executed by an RSRV, in response to commands from the CCS, for retrieving a storage unit from a storage zone of the multi-zone ASRS, according to an embodiment herein.

FIG. 18 illustrates a flowchart of a method executed by an RSRV, in response to commands from the CCS, for returning a storage unit from a storage zone of the multi-zone ASRS, according to an embodiment herein.

FIG. 19 illustrates a partial perspective view of the multi-zone ASRS, showing workstations attached to the multi-zone ASRS via a conveyor system, according to an embodiment herein.

FIGS. 20A-20B illustrate a flowchart of a computer-implemented method for fulfilling and storing an order in the multi-zone ASRS, according to an embodiment herein.

FIG. 21 illustrates a flowchart of a computer-implemented method for retrieving an order from the multi-zone ASRS for pickup by a customer, according to an embodiment herein.

FIG. 22 illustrates a flowchart of a computer-implemented method for executing an inventory replenishment workflow between a supply facility and a receiving facility, according to an embodiment herein.

FIG. 23 illustrates a flowchart of a computer-implemented method for executing consolidation of storage units at a receiving facility for inventory replenishment, according to an embodiment herein.

FIG. 24 illustrates a top plan view of the multi-zone ASRS, showing travel routes of an RSRV and a storage unit configured by the CCS for executing an exchange and induction of storage units, according to an embodiment herein.

FIG. 25 illustrates a flowchart of a computer-implemented method for executing an exchange and induction of storage units based on the configured travel routes shown in FIG. 24, according to an embodiment herein.

FIG. 26 illustrates a top perspective view of a transport vehicle arriving at a receiving facility for executing an exchange and induction of storage units, according to an embodiment herein.

### DETAILED DESCRIPTION

Various aspects of the present disclosure may be embodied as a system of components and/or structures, methods, and/or non-transitory, computer-readable storage media having one or more computer-readable program codes stored thereon. Accordingly, various embodiments of the present disclosure may take the form of a combination of hardware and software embodiments comprising, for example, mechanical structures along with electronic components, computing components, circuits, microcode, firmware, software, etc.

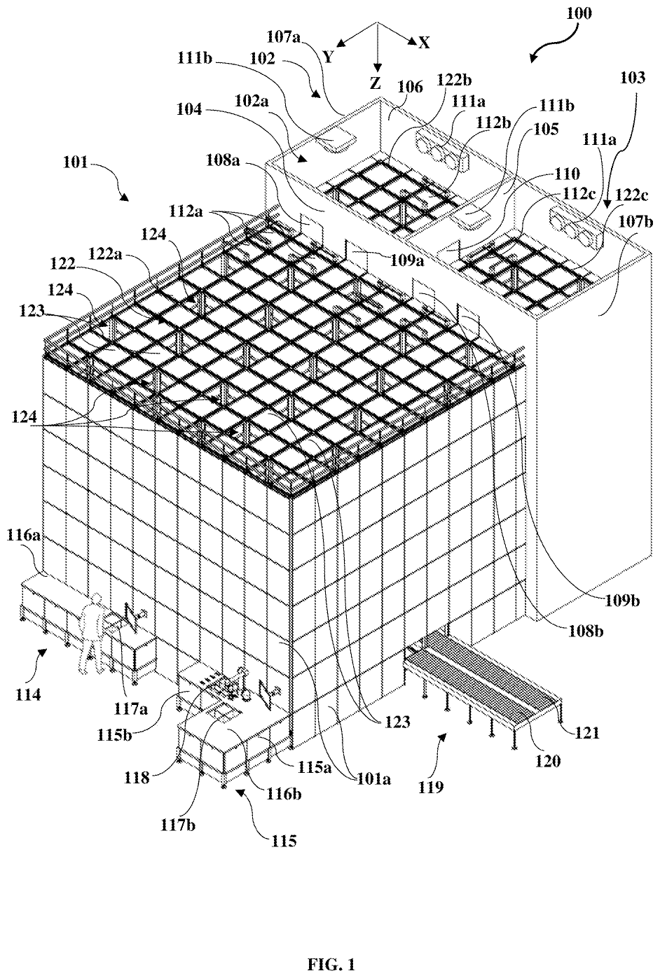

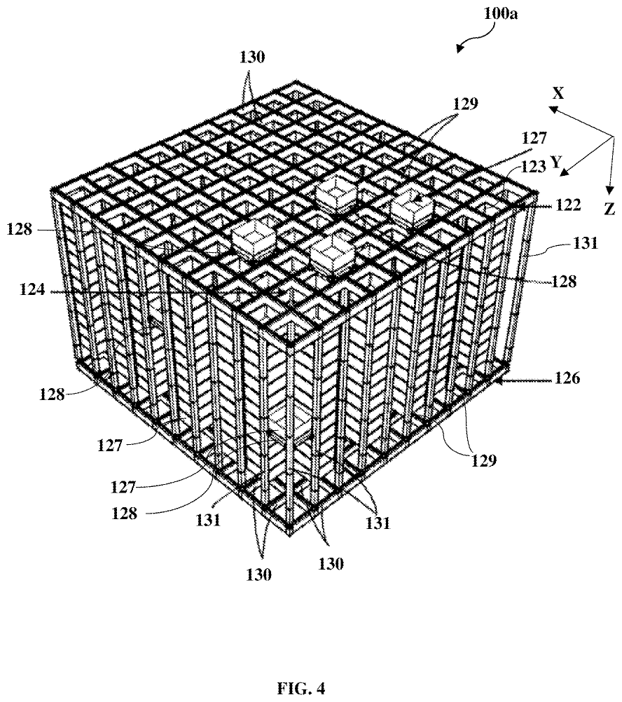

FIG. 1 illustrates a top perspective view of a multi-zone automated storage and retrieval system (ASRS) 100, showing an upper track layout 122 of a three-dimensional (3D) gridded storage structure employed by the multi-zone ASRS 100, according to an embodiment herein. In an embodiment, the multi-zone ASRS 100 disclosed herein employs the 3D gridded storage structure 100a exemplarily illustrated in FIG. 4. The multi-zone ASRS 100 disclosed herein comprises multiple storage locations configured to accommodate placement and storage of storage units therein. As used herein, “storage unit” refers to an inventory holder of any variety, for example, bins, totes, trays, boxes, pallets, gaylords, etc. In an embodiment, the multi-zone ASRS 100 further comprises a first or primary storage zone 101, a second or secondary storage zone 102, at least one barrier 104, one or more portals 108a, 109a, 108b, and 109b, and at least one track layout, for example, 122, and one or more robotic storage/retrieval vehicles (RSRVs) 128 illustrated in FIG. 4 and FIGS. SA-5B. In FIGS. 1-3, upper ceilings of the storage zones 102 and 103 are omitted for illustrative purposes. The first storage zone 101 comprises a first group of storage locations. The second storage zone 102 comprises a second group of storage locations. In an embodiment, the first storage zone 101 and the second storage zone 102 differ from one another in environmental control equipment installed therein or operating characteristics of the environmental control equipment. In another embodiment, the first storage zone 101 or the second storage zone 102 is a cooled storage zone having a lower environmental operating temperature than the other of the first storage zone 101 and the second storage zone 102. For example, as illustrated in FIGS. 1-3, the second storage zone 102 is a cooled storage zone having a lower environmental operating temperature than the first storage zone 101.

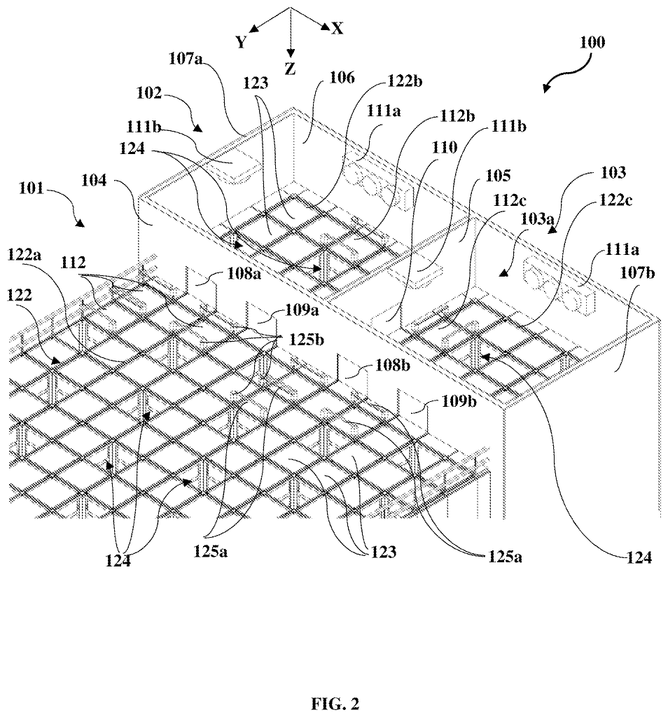

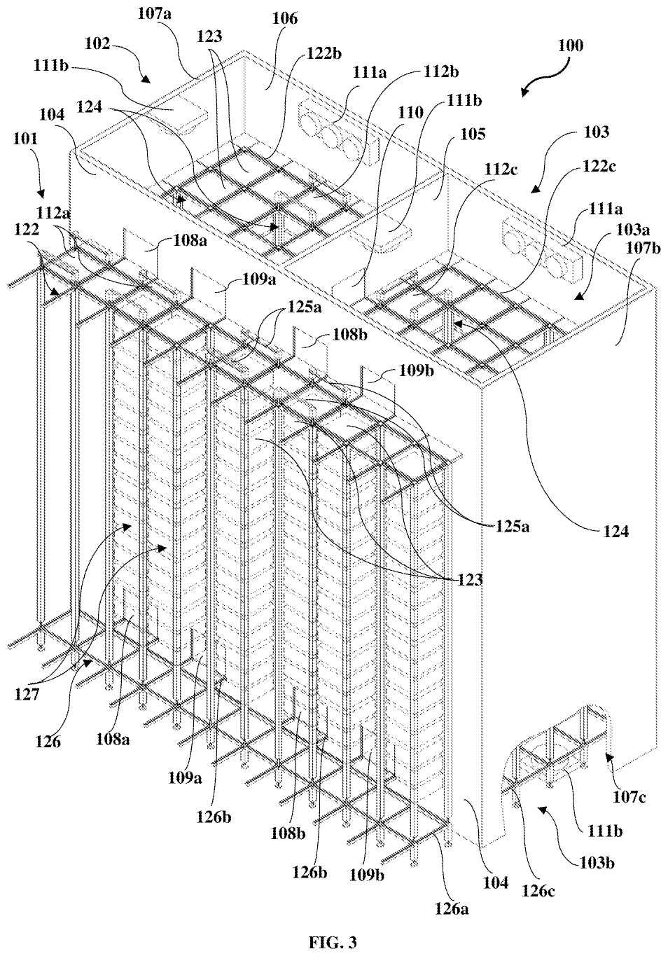

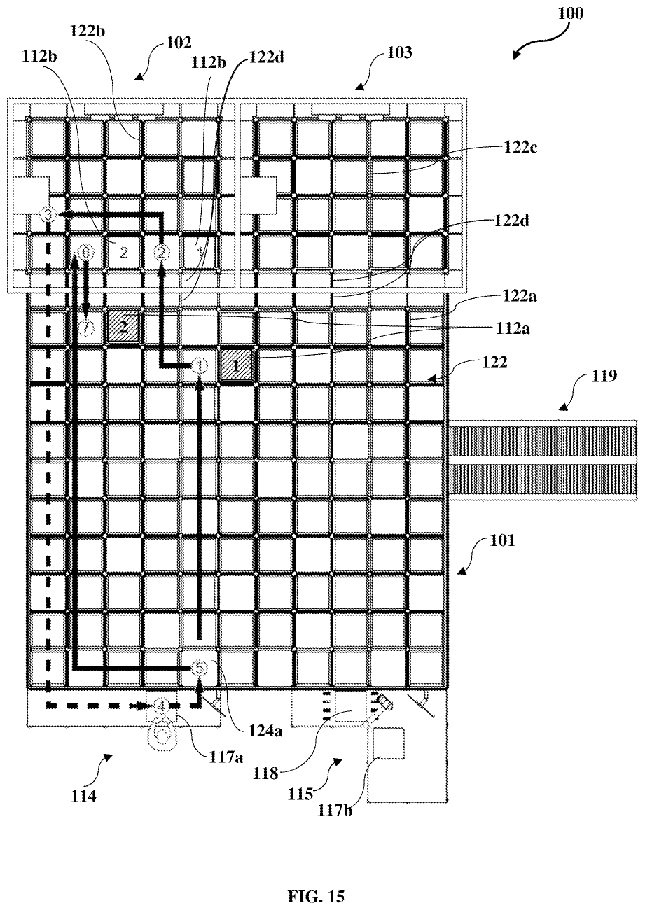

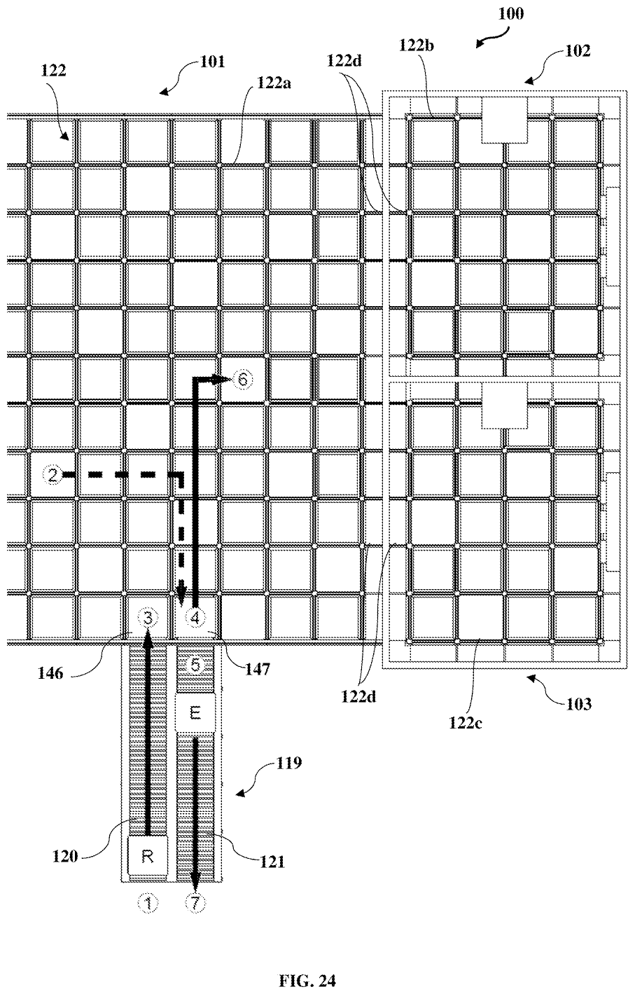

The barrier 104 isolates the second storage zone 102 from the first storage zone 101. The portals 108a, 109a, 108b, and 109b open through the barrier 104 between the first storage zone 101 and the second storage zone 102. The track layout, for example, 122 comprises a first track area 122a occupying the first storage zone 101, a second track area 122b occupying the second storage zone 102, and one or more connective track segments 122d illustrated in FIG. 15 and FIG. 24 interconnecting the first track area 122a and the second track area 122b through the portals 108a, 109a, 108b, and 109b configured in the barrier 104. In an embodiment as illustrated in FIGS. 1-2, the track layout comprises an upper track layout 122 positioned above the storage locations. In this embodiment, the barrier 104 comprises an upper portion standing upright from the upper track layout 122, and the portals 108a, 109a, 108b, and 109b are configured to open through the barrier 104 at the upper portion thereof to accommodate a connective track segment 122d of the upper track layout 122 that interconnects the first track area 122a and the second track area 122b of the upper track layout 122. In an embodiment, the barrier 104 isolating the second storage zone 102 from the first storage zone 101 comprises an upright barrier wall separating the first storage zone 101 and the second storage zone 102. The connective track segment(s) 122d spans through the portals 108a, 109a, 108b, and 109b from one side of the upright barrier wall to another side of the upright barrier wall. In another embodiment, the track layout comprises a lower track layout 126 positioned below the storage locations as illustrated in FIG. 3.

In an embodiment where the track layout 122 is positioned above the storage locations of the multi-zone ASRS 100, the second storage zone 102 comprises an enclosed attic space 102a positioned above the track layout 122 and isolated from the first storage zone 101. The enclosed attic space 102a is delimited by boundary walls 104, 105, 106, and 107a of the second storage zone 102. At least one of the boundary walls 106 is separate and discrete from building walls of a facility that accommodates the multi-zone ASRS 100. The enclosed attic space 102a is isolated from the first storage zone 101 and from a surrounding space of the facility. In an embodiment, the boundary walls 104, 105, 106, and 107a of the enclosed attic space 102a are separate and discrete from the building walls of the facility. In an embodiment, the boundary walls 104, 105, 106, and 107a are mounted to frame members of the 3D gridded storage structure 100a of the multi-zone ASRS 100 illustrated in FIG. 4 that delimits the second group of storage locations. In another embodiment as illustrated in FIGS. 1-2, the first storage zone 101 is free of an enclosed attic space and is open to a surrounding environment of the facility that accommodates the multi-zone ASRS 100. In this embodiment, the environmental control equipment is mounted in the enclosed attic space 102a of the second storage zone 102.

In an embodiment as illustrated in FIGS. 1-2, the multi-zone ASRS 100 further comprises a third or tertiary storage zone 103 isolated from both the first storage zone 101 and the second storage zone 102 by at least one additional barrier 105. The third storage zone 103 comprises a third group of storage locations. The multi-zone ASRS 100 further comprises at least one additional portal 110 opening through the additional barrier 105 between the third storage zone 103 and at least one of the first storage zone 101 and the second storage zone 102. For example, as illustrated in FIGS. 1-2, the additional portal 110 opens through the additional barrier 105 between the third storage zone 103 and the second storage zone 102. The additional portal 110 is configured to accommodate travel of the RSRV(s) 128 therethrough. In an embodiment, the additional portal 110 comprises portals opening to both the first storage zone 101 and the second storage zone 102. In an embodiment, the additional barrier 105 comprises an upper portion standing upright from the upper track layout 122. In this embodiment, the additional portal 110 comprises at least one upper portal opening through the additional barrier 105 at the upper portion thereof. In an embodiment where the track layout 122 is positioned above the storage locations of the multi-zone ASRS 100, the third storage zone 103 comprises an enclosed attic space 103a positioned above the track layout 122 and isolated from the first storage zone 101. The enclosed attic space 103a is delimited by boundary walls 104, 105, 106, and 107b of the third storage zone 103. The enclosed attic space 103a is isolated from the first storage zone 101 and from a surrounding space of the facility. In an embodiment, the boundary walls 104, 105, 106, and 107b of the enclosed attic space 103a are separate and discrete from the building walls of the facility. In an embodiment, the environmental control equipment is mounted in the enclosed attic space 103a of the third storage zone 103. The first storage zone 101, the second storage zone 102, and the third storage zone 103 differ from one another in environmental control equipment installed therein or operating characteristics of the environmental control equipment. The first storage zone 101, the second storage zone 102, and the third storage zone 103 are accessible by the RSRV(s) 128.

In an embodiment, the multi-zone ASRS 100 further comprises one or more buffer spots, for example, 112a, 112b, and 112c. In an embodiment, buffer spots 112a, 112b, and 112c are storage shelves configured to temporarily hold storage units when the RSRVs 128 transition between the storage zones 101, 102, and 103. The buffer spots 112a, 112b, and 112c allow the storage units to be segregated and be stored in only one environmentally controlled storage zone 101, 102, or 103, while allowing an RSRV 128 to transition between the environmentally controlled storage zones 101, 102, and 103 during performance of a single storage and retrieval task. Each of the buffer spots 112a, 112b, and 112c is positioned at a location on the track layout 122 and accessible by the RSRV(s) 128 from the track layout 122. Each of the buffer spots 112a, 112b, and 112c is configured to temporarily hold one of the storage units thereon. In an embodiment, at least one of the buffer spots 112a, 112b, and 112c is positioned proximal to a respective one of the portals 108a, 109a, 108b, 109b, or 110. In an embodiment, one or more buffer spots comprise multiple buffer spots. In this embodiment, at least one of the buffer spots 112a, 112b, and 112c is positioned in each of the first storage zone 101, the second storage zone 102, and the third storage zone 103.

FIG. 2 illustrates an enlarged, partial view of a top end of the multi-zone automated storage and retrieval system (ASRS) 100, according to an embodiment herein. Boundary walls 104, 105, 106, 107a, and 107b made at least partially of a thermally insulative material, for example, a rigid foam insulation, are mounted to the framework of the three-dimensional (3D) gridded storage structure 100a of the multi-zone ASRS 100 exemplarily illustrated in FIG. 4, to subdivide the overall gridded storage structure 100a into different thermally isolated storage zones 101, 102, and 103, and to thermally isolate one or more of these storage zones 101, 102, and 103 from a surrounding environment of the facility in which the 3D gridded storage structure 100a is installed. As exemplarily illustrated in FIGS. 1-2, the 3D gridded storage structure 100a of the multi-zone ASRS 100 is divided into three distinct storage zones, namely, a first storage zone 101 for ambient storage at the same environmental conditions as the surrounding facility environment; a second or secondary storage zone 102 for cooled storage in a chilled environment of a reduced temperature relative to the ambient, first storage zone 101 and surrounding facility environment; and a third storage zone 103 for cooled storage in a freezer environment of a further reduced temperature relative to the other two storage zones 101 and 102 and the surrounding facility environment.

The boundary walls comprise a full-span barrier wall 104 spanning vertically through a full height of the 3D gridded storage structure 100a from a ground level beneath the lower track layout 126 up to, and past, the upper track layout 122. As illustrated in FIG. 1, this full-span barrier wall 104 spans fully across the 3D gridded storage structure 100a in one horizontal direction, referred to herein as the X-direction, thereby separating one storage zone from another in the other horizontal direction perpendicular thereto, referred to herein as the Y-direction. As illustrated in FIG. 1, the first storage zone 101 is positioned on a first side of the full-span barrier wall 104 and spans a full dimension of the 3D gridded storage structure 100a in the X-direction, while spanning only a partial dimension of the 3D gridded storage structure 100a in the Y-direction. Both of the second storage zone 102 and the third storage zone 103 adjacently neighbor the full-span barrier wall 104 on the side thereof opposite the first storage zone 101, whereby the second storage zone 102 and the third storage zone 103, each span only a partial dimension of the 3D gridded storage structure 100a in both the X-direction and the Y-direction. That is, the second storage zone 102 and the third storage zone 103 share the full-span barrier wall 104 that physically and thermally isolates both of these cooled storage zones 102 and 103 from the ambient first storage zone 101.

A partial-span barrier wall 105 spans vertically through the full height of the 3D gridded storage structure 100a from a ground level beneath the lower track layout 126 up to, and past, the upper track layout 122, while not fully spanning the 3D gridded structure 100a in either horizontal direction. The partial-span barrier wall 105 spans in the Y-direction of the 3D gridded storage structure 100a from the full-span barrier wall 104 to the outer perimeter wall 106 of the 3D gridded storage structure 100a at a side of the full-span barrier wall 104 opposite the ambient first storage zone 101, and therefore, physically and thermally isolates the second storage zone 102 and the third storage zone 103 from one another in the X-direction of the 3D gridded storage structure 100a. As exemplarily illustrated in FIGS. 1-2, where the second storage zone 102 and the third storage zone 103 are of equal footprint to one another, in an embodiment, the partial-span barrier wall 105 is positioned midway between two opposing outer perimeter sides of the 3D gridded storage structure 100a in the X-direction. In another embodiment, the second storage zone 102 and the third storage zone 103 differ in size and footprint from one another.

In an embodiment as illustrated in FIG. 1, the first storage zone 101 is the largest of the storage zones 101, 102, and 103, reflecting an installation where more ambient storage is required than chilled or frozen storage. In other embodiments, the ambient, chilled and/or freezer storage zones 101, 102, and 103 are configured in different sizes with different footprints in accordance with requirements of the facility that accommodates the multi-zone ASRS 100. As exemplarily illustrated in FIG. 1, the span of the first storage zone 101 in the Y-direction exceeds the equal width shared by the second storage zone 102 and the third storage zone 103 in the Y-direction, whereby the first storage zone 101 has a footprint that exceeds both the individual footprints and combined footprints of the second storage zone 102 and the third storage zone 103. In atypical scenarios with greater demand for cooled storage than ambient storage, the first storage zone 101 is configured with an equal or less footprint than the combined or the individual footprints of the second storage zone 102 and the third storage zone 103.

In the embodiment illustrated in FIGS. 1-2, the multi-zone ASRS 100 comprises three storage zones 101, 102, and 103, among which there are two storage zones 102 and 103 of a different less-than-ambient operating temperature. In another embodiment, the multi-zone ASRS 100 has a dual-zone configuration, where there is one ambient storage zone and one cooled storage zone, where the cooled storage zone is at a chilled operational temperature range or a freezer operational temperature range. Moreover, in the embodiment illustrated in FIGS. 1-2, the cooled storage zones, that is, the second storage zone 102 and the third storage zone 103 are positioned on the same side of the ambient storage zone, that is, the first storage zone 101, whereby one end of the 3D gridded storage structure 100a is occupied by two cooled storage zones 102 and 103 and the other end is occupied by the ambient storage zone 101. In other embodiments, other configurations of the storage zones 101, 102, and 103 are employed in the multi-zone ASRS 100. For example, the second storage zone 102 or the chilled zone, and the third storage zone 103 or the freezer zone are positioned at opposing sides of the ambient, first storage zone 101, where each of the storage zones 102 and 103 span the full X-direction of the 3D gridded storage structure 100a, and therefore, each of the storage zones 102 and 103 comprises a respective full-span barrier wall 104 isolating each of the storage zones 102 and 103 from the central ambient, first storage zone 101. Furthermore, each of the cooled storage zones 102 and 103 illustrated in FIGS. 1-2 is of a less dimension in the Y-direction than the ambient storage zone 101. In other embodiments where greater cooled storage is required, each of the cooled storage zones 102 and 103 are configured to be of a greater dimension in the Y-direction than the ambient storage zone 101.

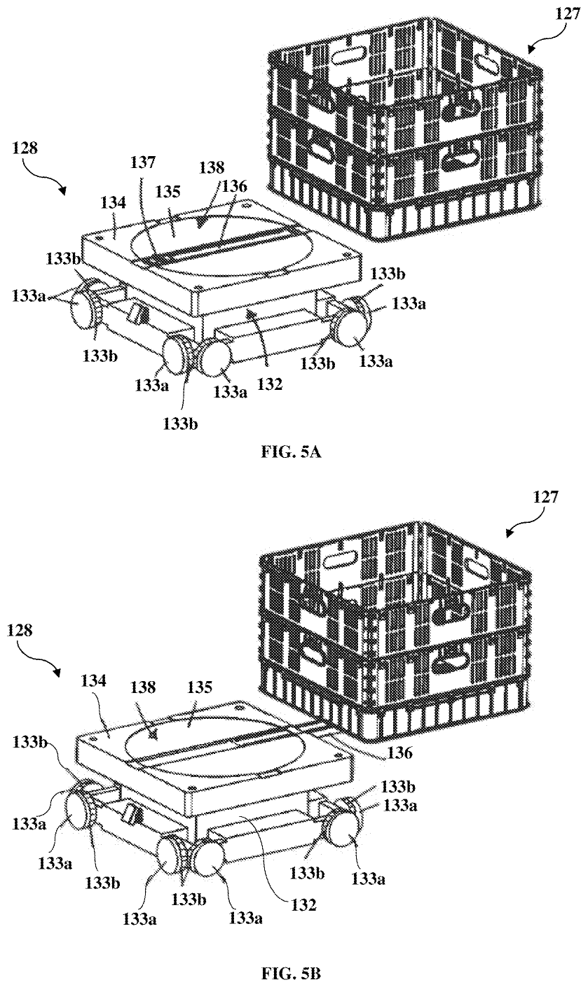

Regardless of the particular configuration of the storage zones 101, 102, and 103, when multiple cooled storage zones are included in the multi-zone ASRS 100, each cooled storage zone 102 and 103 is configured to share at least one barrier wall 104 with the ambient storage zone 101, and have at least one access portal, for example, 108a, 109a, 108b, 109b, that opens through this barrier wall 104 to allow travel of the robotic storage/retrieval vehicles (RSRVs) 128 illustrated in FIG. 4 and FIGS. 5A-5B therethrough. In the multi-zone ASRS 100 disclosed herein, the RSRVs 128 occupy the ambient storage zone 101, where operating conditions are less harsh compared to the lower temperature conditions in the cooled storage zones 102 and 103, and are configured to directly enter any cooled storage zone 102 or 103 from the ambient storage zone 101 to minimize time spent within the harsher low temperature operating environments by avoiding the need to travel through one cooled storage zone, for example, 102, to reach another cooled storage zone, for example, 103.

Since the second storage zone 102 and the third storage zone 103, for example, are environmentally controlled or temperature-controlled, chilled and freezer storage zones requiring physical and thermal isolation from the surrounding environment of the facility, the boundary walls of these storage zones 102 and 103 comprise not only the internal harrier walls 104 and 105 that cut through the interior of the 3D gridded storage structure 100a, but also outer perimeter walls 106, 107a, and 107b that cooperate with the internal barrier walls 104 and 105 to completely surround each of the storage zones 102 and 103 on all sides thereof. The full-span perimeter wall 106 spans the full X-direction of the 3D gridded storage structure 100a at the outer perimeter side thereof and is positioned opposite the full-span barrier wall 104, and is therefore, shared by the second storage zone 102 and the third storage zone 103 to close off the sides thereof opposite the first storage zone 101. Partial-span perimeter walls 107a and 107b for the second storage zone 102 and the third storage zone 103 respectively, span a partial dimension of the 3D gridded storage structure 100a in the Y-direction thereof between the full-span perimeter wall 106 and the full-span barrier wall 104, and thereby closes off a fourth and final side of each of the storage zones 102 and 103 in opposite and opposing relation to the partial-span barrier wall 105.

Similar to the barrier walls 104 and 105, the perimeter walls 106 and 107a, 107b span a full height of the 3D gridded storage structure 100a from a ground level beneath the lower track layout 126 up to, and past, the upper track layout 122. Accordingly, all of the boundary walls 104, 105, 106, 107a, and 107b reach upwardly beyond the upper track layout 122 of the 3D gridded storage structure 100a. At an upper portion of the full-span barrier wall 104 standing upright from the upper track layout 122, a pair of access portals 108a and 109a penetrate horizontally through the full-span barrier wall 104 at the upper portion thereof denoting the boundary between the first storage zone 101 and the second storage zone 102. A respective pair of Y-direction rails 130 of the upper track layout 122 of the 3D gridded storage structure 100a as illustrated in FIG. 4, spans through each of these access portals 108a and 109a, thereby forming a connective track segment 122d that connects the first track area 122a of the upper track layout 122 in the first storage zone 101 to the second track area 122b of the upper track layout 122 in the second storage zone 102 as illustrated in FIG. 15 and FIG. 24. Similarly, another pair of access portals 108b and 109b penetrate horizontally through the upper portion of the full-span barrier wall 104 at the upper portion thereof denoting the boundary between the first storage zone 101 and the third storage zone 103. A respective pair of Y-direction rails 130 of the upper track layout 122 spans through each of these access portals 108b and 109b, thereby forming a connective track segment 122d that connects the first track area 122a of the upper track layout 122 in the first storage zone 101 to a third track area 122c of the upper track layout 122 in the third storage zone 103 as illustrated in FIG. 15 and FIG. 24.

Within each pair of access portals, in an embodiment, one access portal 108a, 108b is used as a dedicated entrance portal by which the RSRVs 128 enter the cooled, second storage zone 102 or third storage zone 103 from the ambient, first storage zone 101 by riding over the respective connective track segment 122d, while the other access portal 109a, 109b is used as a dedicated exit portal by which the RSRVs 128 exit the cooled, second storage zone 102 or third storage zone 103 back into the ambient, first storage zone 101. In another embodiment, either of the two access portals 108a, 108b or 109a, 109b is used as either an entrance portal or an exit portal at any given time. In another embodiment, a singular entrance/exit portal is employed at each of the cooled storage zones 102 and 103 for two-way travel thereto and therefrom. As illustrated in FIGS. 1-2, an additional access portal 110 penetrates through the partial-span barrier wall 105 at an upper portion thereof, with a respective pair of X-direction rails 129 of the upper track layout 122 illustrated in FIG. 4 spanning through the additional access portal 110 to allow travel of the RSRVs 128 directly between the second storage zone 102 and the third storage zone 103. In an embodiment, the additional access portal 110 is optionally omitted as direct access to each of the cooled storage zones 102 and 103 from the ambient storage zone 101 is optimal. The additional access portal 110 is also omitted in dual-zone embodiments and in embodiments where the second storage zone 102 and the third storage zone 103 do not neighbor each other.

The multi-zone ASRS 100 comprises environmental control equipment, for example, chillers or coolers 111a, fans 111b, heaters, etc., for controlling the temperature or environmental parameters and conditions in one or more of the storage zones, for example, 102 and 103. The number, size, and locations of the environmental control equipment are configured based on the size of the multi-zone ASRS 100. As exemplarily illustrated in FIGS. 1-2, each of the second storage zone 102 and the third storage zone 103 comprises a respective chiller 111a installed therein to cool the internal space of the respective storage zone 102, 103 to a targeted operational temperature range for chilled or frozen storage of product items or goods. In an embodiment, the chillers 111a are installed at the upper portion of one of the boundary walls surrounding the respective storage zone 102, 103. For example, the chillers 111a are installed in the enclosed attic space 102a, 103a on the outer perimeter wall 106 of the respective storage zone 102, 103. The chillers 111a are, for example, evaporators or evaporative coolers configured with a wide range of capacities to support cooling applications in the multi-zone ASRS 100. These evaporative coolers cool air through the evaporation of water within the multi-zone ASRS 100. In another embodiment, one or more fans 111b are positioned in the enclosed attic spaces 102a and 103a of the storage zones 102 and 103 respectively and in the basement 103b illustrated in FIG. 3, to circulate cold air from the enclosed attic spaces 102a and 103a to the basement 103b, for example, using central voids or downshafts of the 3D gridded storage structure 100a. The downshafts are configured as ducts for allowing cooled air from the top of the 3D gridded storage structure 100a to be circulated to the bottom of the 3D gridded storage structure 100a. Since the downshafts are surrounded by storage units containing product items to be cooled, each of the storage units is in direct communication with respective downshafts, thereby ensuring that the contents of the storage units are uniformly chilled throughout the 3D gridded storage structure 100a. The presence of downshafts and space between each shelved storage unit in the 3D gridded storage structure 100a of the multi-zone ASRS 100 allows optimal air flow for homogeneous temperatures in the entire 3D gridded storage structure 100a.

As illustrated in FIGS. 1-2, a chiller 111a of each cooled storage zone 102, 103 is mounted to one of the outer perimeter walls 106 and 107a, 107b thereof rather than to one of the internal barrier walls 104 and 105. Mounting the chiller 111a to the outer perimeter wall, for example, 106, allows access to the chiller 111a and other such environmental control equipment from outside the 3D gridded storage structure 100a for inspection, service, or repair without having to interrupt operation of the RSRVs 128 within the 3D gridded storage structure 100a. Mounting of chillers 111a or other environmental control equipment directly on perimeter walls, for example, 106, 107a, and 107b of the 3D gridded storage structure 100a itself allows the multi-zone ASRS 100 to be implemented as a standalone, self-contained system, without having to mount the chillers 111a or other environmental control equipment elsewhere within the facility and assemble suitable ducting and associated air handling equipment to route cooled air into the 3D gridded storage structure 100a. Mounting of the chillers 111a or other environmental control equipment to the interior of the perimeter walls, for example, 106, 107a, and 107b at upper portions thereof, standing directly upright from the outer perimeter of the 3D gridded storage structure 100a also allows the chillers 111a or other environmental control equipment to reside within the two-dimensional (2D) footprint of the 3D gridded storage structure 100a, thereby avoiding the need to include large plenums outside the perimeter of the 3D gridded storage structure 100a itself to accommodate external placement of cooling equipment outside the 2D footprint of the 3D gridded storage structure 100a. The upper portions of the boundary walls 104, 105, 106, 107a, and 107b standing upright from the upper track layout 122 create loft or attic spaces 102a and 103a in the second storage zone 102 and the third storage zone 103 respectively that reside above the 3D gridded storage structure 100a to accommodate the chillers 111a or other equipment, and allow the RSRVs 128 to travel inside the cooled interior environments of these storage zones 102 and 103 once the RSRVs 128 enter from the ambient, first storage zone 101 through the access portals, for example, 108a and 108b. In another embodiment, the environmental control equipment comprises heaters instead of chillers 111a, where the heaters form a reservoir of heated air. In another embodiment, the environmental control equipment comprises heaters in addition to the chillers 111a, thereby creating a reservoir of temperature-controlled air.

To fully enclose the cooled storage zones 102 and 103, in an embodiment, zone ceilings (not shown) made of suitable thermally insulative materials are installed over the top ends of the boundary walls 104, 105, 106, 107a, and 107b. The zone ceilings are omitted in FIGS. 1-3 to illustrate the interior spaces of the cooled, second storage zone 102 and third storage zone 103. In another embodiment, if the boundary walls 104, 105, 106, 107a, and 107b reach an existing ceiling structure of the facility, the existing facility ceiling structure is used to cap off the cooled storage zones 102 and 103 and fully enclose the interior temperature-controlled spaces thereof instead of employing a separate insulative zone ceiling mounted to the boundary walls 104, 105, 106, 107a, and 107b of the multi-zone ASRS 100. Similar options are employed at the bottom of the 3D gridded storage structure 100a in embodiments where the boundary walls 104, 105, 106, 107a, and 107b span fully down to the existing floor of the facility. In another embodiment, a separate insulative zone floor is configured to span between the boundary walls 104, 105, 106, 107a, and 107b of each cooled storage zone 102, 103 below the lower track layout 126 of the 3D gridded storage structure 100a. Similar to the chiller-equipped attic spaces 102a and 103a above storage columns 123 of the 3D gridded storage structure 100a, the RSRVs 128 are configured to travel horizontally within the temperature-controlled interiors of the cooled, second storage zone 102 and third storage zone 103 at a basement level thereof below the storage columns 123. In an embodiment as illustrated in FIGS. 1-2, the ambient attic space above the first track area 122a of the upper track layout 122 at the first storage zone 101 is not enclosed like the ceiling-covered and wall-surrounded attic spaces 102a and 103a of the cooled, second storage zone 102 and third storage zone 103 and is maintained fully open to the surrounding environment of the facility. In an embodiment as illustrated in FIG. 1, the 3D gridded storage structure 100a is equipped with cladding 101a at the outer perimeter sides thereof that create outer side walls that substantially close off all four sides of the 3D gridded storage structure 100a, thereby visually concealing the interior thereof.

Through the above disclosed division of the 3D gridded storage structure 100a of the multi-zone ASRS 100 into storage zones 101, 102, and 103 isolated by the internal barrier walls 104 and 105, and the cooperative relation of the perimeter walls 106, 107a, and 107b and zone or facility ceilings and floors therewith to fully enclose the cooled, second storage zone 102 and third storage zone 103, a first group or a subset of the storage columns 123 of the overall 3D gridded storage structure 100a therefore reside in an ambient environment in the environmentally exposed first storage zone 101, while second and third groups or subsets of the storage columns 123 of the overall 3D gridded storage structure 100a reside in cooled environments within the chilled, second storage zone 102 and the freezer, third storage zone 103. In an embodiment, to maintain a substantially complete isolation between the cooled storage zones 102 and 103 and the ambient storage zone 101, each of the access portals 108a, 109a, 108b, 109b, and 110 is equipped with a strip curtain through which an RSRV 128 is configured to push. In another embodiment, each of the access portals 108a, 108b, 109a, 109b, and 110 is equipped with a normally-closed, selectively-openable, electronically-operated door configured to automatically open upon approach or arrival of an RSRV 128, for example, under an automated control either at a system level by a computerized control system (CCS) of the multi-zone ASRS 100 configured to wirelessly command movements and operations of the RSRVs 128 within the 3D gridded storage structure 100a, or at a vehicular level by an actuator, remote control system, or other means. Neither the storage columns 123 nor the access shafts 124 inside the cooled, second storage zone 102 and third storage zone 103 need to be capped with individual insulation covers and, in an embodiment, are left uncapped at all times. The access shafts 124 are left uncapped at all times such that any RSRV 128 entering the cooled, second storage zone 102 or third storage zone 103 at the upper track layout 122 can readily travel down any access shaft 124 in the cooled storage zone 102 or 103 without having to first perform or await removal of such an insulative cover.

As disclosed above, the upper track layout 122 further comprises a plurality of buffer spots, including a plurality of buffer spots 112a in the first storage zone 101, at least one buffer spot 112b in the second storage zone 102, and at least one buffer spot 112c in the third storage zone 103. Each of the buffer spots 112a, 112b, and 112c is positioned proximal to a respective one of the access portals 108a, 109a, 108b, 109b, and 110 in the barrier walls 104 and 105 respectively. Each of the buffer spots 112a, 112b, and 112c is equipped with a shelving assembly sized to accommodate placement of one of the storage units thereon. As illustrated in FIGS. 1-2, each shelving assembly comprises a pair of parallel shelf rails 125a supported by a set of four uprights 125b. Each upright 125b is installed at the intersection of two perpendicular rails of the track area 122a, 122b, or 122c at a respective corner of the buffer spot 112a, 112b, or 112c. Each shelf rail 125a runs along a respective side of the buffer spot 112a, 112b, or 112c, with the distance between the two shelf rails 125a being less than the width of each square-bottomed storage unit. The open space between the two shelf rails 125a allows insertion of an extendable/retractable arm 136 of an RSRV 128 illustrated in FIGS. 5A-5B, between the two shelf rails 125a to push a storage unit 127 off the RSRV 128 onto the shelf rails 125a during a drop-off of the storage unit 127 at the buffer spot 112a, 112b, or 112c. Similarly, the space between the shelf rails 125a allows retraction of the extendable/retractable arm 136 of the RSRV 128 once the extendable/retractable arm 136 is lowered out of engagement with the underside of the storage unit 127, for example, by raising of a height-adjustable wheel set of the RSRV 128, after seating of the storage unit 127 on the shelf rails 125a, thereby parking the storage unit 127 at the buffer spot 112a, 112b, or 112c and leaving the RSRV 128 free to perform other tasks.

During a subsequent pickup of the storage unit 127, the reverse process is performed, that is, extending the arm 136 of the RSRV 128 between the shelf rails 125a, raising an upper support platform 138 of the RSRV 128 illustrated in FIGS. 5A-5B, by lowering the height-adjustable wheel set thereof to raise the extended arm 136 into engagement with the underside of the storage unit 127, and then retracting the arm 136 to pull the storage unit 127 onto the upper support platform 138 of the RSRV 128. The drop-off and pick-up of the storage units 127 at the buffer spots 112a, 112b, and 112c are, therefore, similar to the deposit and extraction or retrieval of the storage units 127 to and from the shelving-equipped storage locations in the 3D gridded storage structure 100a of the multi-zone ASRS 100, as shelving brackets in the storage columns 123 of the 3D gridded storage structure 100a are spaced equivalent to the shelf rails 125a of the buffer spots 112a, 112b, and 112c to allow sliding of the storage units 127 onto and off of the shelving brackets. In various embodiments, the particular structure of the shelving assembly and the particular mounting thereof to or near the upper track layout 122 of the 3D gridded storage structure 100a in positions accessible to the RSRVs 128 operating on the upper track layout 122 vary.

The multi-zone ASRS 100 further comprises at least one neighboring workstation 114, 115. For example, two workstations 114 and 115 are attached to a perimeter side of the 3D gridded storage structure 100a of the multi-zone ASRS 100 as illustrated in FIG. 1. Each of the workstations 114 and 115 is directly coupled to the lower track layout 126 of the 3D gridded storage structure 100a illustrated in FIGS. 3-4, at a position immediately adjacent to the lower track layout 126 at an outer perimeter side of the 3D gridded storage structure 100a by a extension track on which the RSRVs 128 are configured to enter and exit the workstations 114 and 115.

In an embodiment as illustrated in FIG. 1, the workstation 114 has a single-point access configuration, where only a singular storage unit is made accessible to a human or robotic worker at the workstation 114 at any given time. In an embodiment, the single-point workstation 114 is of the type disclosed in Applicant's Patent Cooperation Treaty (PCT) international application numbers PCT/CA2019/050404 and PCT/CA2019/050815, where a short extension track of the lower track layout 126 of the 3D gridded storage structure 100a runs longitudinally below an elongated countertop 116a of the workstation 114. The elongated countertop 116a comprises a singular picking port 117a overlying an access spot on the extension track of the lower track layout 126 of the 3D gridded storage structure 100a. An RSRV 128 carrying a storage unit is configured to travel onto and along the extension track from the lower track layout 126 of the 3D gridded storage structure 100a, and park at the access spot, where the human or robotic worker can then access the storage unit through the picking port 117a, for example, to pick a product item therefrom to fulfill a customer order, optionally after having compiled the product item with one or more other product items likewise picked from one or more additional storage units delivered to and conveyed through the workstation 114 by the RSRVs 128. The single-point workstation 114 is useful for orders prioritized or scheduled for immediate or prompt pickup or delivery.

In an embodiment as illustrated in FIG. 1, the workstation 115 has a multi-point access configuration, where two storage units are made simultaneously accessible to a human or robotic worker at the workstation 115 to allow picking of a product item from one storage unit for placement into another storage unit. In an embodiment, this multi-point workstation 115 is of the type disclosed in Applicant's PCT international application number PCT/IB2020/054380, the entirety of which is incorporated herein by reference. In an embodiment, each multi-point workstation 115 has an L-shaped configuration comprising a first leg 115a and a second leg 115b. The first leg 115a of the workstation 115 projects outwardly from the perimeter side of the 3D gridded storage structure 100a. The second leg 115b of the workstation 115 extends parallel to the perimeter side of the 3D gridded storage structure 100a. In an embodiment, a two-way lower track of the workstation 115 occupies the first leg 115a thereof and is two-spots wide, with a first series of spots running outwardly from the lower track layout 126 of the 3D gridded storage structure 100a, and then a second series of spots running back to the lower track layout 126 of the 3D gridded storage structure 100a. An RSRV 128 carrying a storage unit on the lower track layout 126 of the 3D gridded storage structure 100a is therefore configured to travel outbound therefrom and return thereto on a circulatory travel path inside the first leg 115a of the workstation 115. The RSRV 128 is configured to park beneath a picking port 117b positioned in a countertop 116b of the workstation 115 at a location residing over the inbound half of the travel path to allow a human or robotic worker to pick a product item from the storage unit, before returning the storage unit into the 3D gridded storage structure 100a.

The second leg 115b of the multi-point workstation 115 comprises a placement port 118 opening through the countertop Hob of the workstation 115 in overlying relation to an access spot, which instead of overlying an RSRV-carrying extension of the lower track layout 126 of the 3D gridded storage structure 100a, overlies a short conveyor (not shown) to which storage units are dropped off by the RSRVs 128 operating on the lower track layout 126 of the 3D gridded storage structure 100a. Accordingly, a storage unit into which an order is to be placed, herein referred to as an “order bin”, is dropped off at the conveyor-based path of the second leg 115b of the workstation 115, and advanced by the conveyor to the placement port 118, where product items picked from different RSRV-carried storage units circulating through the track-based path of the first leg 115a of the workstation 115 are placed into the order bin waiting at the placement port 118. Once the order bin has been filled with the prescribed product items for the order being filled, the filled order bin is advanced on the conveyor-based path to a pickup point from where the filled order bin is retrieved by an RSRV 128 on the lower track layout 126 of the 3D gridded storage structure 100a. This RSRV 128, alone or in cooperation with another RSRV 128, is tasked with placement of the order bin into a storage location of the 3D gridded storage structure 100a for temporary storage or buffering of the filled order bin for later retrieval during a customer pickup or delivery.

In an embodiment of the multi-point workstation 115 as illustrated in FIG. 1, the two access points at which storage units are located in accessible relation to the human or robotic worker are access ports opening through a surrounding worksurface of the countertop 116b of the workstation 115. In other embodiments, other structures and configurations of the multi-point workstation 115 are implemented regardless of whether the access points are specifically open ports of an otherwise enclosed pathway through which the storage units are routed. Similarly, while in an embodiment, a conveyor-based path is implemented to serve one access point and a track-based vehicle path is implemented to serve the other access point, other combinations are also implemented, including a scenario with two track-based vehicle paths, and another with two conveyor-based vehicle paths.

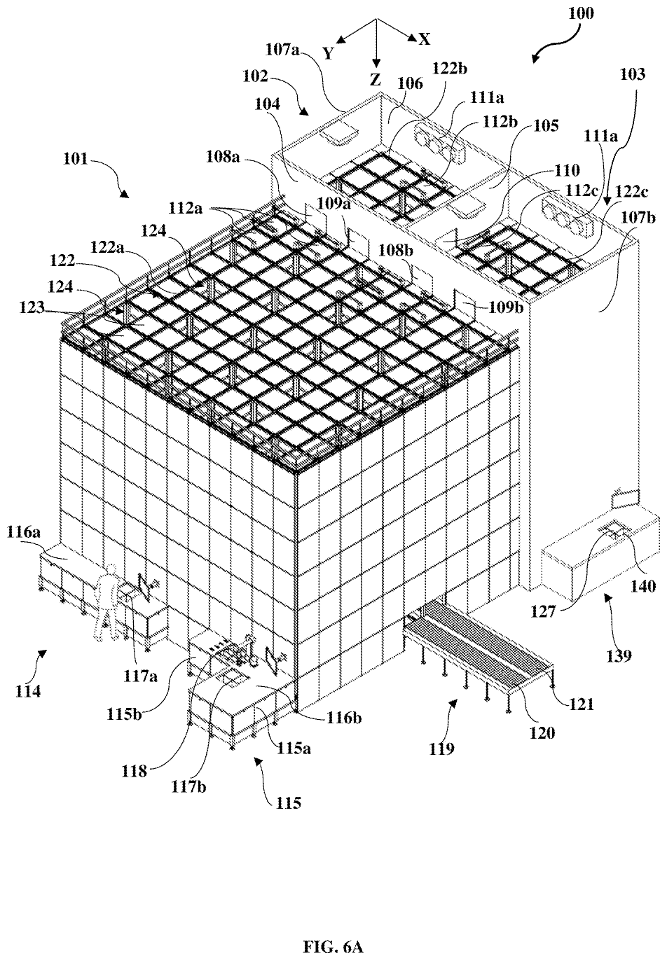

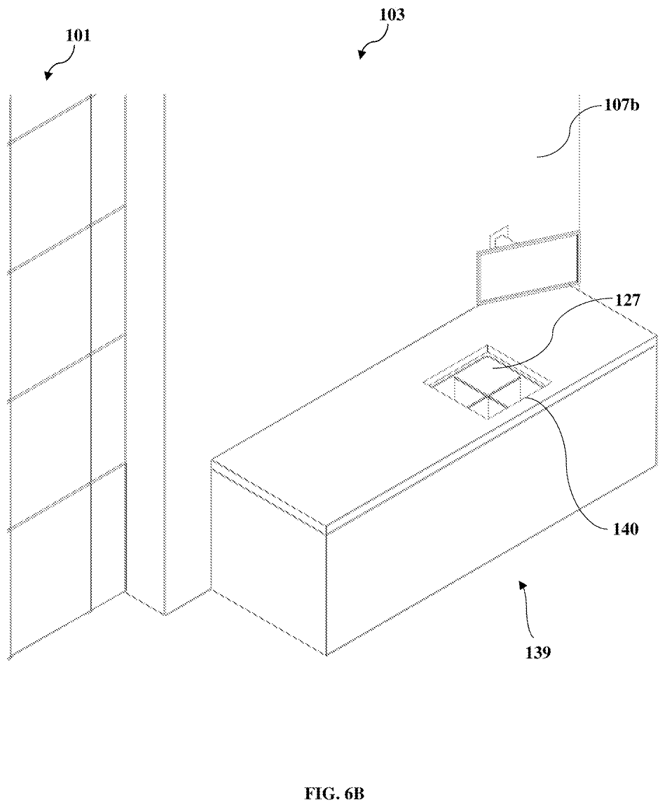

As illustrated in FIG. 1, both of the workstations 114 and 115 are connected to the lower track layout 126 of the gridded storage structure 100a at the ambient, first storage zone 101, whereby the RSRVs 128 serve the storage units to both of these workstations 114 and 115 within an ambient environment, and not from either of the cooled, second storage zone 102 and third storage zone 103. While the multi-zone ASRS 100 illustrated in FIG. 1 comprises two workstations 114 and 115 positioned on a common perimeter side of the 3D gridded storage structure 100a, in other embodiments where multiple workstations are included, the workstations are distributed among different sides of the 3D gridded storage structure 100a. In addition to the workstations 114 and 115 connected to the ambient, first storage zone 101, in an embodiment, one or more additional workstations, for example, 139, are connected to the lower track layout 126 at one or both of the cooled, second storage zone 102 and third storage zone 103 as illustrated in FIGS. 6A-6B. The additional workstations are connected to the lower track layout 126 at one or both of the cooled, second storage zone 102 and third storage zone 103, for example, via workstation access portals, for example, 107c illustrated in FIG. 3, opening through one or more of the outer perimeter walls 106, 107a, and 107b to allow the RSRVs 128 to transition between the cooled storage zone 102 or 103 and the adjacent workstation. In another embodiment, such workstations positioned at the cooled storage zones 102 and 103 are dedicated solely to orders including product items from one or both of the cooled storage zones 102 and 103. Similar to the access portals 108a, 109a, 108b, 109b, and 110 between the ambient storage zone 101 and the cooled storage zones 102 and 103, in an embodiment, the workstation access portals, for example, 107c, are equipped with strip curtains, electronically controlled doors, or other normally-closed, selectively-openable closure to insulate the workstation from the cooled storage zone 102 or 103 to allow order picking in an ambient environment. The single-point workstation 114 is used for prompt pickup/delivery needs, while a separate multi-point workstation 115 is used for temporary storage or buffering of orders in the 3D gridded storage structure 100a for later pickup/delivery. In other embodiments, the multi-zone ASRS 100 optionally employs only one or the other type of workstation 114 or 115, in a single-station scenario or a multi-station scenario.

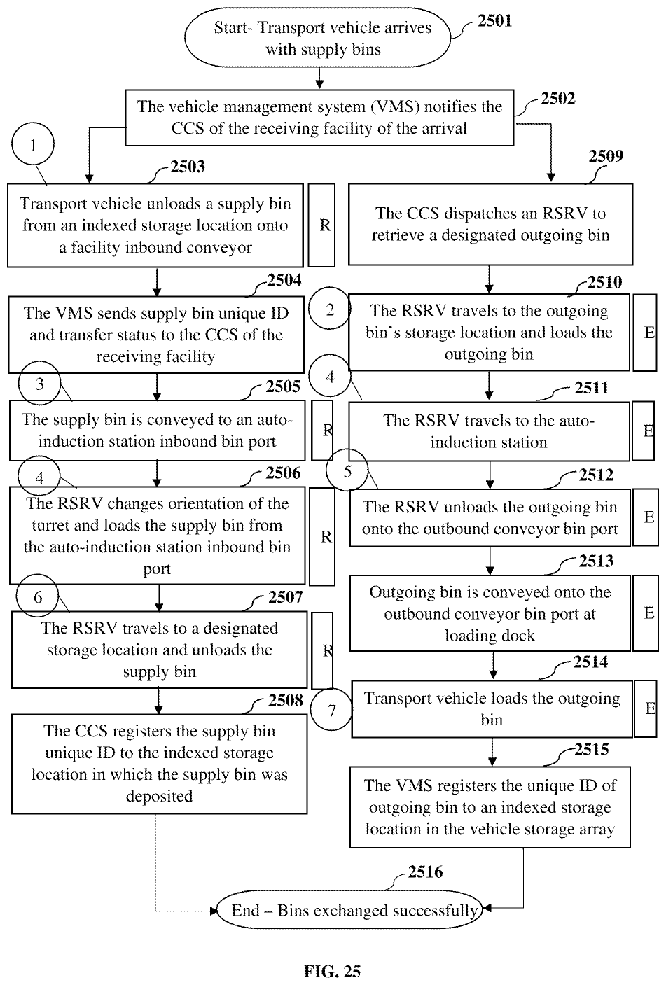

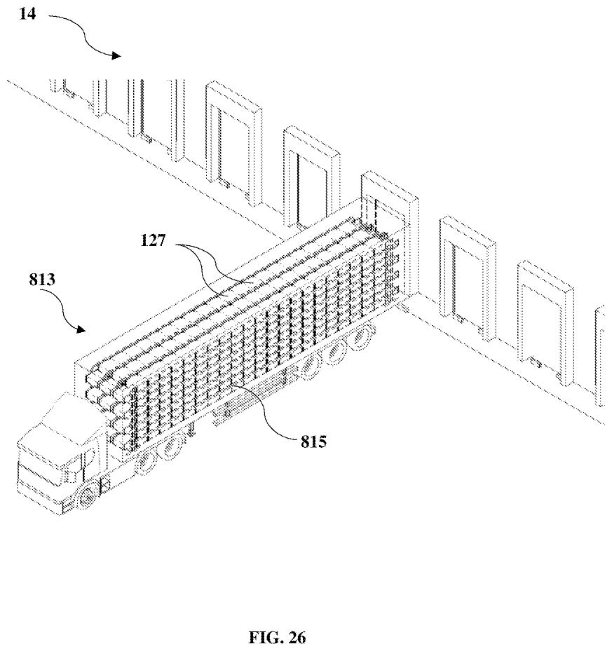

Furthermore, in an embodiment, the multi-zone ASRS 100 further comprises a bin exchange area 119 as illustrated in FIG. 1. The bin exchange area 119 comprises an outbound conveyor 121 and a neighboring inbound conveyor 120. The outbound conveyor 121 spans outward from the lower track layout 126 of the 3D gridded storage structure 100a at one side thereof. As exemplarily illustrated in FIG. 1, the outbound conveyor 121 spans outward from the lower track layout 126 of the 3D gridded storage structure 100a at the ambient, first storage zone 101 of the multi-zone ASRS 100. The neighboring inbound conveyor 120 is positioned in adjacent parallel relation to the outbound conveyor 121 at the same side of the 3D gridded storage structure 100a. The bin exchange area 119 employs the outbound conveyor 121 and the neighboring inbound conveyor 120 for performing bin exchange operations as disclosed in the detailed description of FIGS. 24-25.

FIG. 3 illustrates a cutaway, perspective view of the multi-zone automated storage and retrieval system (ASRS) 100, showing partial sections of the upper track layout 122 and the lower track layout 126 of the three-dimensional (3D) gridded storage structure employed by the multi-zone ASRS 100, according to an embodiment herein. In an embodiment, the track layout of the multi-zone ASRS 100 comprises a lower track layout 126 positioned below the storage locations of the 3D gridded storage structure 100a as illustrated in FIG. 3. In this embodiment, the barrier 104 comprises a lower portion standing upright from the lower track layout 126. One or more portals, for example, 108a, 109a, 108b, and 109b, are configured to open through the barrier 104 at the lower portion thereof to accommodate a connective track segment 126b of the lower track layout 126 that interconnects the first track area 126a, the second track area (not shown in FIG. 3), and the third track area 126c of the lower track layout 126. As illustrated in FIG. 3, the lower portion of the full-span harrier wall 104 comprises at least one access portal 108a, 109a, 108b, or 109b, and in an embodiment, a pair of access portals 108a, 109a and/or 108b, 109b opening through the barrier wall 104 from the first storage zone 101 into each of the second storage zone 102 and the third storage zone 103.

Similar to the upper track layout 122, the lower track layout 126 comprises connective track segments 126b running through the lower access portals 108a, 109a, 108b, and 109b to connect the first track area 126a of the lower track layout 126 positioned in the first storage zone 101 with the second track area and the third track area 126c of the lower track layout 126 positioned respectively inside the second storage zone 102 and the third storage zone 103. Accordingly, by riding through the lower access portals 108a, 109a, 108b, and 109b on the connective track segments 126b of the lower track layout 126, the RSRVs 128 travel into and out of the second storage zone 102 and the third storage zone 103 from and back into the first storage zone 101. In various embodiments of RSRV routing techniques disclosed herein, both the entrance and exit of the RSRVs 128 to and from the second storage zone 102 and the third storage zone 103 are employed at the upper track layout 122, and hence both entrance and exit access portals 108a, 108b, and 109a, 109b are implemented in the 3D gridded storage structure 100a, while transitions of the RSRVs 128 between the storage zones 101, 102, and 103 at the lower track level is limited to a one-way travel in an exiting direction from the second storage zone 102 and the third storage zone 103 back into the first storage zone 101, in which case a singular lower access portal between the ambient, first storage zone 101 and each of the cooled storage zones 102 and 103 are employed. In an embodiment similar to the access portal 110 at the upper track layout 122, an additional access portal (not shown) between the second storage zone 102 and the third storage zone 103 is optionally included at the lower portion of the partial-span barrier wall 105 to allow transition of the RSRVs 128 directly between the second track area and the third track area 126c of the lower track layout 126. In an embodiment, the storage units stored in the first group of storage locations of the first storage zone 101 and the second group of storage locations of the second storage zone 102, and in an embodiment, the third group of storage locations of the third storage zone 103, are accessible by any one of a plurality of workstations, for example, 114 and 115 illustrated in FIG. 1, attached to the lower track layout 126 that extends continuous to the first storage zone 101, the second storage zone 102, and the third storage zone 103.

FIG. 4 illustrates a top isometric view of the three-dimensional (3D) gridded storage structure 100a employed by the multi-zone ASRS 100 shown in FIGS. 1-3, according to an embodiment herein. FIG. 4 illustrates a small-scale example of the structural framework of the 3D gridded storage structure 100a. As exemplarily illustrated in FIG. 4, the 3D gridded storage structure 100a comprises a gridded upper track layout 122 positioned in an elevated horizontal plane above a matching and aligned gridded lower track layout 126 positioned in a lower horizontal plane at or near ground level. Between the aligned gridded upper and lower track layouts 122 and 126 is a 3D array of storage locations. Each of the storage locations is configured to hold a respective storage unit 127 therein. The storage locations are arranged in vertical storage columns 123, in which storage locations of equal square footprint are aligned over one another. The storage columns 123 are configured to receive the placement of the storage units 127 therein. Each of the storage columns 123 is neighbored by a vertically upright access shaft 124 through which the storage locations of the corresponding storage column 123 are accessible.

The multi-zone ASRS 100 disclosed herein comprises a common class of robotic handlers or robotic storage/retrieval vehicles (RSRVs) 128 that are configured to operate in all the different environmentally controlled storage zones, for example, 101, 102 and 103, of the multi-zone ASRS 100 illustrated in FIGS. 1-3, with optimized buffering of the RSRVs 128 within the multi-zone ASRS 100 when the RSRVs 128 transition between the different environmentally controlled storage zones 101, 102, and 103. The fleet of RSRVs 128 is configured to horizontally traverse each of the upper track layout 122 and the lower track layout 126 in two dimensions, and traverse through the open access shafts 124 in a third vertical dimension and thereby travel between the upper track layout 122 and the lower track layout 126. The RSRVs 128 are configured to deposit and retrieve the storage units 127 to and from the storage locations. The RSRVs 128 are further configured to travel on the upper track layout 122 on the first track area 122a, the second track area 122b, and the third track area 122c as illustrated in FIG. 1, to respectively access the first, second and third groups of storage locations therefrom. The RSRVs 128 are further configured to travel on the lower track layout 126 on the first track area 126a, the second track area (not shown), and the third track area 126c as illustrated in FIG. 3.

The RSRVs 128 are further configured to travel between the first track area 122a, the second track area 122b, and the third track area 122c of the upper track layout 122 via the connective track segments 122d connected therebetween as illustrated in FIG. 15 and FIG. 24. Similarly, the RSRVs 128 are further configured to travel between the first track area 126a, the second track area (not shown), and the third track area 126c of the lower track layout 126 via the connective track segments 126b connected therebetween as illustrated in FIG. 3. In an embodiment, the RSRVs 128 are configured to travel on at least one track layout, for example, the upper track layout 122, between access locations at which different storage columns 123 are accessible by the RSRVs 128 to deposit and retrieve the storage units 127 into and from the storage columns 123. In an embodiment, the access locations comprise unoccupied access shafts 124 around which the storage columns 123 are clustered and through which the RSRVs 128 are configured to travel to access multiple levels of the storage columns 123. Each of the unoccupied access shafts 124 is neighbored by at least one of the storage columns 123 to and from which the storage units 127 are placeable and retrievable by the RSRVs 128 from within each of the unoccupied access shafts 124.

Each of the upper track layout 122 and the lower track layout 126 comprises a set of X-direction rails 129 lying in the X-direction of the respective horizontal plane, and a set of Y-direction rails 130 perpendicularly crossing the X-direction rails 129 in the Y-direction of the same horizontal plane. The crossing rails 129 and 130 define a horizontal reference grid of the 3D gridded storage structure 100a, where each horizontal grid row is delimited between an adjacent pair of the X-direction rails 129 and each horizontal grid column is delimited between an adjacent pair of the Y-direction rails 130. Each intersection point between one of the horizontal grid columns and one of the horizontal grid rows denotes a two-dimensional position of a respective vertical storage column 123 or a respective vertical access shaft 124. That is, each storage column 123 and each access shaft 124 are positioned at a respective X, Y Cartesian coordinate point of the reference grid at a respective area bound between two of the X-direction rails 129 and two of the Y-direction rails 130. Each such area bound between four rails 129 and 130 in either the upper track layout 122 or the lower track layout 126 is referred to herein as a respective “spot” of the track layout 122 or 126. The 3D address of each storage location in the 3D gridded storage structure 100a is, therefore, a combination of the X, Y coordinates of the storage column 123 in which that storage location is positioned, plus the vertical level or Z coordinate at which the storage location is positioned within that storage column 123.

A respective upright frame member 131 spans vertically between the upper track layout 122 and the lower track layout 126 at each intersection point between the X-direction rails 129 and the Y-direction rails 130, thereby cooperating with the track rails 129 and 130 to define a skeletal framework of the 3D gridded storage structure 100a for containing and organizing the 3D array of storage units 127 within the skeletal framework. As a result, each access shaft 124 of the 3D gridded storage structure 100a comprises four vertical frame members 131 spanning the full height of the access shaft 124 at the four corners thereof. Each frame member 131 comprises respective sets of rack teeth arranged in series in the vertical Z-direction of the 3D gridded storage structure 100a on two sides of the frame member 131. Each access shaft 124, therefore, comprises eight sets of rack teeth in total, with two sets at each corner of the access shaft 124. These eight sets of rack teeth cooperate with eight pinion wheels 133b on each of the RSRVs 128 illustrated in FIGS. 5A-5B, to allow vertical traversal of each RSRV 128 between the upper track layout 122 and the lower track layout 126 in ascending and descending directions through the access shafts 124 of the 3D gridded storage structure 100a.

FIG. 5A illustrates a robotic storage/retrieval vehicle (RSRV) 128 and a compatible storage unit 127 employed in the multi-zone automated storage and retrieval system (ASRS) 100 shown in FIGS. 1-3, according to an embodiment herein. Each RSRV 128 comprises a wheeled frame or chassis 132 including both round conveyance wheels 133a and toothed pinion wheels 133b. The conveyance wheels 133a are configured for horizontal traversal of the RSRV 128 in its entirety over the upper track layout 122 and the lower track layout 126 of the three-dimensional (3D) gridded storage structure 100a illustrated in FIG. 4 in a track-riding mode. The toothed pinion wheels 133b are positioned inwardly of the conveyance wheels 133a for vertical traversal of the RSRV 128 in its entirety through the rack-equipped access shafts 124 in a shaft-traversing mode. Each toothed pinion wheel 133b and a respective conveyance wheel 133a are part of a combined singular wheel unit, of which the entirety, or at least the conveyance wheel 133a, is horizontally extendable in an outboard direction from the RSRV 128 for use of the conveyance wheels 133a in a track-riding mode on the upper track layout 122 or the lower track layout 126, and horizontally retractable in an inboard direction of the RSRV 128 for use of the toothed pinion wheels 133b in a shaft-traversing mode where the pinion wheels 133b are engaged with the rack teeth of the upright frame members 131 of an access shaft 124 illustrated in FIG. 4. The outboard extension of the conveyance wheels 133a, therefore, enlarges an overall footprint of the RSRV 128 to a size exceeding the square area of each access shaft 124 to allow the RSRV 128 to ride on the track rails 129 and 130 of the upper track layout 122 or the lower track layout 126 illustrated in FIG. 4, while inboard retraction of the conveyance wheels 133a reduces the overall footprint of the RSRV 128 to a less size than the square area of each access shaft 124 to allow travel of the entire RSRV 128 through the access shaft 124.

A set of four X-direction wheel units is arranged in pairs on two opposing sides of the RSRV 128 to drive the RSRV 128 on the X-direction rails 129 of the upper track layout 122 or the lower track layout 126 of the 3D gridded storage structure 100a. A set of four Y-direction wheel units is arranged in pairs on the other two opposing sides of the RSRV 128 to drive the RSRV 128 on the Y-direction rails 130 of the upper track layout 122 or the lower track layout 126 of the 3D gridded storage structure 100a. One set of wheel units is an elevationally-adjustable set of wheel units that is raiseable or lowerable relative to the other elevationally-fixed set of wheel units that is positioned at a fixed height on the frame or chassis 132 of the RSRV 128. Such height adjustment of one set of wheel units relative to the other on the upper track layout 122 or the lower track layout 126 of the 3D gridded storage structure 100a is operable to switch the RSRV 128 between an X-direction travel mode and a Y-direction travel mode by controlling which one of the two sets of wheel units currently contact the respective rails 129 and 130 of the upper track layout 122 or the lower track layout 126, and which does not. Raising one set of wheel units when in the outboard positions seated on the upper track layout 122 is also operable to lower the other set of wheel units into engagement with the rack teeth of an access shaft 124, after which the raised wheel units are then also shifted inboard, thereby completing transition of the RSRV 128 from the upper track layout 122 into an access shaft 124 for descending travel therethrough. Similarly, lowering one set of wheel units when in the outboard positions seated on the lower track layout 126 is also operable to raise the other set of wheel units into engagement with the rack teeth of an access shaft 124, after which the lowered wheel units are then also shifted inboard, thereby completing transition of the RSRV 128 from the track-riding mode to the shaft-traversing mode. In an embodiment, a lifting mechanism defined separately of the RSRV 128 and installed in the lower track layout 126 is used to air or perform lifting of the RSRV 128 from the lower track layout 126 into an overlying access shaft 124, as disclosed in Applicant's PCT Application numbers PCT/CA2019/050404 and PCT/CA2019/050815.

Each RSRV 128 further comprises an upper support platform 138 on which the storage unit 127 is receivable for carrying thereon. The upper support platform 138 comprises a rotatable turret 135 surrounded by a stationary outer deck surface 134. The rotatable turret 135 comprises an extendable/retractable arm 136 mounted in a diametric slot of the rotatable turret 135 and movably supported therein for linear movement into and out of a deployed position extending outwardly from the outer circumference of the rotatable turret 135.

FIG. 5B illustrates the robotic storage/retrieval vehicle (RSRV) 128 and the compatible storage unit 127 of FIG. 5A, showing an extension of the arm 136 of the rotatable turret 135 of the RSRV 128 for engaging with the storage unit 127 to push or pull the storage unit 127 off of or onto the RSRV 128, according to an embodiment herein. The arm 136 carries a catch member 137 thereon, for example, mounted on a shuttle movable back and forth along the arm 36, to engage with a mating catch mechanism in the underside of the storage unit 127. Together with the rotatable function of the turret 135, the catch member 137 allows pulling of a storage unit 127 onto the upper support platform 138 and pushing of the storage unit 127 off the upper support platform 138 at all four sides of the RSRV 128 so that each RSRV 128 can access a storage unit 127 on any side of any access shaft 124 in the three-dimensional (3D) gridded storage structure 100a illustrated in FIG. 4, including fully-surrounded access shafts 124 that are each surrounded by storage columns 123 on all four sides of the access shaft 124 for optimal storage density in the 3D gridded storage structure 100a. That is, each RSRV 128 is operable in four different working positions inside any of the access shafts 124 to reach into any of the storage locations on any of the four different sides of the access shaft 124 to deposit or withdraw a respective storage unit 127 to or from the selected storage location. While in an embodiment, four such working positions are achieved by a singular arm 136 that is movable into working relation with the four different sides of the RSRV 128 by rotation of the turret 135 on which the arm 136 is carried, in other embodiments, other configurations for enabling storage unit interaction and engagement at all four sides of the RSRV 128 are employed, for example, with multiple arms deployable at different sides of the RSRV 128 to enable arm-selective extension from any of the four sides thereof.

The framework of the 3D gridded storage structure 100a comprises a set of shelving brackets at each storage location to cooperatively form a shelf for the storage unit 127 currently stored at the storage location, whereby any storage unit 127 can be removed from its storage location by one of the RSRVs 128 without disrupting the storage units 127 above and below the given storage unit 127 in the same storage column 123. This allows a storage unit 127 to be returned to a prescribed storage location at any level in the 3D gridded storage structure. Accordingly, through two-dimensional horizontal navigation of the track layouts 122 and 126, each RSRV 128 is configured to access any of the access shafts 124, and is able to travel vertically therethrough in ascending or descending directions in the third dimension to access any of the storage locations and deposit or withdraw a storage unit 127 therefrom.

FIG. 6A illustrates a top perspective view of the multi-zone automated storage and retrieval system (ASRS) 100, showing a workstation 139 attached to a storage zone, for example, the third storage zone 103 of the multi-zone ASRS 100 to allow a worker to operate on product items having non-ambient temperatures in an ambient environment, while maintaining a storage unit 127 containing the product items in the storage zone, according to an embodiment herein. In addition to workstations 114 and 115 connected to the ambient, first storage zone 101, in an embodiment, one or more additional workstations, for example, 139, are connected to the lower track layout 126 at one or both of the cooled, second storage zone 102 and third storage zone 103 as illustrated in FIGS. 6A-6B. As exemplarily illustrated in FIG. 6A, an additional workstation 139 is connected to the lower track layout 126 at the cooled, third storage zone 103, for example, via a workstation access portal 107c illustrated in FIG. 3, opening through the outer perimeter wall 107b to allow the RSRVs 128 to transition between the cooled, third storage zone 103 and the adjacent workstation 139. In an embodiment, the workstation 139 is positioned at the cooled, third storage zone 103 for managing orders including product items, for example, from the cooled, third storage zone 103. Storage units 127 are presented to a picking port 140 of the workstation 139 to allow picking of product items, for example, frozen goods, for order fulfillment.

FIG. 6B illustrates an enlarged view of the workstation 139 shown in FIG. 6A, according to an embodiment herein. The workstation 139 is attached directly to one of the storage zones, for example, the cooled, third storage zone 103 to allow a human worker to pick frozen/chilled goods from a storage unit 127 presented at the picking port 140, in ambient temperatures, while keeping the storage unit 127 in the cooled, third storage zone 103. The workstation 139 is configured with insulation properties.

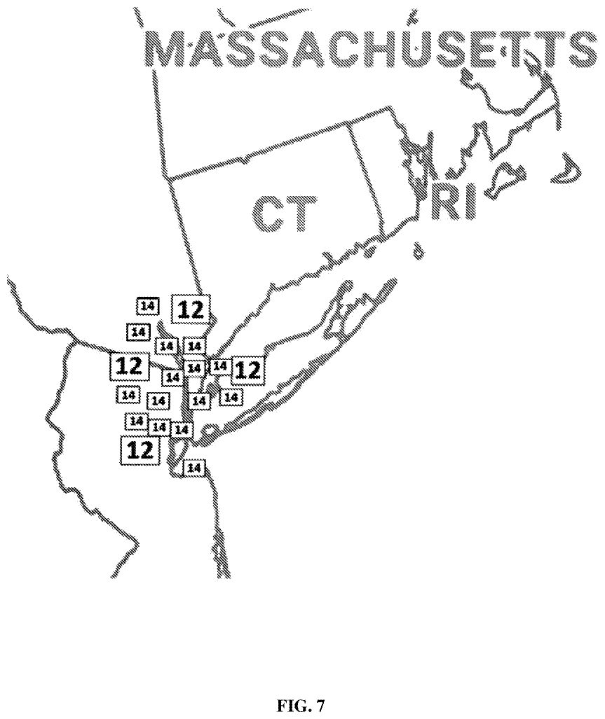

FIG. 7 illustrates a group of interconnected facilities, for example, 12, 14 in a supply chain or distribution network, including a supply facility 12 that supplies replenishing inventory to numerous smaller, receiving facilities 14 at which customer orders are fulfilled from an automated storage and retrieval system (ASRS), according to an embodiment herein. In an embodiment, the ASRS employed at each of the receiving facilities 14 is the multi-zone ASRS 100 disclosed in the detailed descriptions of FIGS. 1-3. The embodiments herein also implement management of inventory levels at the ASRS of the type illustrated in FIGS. 1-3 based on replenishment of the inventory levels from another facility 12 that, in an embodiment, is optionally equipped with a similar ASRS using the same type of storage units, and whereby the transport of inventory between the two facilities 12 and 14 is performed using the ASRS-compatible storage units of the facilities 12 and 14. The equipment and techniques disclosed herein for such inventory management purposes are employed regardless of whether the ASRS of either facility 12 or 14 is a multi-zone ASRS 100 or a single-zone ASRS. The facility 14 at which the inventory is being replenished is herein referred to as a “receiving facility”, while the facility 12 from which the replenishment inventory is being supplied is herein referred to as a “supply facility”. Moreover, the storage units being shipped from the supply facility 12 with new inventory therein are herein referred to as “supply bins”, while the storage units already residing in the ASRS of the receiving facility 14 are referred to as “inventory bins”. In an embodiment, the receiving facility 14 is an order fulfillment facility at which customer orders are fulfilled for pickup or delivery, while the supply facility 12 is a larger regional distribution facility that supplies replenishment inventory to a plurality of order fulfillment facilities at different locales within a larger geographic region.

In an embodiment, the centers and transport vehicles used therebetween are part of a larger overall facility and vehicle network in a supply chain or distribution ecosystem, for example, as disclosed in Applicant's PCT international patent application numbers PCT/IB2020/051721 and PCT/IB2020/052287, which are incorporated herein by reference in their entirety. In an embodiment, a four-tiered hierarchy of different facility types is employed. The four-tiered hierarchy comprises mega facilities, macro facilities, micro facilities, and nano facilities. In this order, the quantity of facilities in each category increases from one category to the next, while the individual size of each facility reduces from one category to the next. Typically, the mega facilities form entry points at which products from manufacturers or suppliers first enter the network of facilities, while the nano facilities form exit points from which products depart the network of facilities. The products may enter and depart the network of facilities at various points. Each facility comprises an ASRS of the same three-dimensional (3D) gridded storage structure and RSRV type disclosed in the detailed descriptions of FIG. 4 and FIGS. 5A-5B, whereby product is shipped between facilities within the identically or similarly sized and configured storage units that are compatible with the ASRS of each facility. FIG. 7 illustrates an example where the supply facility 12 is a macro facility such as a macro distribution center of a national facility network, and the receiving facilities 14 are micro facilities such as micro-fulfillment centers at which customer orders are fulfilled, and from which the fulfilled orders are in an embodiment, optionally shipped further downstream to neighborhood level nano facilities for either direct pickup by customers, or pickup by last-leg delivery personnel who deliver the fulfilled orders to the customers' homes or businesses. In an embodiment, the additional nano facility is omitted, in which case pickup by customers or last-leg delivery personnel occurs directly at the receiving facility 14.

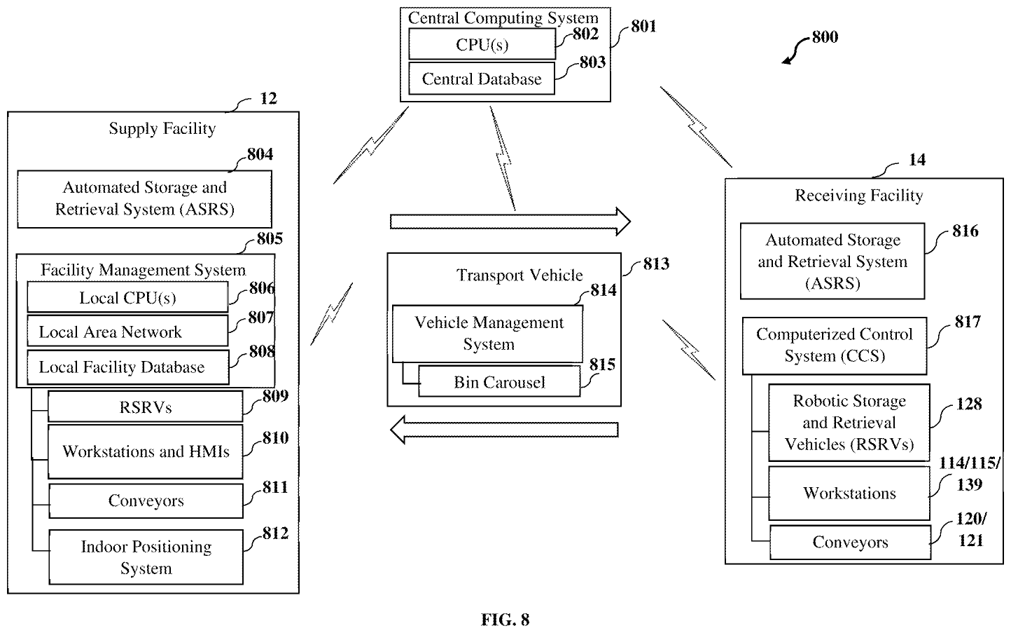

FIG. 8 illustrates an architectural block diagram of a system 800 for executing an inventory replenishment workflow comprising a 1:1 exchange of transportable storage units, according to an embodiment herein. The system 800 disclosed herein monitors and controls movement of storage units throughout a supply chain or distribution ecosystem. The system 800 controls and monitors induction, storage, transport, and tracking of inventory contained in the storage units and fulfillment of customer orders therefrom. The system 800 comprises multiple computer systems that are programmable using high-level computer programming languages. In an embodiment as illustrated in FIG. 8, the system 800 comprises a combination of a central computing system 801, a computerized facility management system (FMS) 805 configured at a supply facility 12, a computerized control system (CCS) 817 configured at a receiving facility 14, and a computerized vehicle management system (VMS) 814 configured in each of a plurality of inter-nodal transport vehicles, for example, 813, that executes an exchange of storage units between the supply facility 12 and the receiving facility 14. The computing systems 801, 805, 817, and 814 are implemented using programmed and purposeful hardware. The supply facility 12 houses an automated storage and retrieval system (ASRS) 804 of a multi-zone type as illustrated in FIGS. 1-3 or a single-zone type. The receiving facility 14 houses an ASRS 816 of a multi-zone type as illustrated in FIGS. 1-3 or a single-zone type.

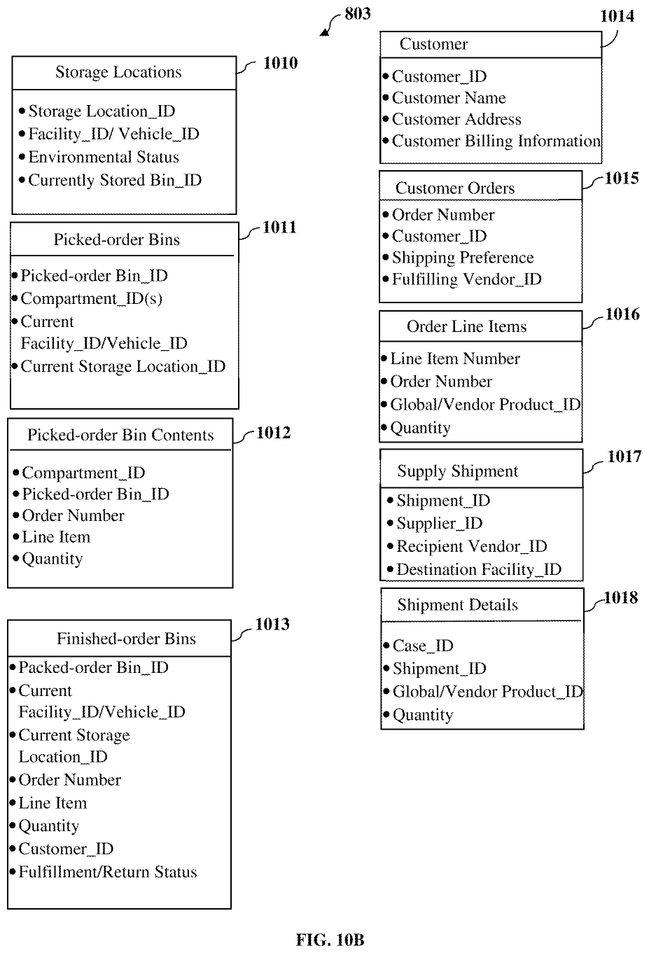

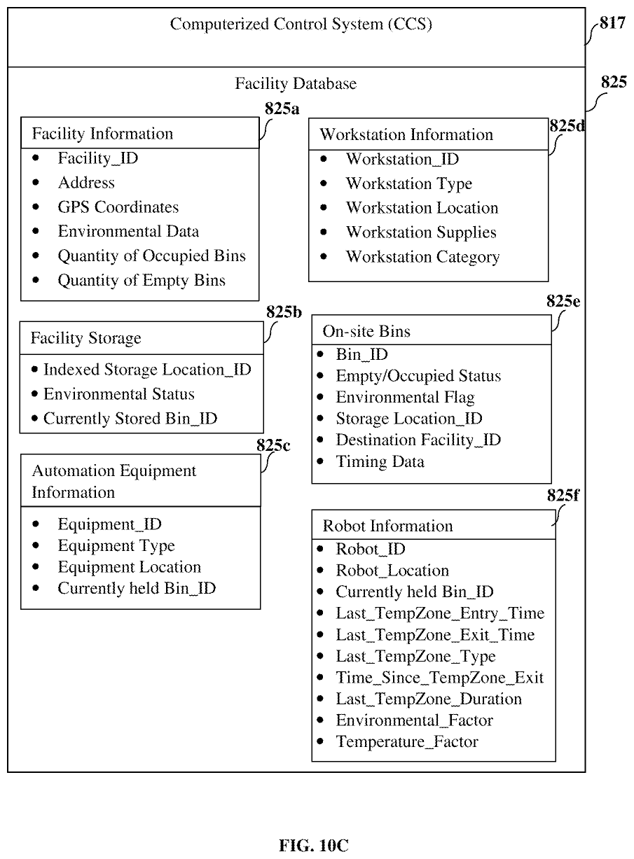

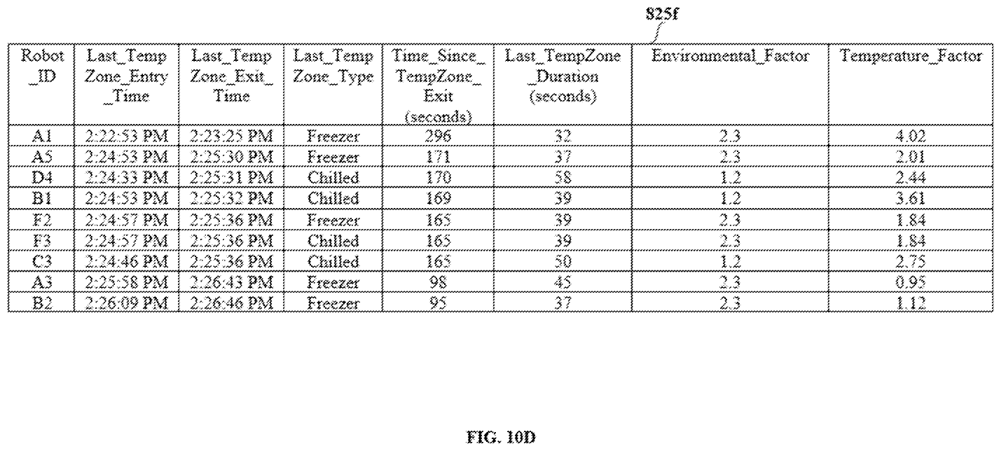

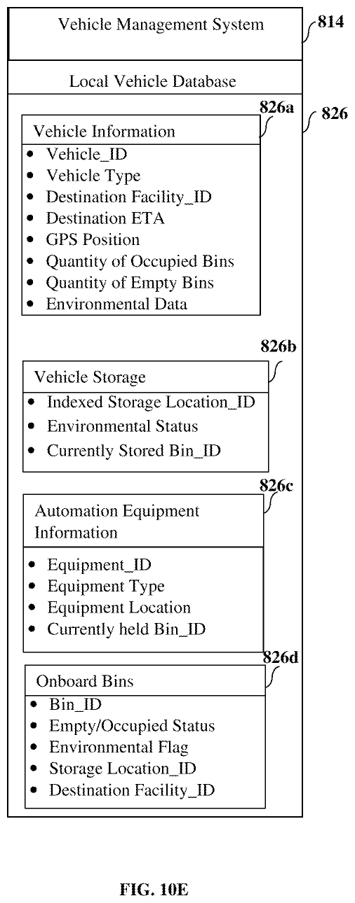

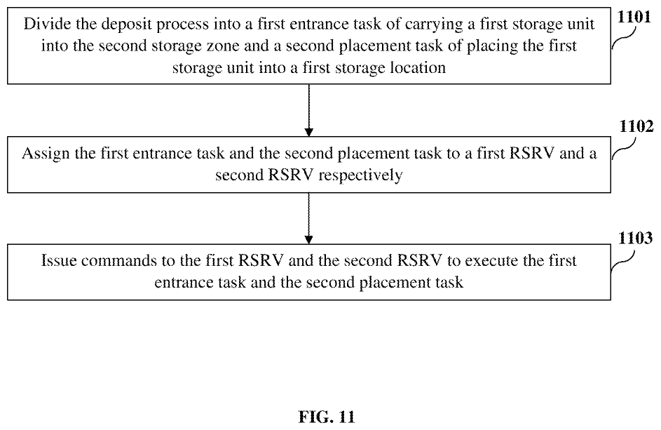

The central computing system 801 comprises one or more computers comprising one or more processors, for example, central processing units (CPUs) 802 connected to a network interface coupled to a communication network, for example, the Internet or other wide area network, and one or more data storage devices comprising non-transitory, computer-readable storage media or memory among which there is stored executable software for execution by the processors to execute multiple processes disclosed herein. As used herein, “non-transitory, computer-readable storage media” refers to all computer-readable media that contain and store computer programs and data. Examples of the computer-readable media comprise hard drives, solid state drives, optical discs or magnetic disks, memory chips, a read-only memory (ROM), a register memory, a processor cache, a random-access memory (RAM), etc. The data storage devices comprise one or more databases, for example, a central database 803 in which, among other data disclosed below, stores unique bin identifiers (Bin_IDs) of all the storage units illustrated in FIGS. 10A-10B, unique identifiers (Vendor_IDs) of multiple vendors who have contracted or subscribed to services of an operating entity for the purpose of inventory storage and order fulfillment; and respective inventory catalogues of inventory items or products that are offered by the vendors to their customers, and are stored or storable within the system 800. As used herein, the term “central” in relation to the central computing system 801 and the central database 803 hosted thereby merely denotes its status as a shared resource operably connected to each of the facilities 12 and 14 and each of the inter-nodal transport vehicles, for example, 813, of the system 800, and does not denote that its components must all reside at a common location.

As used herein, “communication network” refers, for example, to one of the Internet, a wireless network, a communication network that implements Bluetooth® of Bluetooth Sig, Inc., a network that implements Wi-Fi® of Wi-Fi Alliance Corporation, an ultra-wideband (UWB) communication network, a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a fifth generation (5G) mobile communication network, a long-term evolution (LTE) mobile communication network, a public telephone network, etc., a local area network, a wide area network, an internet connection network, an infrared communication network, etc., or a network formed from any combination of these networks. The communication network allows the FMS 805, the VMS 814, and the CCS 817 to communicate with each other and with the central computing system 801.

In an embodiment, the system 800 disclosed herein is implemented in a cloud computing environment. As used herein, “cloud computing environment” refers to a processing environment comprising configurable computing physical and logical resources, for example, networks, servers, storage media, virtual machines, applications, services, etc., and data distributed over a communication network. The cloud computing environment provides an on-demand network access to a shared pool of the configurable computing physical and logical resources. In an embodiment, the system 800 disclosed herein is a cloud computing-based platform implemented as a service for executing an inventory replenishment workflow comprising a 1:1 exchange of transportable storage units. In this embodiment, the central computing system 801 and the central database 803 are herein referred to as a cloud-based computer platform and a cloud database respectively. In an embodiment, the computerized FMS 805 and the CCS 817 are implemented as on-premise software installed and run on computers on the premises of the supply facility 12 and the receiving facility 14 respectively. In an embodiment, the VMS 814 is implemented as an on-premise software installed and run on computers on the premises of each of the transport vehicles, for example, 813.

The computerized FMS 805 is installed at the supply facility 12. The FMS 805 comprises one or more local computers comprising one or more processors, for example, central processing units (CPUs) 806 connected to a network interface coupled to the communication network, for example, the Internet or other wide area network, and one or more data storage devices comprising non-transitory, computer-readable storage media in which there is stored executable software for execution by one more processors to execute multiple processes disclosed herein. The data storage devices comprise one or more databases, for example, a local facility database 808 for storing data pertinent to the supply facility 12. In addition to their connection to the wide area network, the local computers of the FMS 805 are installed in one or more local area networks 807, for example, local wireless networks, of the supply facility 12, by which at least one of the local computers are communicable with automated bin handling equipment of the supply facility 12. The automated bin handling equipment comprises, for example, the robotic handlers or robotic storage/retrieval vehicles (RSRVs) 809 at the supply facility 12, and various conveyors 811 and other handling equipment. Over the local area networks 807, at least one of the local computers of the FMS 805 also communicates with workstations and other equipment and devices comprising, for example, stationary and/or mobile human-machine interfaces (HMIs) 810 for guiding performance of various tasks by human workers, conveyors 811, and the storage units. In an embodiment, the system 800 further comprises an indoor positioning system 812 in operable communication with the FMS 805 of the supply facility 12 for real-time tracking of each of the storage units.

The computerized VMS 814 is installed in each of the inter-nodal transport vehicles, for example, 813, of the system 800. Each VMS 814 comprises one or more local computers comprising one or more processors, for example, central processing units (CPUs) connected to one or more data storage devices comprising non-transitory, computer-readable storage media in which there is stored executable software for execution by the processors to execute multiple processes disclosed herein. The data storage devices comprise a local vehicle database that stores data pertinent to that particular transport vehicle 813 and the transported contents thereof. In an embodiment, a wireless communications unit is operably coupled to the transport vehicle 813. The wireless communications unit, for example, a wide area communication device, is configured to communicate the location of the transport vehicle 813 and the location of any one of the storage units to the central computing system 801, the FMS 805, and the CCS 817 during transport of the storage units between the facilities 12 and 14. For example, the processors of the VMS 814 are connected to a wireless wide area communications device, for example, a cellular communications device, for mobile communication with the central computing system 801 over a wireless wide area network, for example, a cellular network. In an embodiment, a positioning unit, for example, a global positioning system (GPS) device is operably coupled to the transport vehicle 813. The positioning unit is configured to determine a location of the transport vehicle 813 and in turn determine a location of any one of the storage units being transported in the transport vehicle 813. The GPS device is also connected to at least one processor of at least one of the local computers of the transport vehicle 813 for tracking the movement of the transport vehicle 813 via the GPS and sharing the calculated GPS coordinates of the transport vehicle 813 to the respective local computers for communication onward to the central computing system 801. In an embodiment, the GPS device of the transport vehicle 813 communicates directly with the central computing system 801 to report the GPS coordinates thereto, independent of the local computers of the VMS 814. In an embodiment, the local computers of the VMS 814 are installed in a local area network by which at least one of the local computers is communicable with the storage units. In an embodiment, the VMS 814 is operably and communicatively coupled to bin handling equipment, for example, bin carousels 815 installed in the transport vehicle 813.

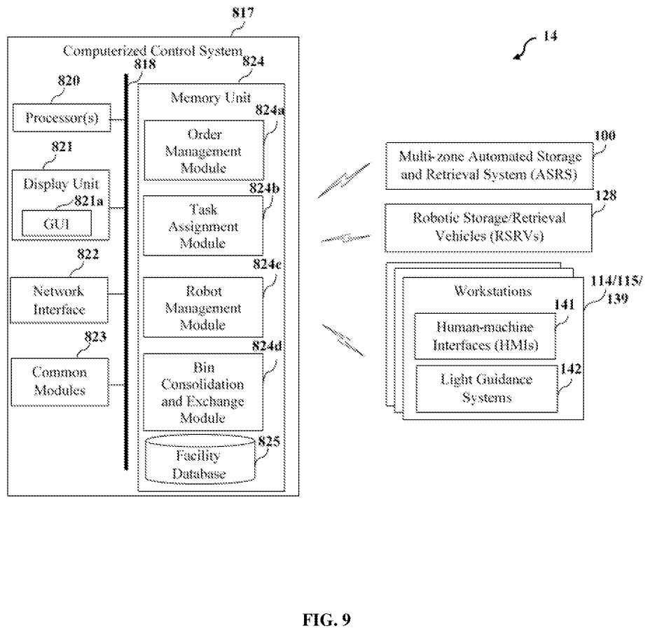

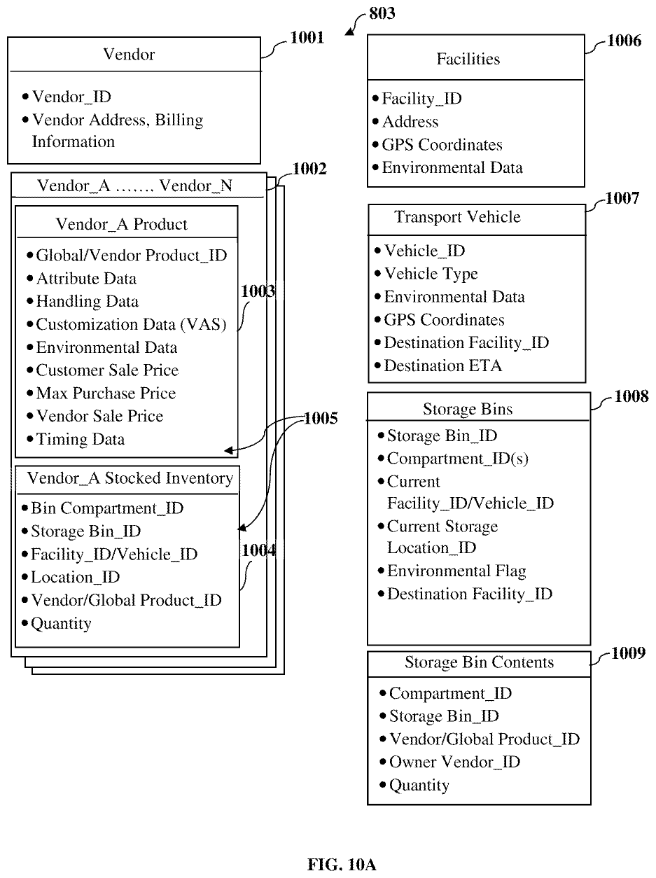

The CCS 817 configured at the receiving facility 14 controls the RSRVs 128, workstations 114, 115, and 139, and conveyors 120 and 121 for managing orders, executing the 1:1 exchange of transportable storage units between the supply facility 12 and the receiving facility 14, and controlling operations of the RSRVs 128 in the ASRS 816 as disclosed in the detailed description of FIG. 9.

The processors disclosed above refer to any one or more microprocessors, CPU devices, finite state machines, computers, microcontrollers, digital signal processors, logic, a logic device, an application specific integrated circuit (ASIC), a field-programmable gate array (FPGA), a chip, etc., or any combination thereof, capable of executing computer programs or a series of commands, instructions, or state transitions. In an embodiment, each of the processors is implemented as a processor set comprising, for example, a programmed microprocessor and a math or graphics co-processor. The system 800 is not limited to employing processors. In an embodiment, the system 800 employs controllers or microcontrollers.

The network interfaces disclosed above are, for example, one or more of infrared interfaces, interfaces implementing Wi-Fi® of Wi-Fi Alliance Corporation, universal serial bus interfaces, FireWire® interfaces of Apple Inc., Ethernet interfaces, frame relay interfaces, cable interfaces, digital subscriber line interfaces, token ring interfaces, peripheral controller interconnect interfaces, local area network interfaces, wide area network interfaces, interfaces using serial protocols, interfaces using parallel protocols, Ethernet communication interfaces, asynchronous transfer mode interfaces, high speed serial interfaces, fiber distributed data interfaces, interfaces based on transmission control protocol/internet protocol, interfaces based on wireless communications technology such as satellite technology, radio frequency technology, near field communication, etc.

The databases of the system 800, for example, the central database 803, the local facility database 808, and the local vehicle databases refer to any storage area or media that can be used for storing data and files. The databases can be, for example, any of a structured query language (SQL) data store or a not only SQL (NoSQL) data store such as the Microsoft® SQL Server®, the Oracle® servers, the MySQL® database of MySQL AB Limited Company, the mongoDB® of MongoDB, Inc., the Neo4j graph database of Neo Technology Corporation, the Cassandra database of the Apache Software Foundation, the HBase® database of the Apache Software Foundation, etc. In an embodiment, the databases can also be locations on a file system. In another embodiment, the databases can be remotely accessed by the computing systems 801, 805, 814, and 817 via the communication network. In another embodiment, the databases are configured as cloud-based databases implemented in a cloud computing environment, where computing resources are delivered as a service over the communication network.

In an embodiment, the storage units containing product inventory are received at the receiving facility 14 on the transport vehicle 813 from the supply facility 12 and automatically inducted into the ASRS 816, for example, the multi-zone ASRS 100 illustrated in FIGS. 1-3 and FIG. 9 or a single-zone ASRS, at the receiving facility 14. The multi-zone ASRS 100 or the single-zone ASRS is of a type compatible with a predetermined type of each of the storage units. In this embodiment, the storage units containing the product inventory are exchanged for outgoing storage units, for example, empty storage units, from the receiving facility 14, thereby loading the outgoing storage units onto the transport vehicle 813 for transit from the receiving facility 14 to the supply facility 12. Both the storage units containing the product inventory and the outgoing storage units are of the same predetermined type compatible with the ASRS 816 of the receiving facility 14. The embodiments herein implement a 1:1 exchange technique of forward and reverse storage units during auto-induction at the receiving facility 14, for example, a micro-fulfillment center, during a replenishment process. The embodiments herein improve shipping and receiving processes and eliminate associated staging areas in micro-fulfillment and distribution center sites to substantially reduce labor, real estate and resource requirements while streamlining logistics, thereby making operations predictable, orderly, and easier to monitor in real time.

FIG. 9 illustrates an architectural block diagram of a system for managing orders and controlling operation of robotic storage/retrieval vehicles (RSRVs) 128 in an automated storage and retrieval system (ASRS), for example, the multi-zone ASRS 100, using a computerized control system (CCS) 817, according to an embodiment herein. The components of the system comprise the CCS 817, the multi-zone ASRS 100, the fleet of RSRVs 128, and the workstations 114, 115, and 139. The CCS 817 is in operable communication with the fleet of RSRVs 128 and the human-machine interfaces (HMIs) 141 and light guidance systems 142 of the workstations 114, 115, and 139. The HMIs 141 of the workstations 114, 115, and 139 comprise display screens for displaying instructions to human workers for performing picking and placement operations at a receiving facility 14. The light guidance systems 142 comprise, for example, a put-to-light guidance system and a pick-to-light guidance system.

In an embodiment, the CCS 817 is a computer system that is programmable using high-level computer programming languages. The CCS 817 is implemented using programmed and purposeful hardware. In the system disclosed herein, the CCS 817 interfaces with the ASRS, for example, the multi-zone ASRS 100, the RSRVs 128, and the workstations 114, 115, and 139, and in an embodiment, with the central computing system 801, the facility management system 805 at a supply facility 12, and the vehicle management system 814 of the transport vehicle 813 illustrated in FIG. 8, and therefore more than one specifically programmed computing system is used for executing workflows in the receiving facility 14. As illustrated in FIG. 9, the CCS 817 further comprises a data bus 818, a display unit 821, a network interface 822, at least one processor 820 coupled to the network interface 822, and common modules 823. The data bus 818 permits communications between the modules, for example, 820, 821, 822, 823, and 824 of the CCS 817. The display unit 821, via a graphical user interface (GUI) 821a, displays information, display interfaces, user interface elements such as checkboxes, input text fields, etc., for example, for allowing a user such as a system administrator to trigger an update to digital records for customer orders, enter inventory information, update database tables, etc., for executing workflows in the system. The CCS 817 renders the GUI 821a on the display unit 821 for receiving inputs from the system administrator. The GUI 821a comprises, for example, an online web interface, a web-based downloadable application interface, a mobile-based downloadable application interface, etc. The display unit 821 displays the GUI 821a. The network interface 822 is coupled to a communication network and enables connection of the CCS 817 to the communication network. The common modules 823 of the CCS 817 comprise, for example, input/output (I/O) controllers, input devices, output devices, fixed media drives such as hard drives, removable media drives for receiving removable media, etc. Computer applications and programs are used for operating the CCS 817. The programs are loaded onto fixed media drives and into the memory unit 824 via the removable media drives. In an embodiment, the computer applications and programs are loaded into the memory unit 824 directly via the communication network.

The CCS 817 further comprises a non-transitory, computer-readable storage medium, for example, a memory unit 824, communicatively coupled to the processor(s) 820. The memory unit 824 is used for storing program instructions, applications, and data. The memory unit 824 stores computer program instructions defined by modules, for example, 824a-824d of the CCS 817. The memory unit 824 is operably and communicatively coupled to the processor 820 for executing the computer program instructions defined by the modules, for example, 824a-824d of the CCS 817 for executing workflows in the receiving facility 14. The processor 820 executes the modules, for example, 824a-824d of the CCS 817. The memory unit 824 is, for example, a random-access memory (RAM) or another type of dynamic storage device that stores information and instructions for execution by the processor 820. The memory unit 824 also stores temporary variables and other intermediate information used during execution of the instructions by the processor 820. In an embodiment, the CCS 817 further comprises read only memories (ROMs) or other types of static storage devices that store static information and instructions for execution by the processor 820. In an embodiment, the modules, for example, 824a-824d and 825 of the CCS 817 are stored in the memory unit 824.

The memory unit 824 is configured to store computer program instructions, which when executed by the processor(s) 820, cause the processor(s) 820 to control operation of the RSRVs 128 in the multi-zone ASRS 100 as follows. Through the execution of the computer program instructions by the processor 820, the CCS 817 performs the following method in the multi-zone ASRS 100 comprising a first storage zone 101, a second storage zone 102, and in an embodiment, a third storage zone 103 as illustrated in FIGS. 1-3. For purposes of illustration, in an example, the first storage zone 101 is an ambient storage zone having an ambient operating temperature, the second storage zone 102 is a chilled storage zone having a chilled operating temperature, and the third storage zone 103 is a freezer storage zone having a freezing operating temperature. As part of a retrieval task associated with the second storage zone 102 requiring retrieval of a targeted storage unit stored in the second storage zone 102, the CCS 817 assigns the retrieval task associated with the second storage zone 102 to a first RSRV selected from among the RSRVs 128 located in the first storage zone 101; and issues commands to the first RSRV to: (a) travel into the second storage zone 102 via one of the portals opening thereinto from the first storage zone 101; and (b) during the travel, prior to entering the second storage zone 102 through that portal, drop off one of the storage units currently carried on the first RSRV at one of the buffer spots in the first storage zone 101.

In additional steps of the retrieval task associated with the second storage zone 102, the CCS 817 further issues commands to the first RSRV to: upon entry into the second storage zone 102, pick up a buffered storage unit from one of the buffer spots in the second storage zone 102; travel from that buffer spot in the second storage zone 102 toward an access location in the second storage zone 102 from which the targeted storage unit stored in the second storage zone 102 is retrievable; and prior to retrieving the targeted storage unit at the access location, deposit the picked up storage unit into an available one of the storage locations in the second storage zone 102. In an embodiment, the CCS 817 selects the available storage location in the second storage zone 102 from among any of the storage locations available upstream and positioned en route from the buffer spot in the second storage zone 102 to the access location, and/or any of the storage locations available downstream and positioned en route from the access location to an exit portal.

The CCS 817 completes the retrieval task associated with the second storage zone 102 by issuing commands to the first RSRV to retrieve the targeted storage unit stored in the second storage zone 102 and perform delivery of the targeted storage unit to a workstation, for example, 114, 115, or 139, to facilitate picking of product from the targeted storage unit at the workstation. Subsequent to the completion of the retrieval task associated with the second storage zone 102 and picking of the product from the targeted storage unit carried by the first RSRV, the CCS 817 issues commands to the first RSRV or a different RSRV to deposit the targeted storage unit onto one of the buffer spots in the second storage zone 102 and then exit the second storage zone 102. As part of a subsequent retrieval task associated with the second storage zone 102 and assigned to a second RSRV selected from among the first RSRV and a different RSRV, to retrieve another targeted storage unit stored in the second storage zone 102, the CCS 817 issues commands to the second RSRV to: (a) enter the second storage zone 102; (b) pick up the deposited storage unit from the buffer spot in the second storage zone 102; (c) travel from the buffer spot in the second storage zone 102 toward an access location in the second storage zone 102 from which the other targeted storage unit is retrievable; and (d) prior to retrieving the other targeted storage unit at the access location, deposit the picked up storage unit from the buffer spot in the second storage zone 102 into an available one of the storage locations in the second storage zone 102. In an embodiment, the CCS 817 selects the available storage location in the second storage zone 102 from among any of the storage locations available upstream and positioned en route from the buffer spot in the second storage zone 102 to the access location, and/or any of the storage locations available downstream and positioned en route from the access location to an exit portal.

In an embodiment, the CCS 817 assigns a task of depositing an unneeded one of the storage units stored in the second storage zone 102 into one of the storage locations in the second group, to one of the RSRVs 128 that is assigned to retrieve a needed one of the storage units stored in the second storage zone 102 from the second group of the storage locations. In an embodiment, the second storage zone 102 is characterized by a harsher operating environment for the RSRVs 128 than the first storage zone 101. In this embodiment, during the selection of one of the RSRVs 128 to assign to any retrieval task associated with the second storage zone 102, the CCS 817 prioritizes the RSRVs 128 of a longer absence from the second storage zone 102 over the RSRVs 128 of a more recent presence in the second storage zone 102. In an embodiment, the CCS 817 records an exit time at which any of the RSRVs 128 last exited the second storage zone 102. In this embodiment, during the selection of the RSRVs 128 for any retrieval task associated with the second storage zone 102, the CCS 817 compares exit times of the RSRVs 128 for prioritizing the RSRVs 128 of the longer absence from the second storage zone 102 over the RSRVs 128 of the more recent presence in the second storage zone 102. The embodiments herein reduce exposure of the RSRVs 128 to non-ambient, cooled, chilled or freezer environments while the RSRVs 128 operate in the multi-zone ASRS 100, thereby protecting their circuitry and componentry and maintaining their throughput performance.

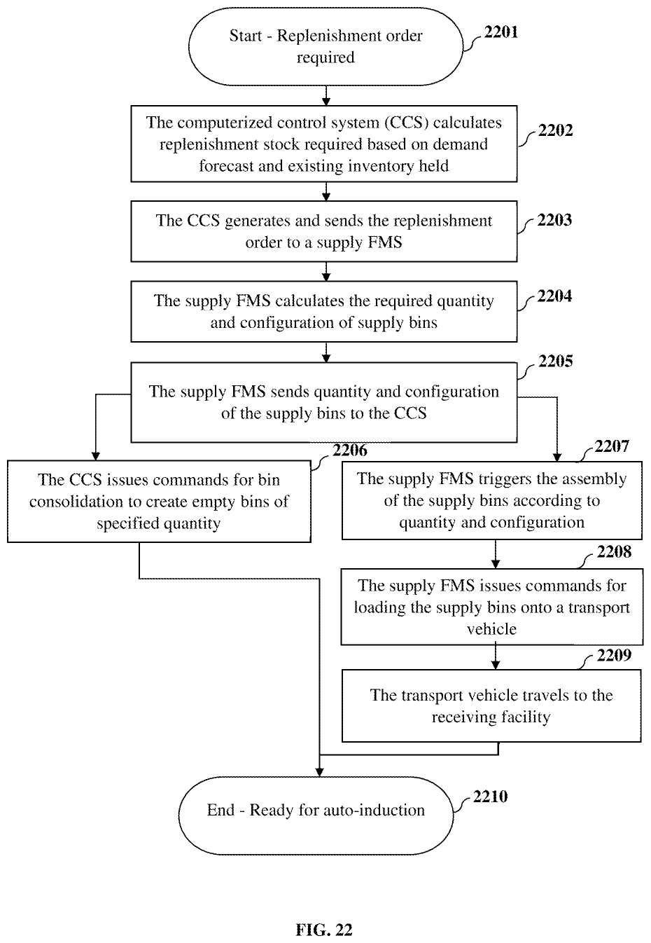

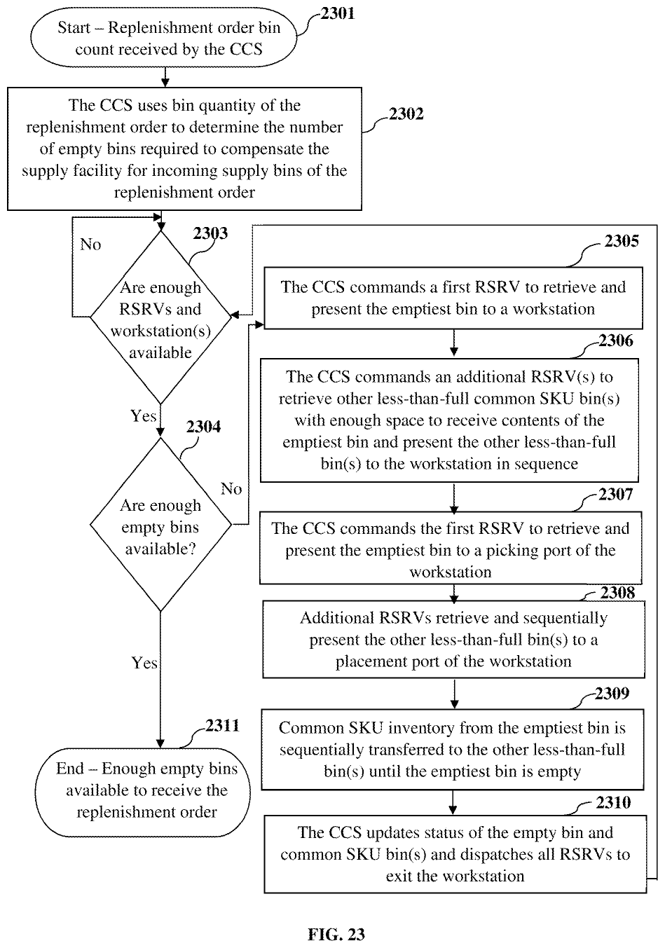

In an exemplary implementation of the system illustrated in FIG. 9, the CCS 817 comprises an order management module 824a, a task assignment module 824b, a robot management module 824c, a bin consolidation and exchange module 824d, and a facility database 825. The order management module 824a defines computer program instructions for receiving and managing orders to be fulfilled at the receiving facility 14. The order management module 824a is configured to update digital records for the orders in the facility database 825. In an embodiment, the order management module 824a also calculates replenishment stock required based on a demand forecast and existing inventory held in the multi-zone ASRS 100 as disclosed in the detailed description of FIG. 22. The order management module 824a also transmits a replenishment order to the computerized facility management system 805 of the supply facility 12 illustrated in FIG. 8. The task assignment module 824b defines computer program instructions for assigning tasks to the RSRVs 128 for performing storage, retrieval, storage zone transition, delivery, and return operations with respect to the multi-zone ASRS 100 and the workstations 114, 115, and 139 as disclosed in the detailed description of FIGS. 11-25. The robot management module 824c, in communication with the task assignment module 824b, activates one or more of the RSRVs 128 for performing various storage, retrieval, storage zone transition, delivery, and return operations with respect to the multi-zone ASRS 100 and the workstations 114, 115, and 139 as disclosed in the detailed descriptions of FIGS. 11-25. The bin consolidation and exchange module 824d defines computer program instructions for executing bin consolidation and exchange operations as disclosed in the detailed descriptions of FIGS. 23-25.

The processor 820 of the CCS 817 retrieves instructions defined by the order management module 824a, the task assignment module 824b, the robot management module 824c, and the bin consolidation and exchange module 824d for performing respective functions disclosed above. The processor 820 retrieves instructions for executing the modules, for example, 824a-824d, from the memory unit 824. The instructions fetched by the processor 820 from the memory unit 824 after being processed are decoded. After processing and decoding, the processor 820 executes their respective instructions, thereby performing one or more processes defined by those instructions. An operating system of the CCS 817 performs multiple routines for performing a number of tasks required to assign the input devices, the output devices, and the memory unit 824 for execution of the modules, for example, 824a-824d and 825. The tasks performed by the operating system comprise, for example, assigning memory to the modules, for example, 824a-824d, 825, etc., and to data used by the CCS 817, moving data between the memory unit 824 and disk units, and handling input/output operations. The operating system performs the tasks on request by the operations and after performing the tasks, the operating system transfers the execution control back to the processor 820. The processor 820 continues the execution to obtain one or more outputs.

For purposes of illustration, the detailed description refers to the modules, for example, 824a-824d and 825, being run locally on a single computer system, that is, the CCS 817; however the scope of the embodiments herein is not limited to the modules, for example, 824a-824d and 825, being run locally on a single computer system via the operating system and the processor 820, but may be extended to run remotely over the communication network by employing a web browser and a remote server, a mobile phone, or other electronic devices. In an embodiment, one or more computing portions of the system disclosed herein are distributed across one or more computer systems (not shown) coupled to the communication network.

The non-transitory, computer-readable storage medium disclosed herein stores computer program instructions executable by the processor 820 for executing different workflows at the receiving facility 14. The computer program instructions implement the processes of various embodiments disclosed above and perform additional steps that may be required and contemplated for executing the workflows at the receiving facility 14. When the computer program instructions are executed by the processor 820, the computer program instructions cause the processor 820 to perform the steps of the method for executing the workflows at the receiving facility 14 as disclosed above. In an embodiment, a single piece of computer program code comprising computer program instructions performs one or more steps of the methods disclosed above and the methods disclosed in the detailed descriptions of FIGS. 11-25. The processor 820 retrieves these computer program instructions and executes them.

A module, or an engine, or a unit, as used herein, refers to any combination of hardware, software, and/or firmware. As an example, a module, or an engine, or a unit may include hardware, such as a microcontroller, associated with a non-transitory, computer-readable storage medium to store computer program codes adapted to be executed by the microcontroller. Therefore, references to a module, or an engine, or a unit, in an embodiment, refer to the hardware that is specifically configured to recognize and/or execute the computer program codes to be held on a non-transitory, computer-readable storage medium. The computer program codes comprising computer readable and executable instructions can be implemented in any programming language, for example, C, C++, C#, Java®, JavaScript®, Fortran, Ruby, Perl®, Python®, Visual Basic®, hypertext preprocessor (PHP), Microsoft® .NET, Objective-C®, etc. Other object-oriented, functional, scripting, and/or logical programming languages can also be used. In an embodiment, the computer program codes or software programs are stored on or in one or more mediums as object code. In another embodiment, the term “module” or “engine” or “unit” refers to the combination of the microcontroller and the non-transitory, computer-readable storage medium. Often module or engine or unit boundaries that are illustrated as separate commonly vary and potentially overlap. For example, a module or an engine or a unit may share hardware, software, firmware, or a combination thereof, while potentially retaining some independent hardware, software, or firmware. In various embodiments, a module or an engine or a unit includes any suitable logic.

FIGS. 10A-10B illustrate a database schema of the central database 803 of the central computing system 801 shown in FIG. 8, according to an embodiment herein. In an embodiment of an organizational scheme of the central database 803, the central database 803 comprises a vendor table 1001, a vendor's product table 1003, a vendor's stocked inventory table 1004, a facilities table 1006, a transport vehicle table 1007, a storage bins table 1008, a storage bin contents table 1009, a storage locations table 1010, a picked-order (PO) bins table 1011, a picker-order (PO) bin contents table 1012, a finished-order (FO) bins table 1013, a customer table 1014, a customer orders table 1015, an order line items table 1016, a supply shipment table 1017, and a shipment details table 1018 as disclosed in Applicant's PCT international patent application number PCT/IB2020/051721, the entirety of which is disclosed herein by reference. The vendor table 1001 contains vendor identifiers (Vendor_IDs) and other details of subscribing vendors 1002, for example, their official corporate names, addresses, and billing information. For each vendor identified in the vendor table 1001, a respective vendor's product table 1003 and vendor's stocked inventory table 1004 co-operably define a vendor's product catalogue 1005 for that particular vendor in the central database 803.

In an embodiment, each product record in the vendor's product table 1003 comprises one or more product attributes of the product concerned, for example, size, color, etc.; vendor-specific product handling data that defines particular actions or conditions that must be fulfilled for that product type while the product moves within the supply chain ecosystem; vendor-specific customization data that defines performance of one or more modifications to the product by the operating entity based on value-added services (VAS), for example, re-packaging, labeling, price tagging, security tagging, etc., offered thereby; environmental data concerning controlled-environment requirements, or a lack thereof, for the particular product, for example, as may be necessitated by the nature of the product itself to prevent damage, leakage, or spoilage thereof or avoid, prevent, and/or minimize hazards presented thereby, etc. Examples of the environmental data comprise an indication of a freezer-storage requirement for frozen food items, an indication of a chilled-storage requirement for chilled but non-frozen food items, an indication of ambient-storage acceptability for general items requiring no particular controlled-environment conditions, etc. In an embodiment, the central computing system 801 uses the environmental data to determine and control placement of a product in various environmentally distinct or environmentally controlled storage zones or areas in the receiving facility and the transport vehicles, for example, 813, of the supply chain ecosystem.

In FIG. 10A, the unique identifiers, for example, the Facility_ID/Vehicle_ID, Location_ID, and Bin_ID are included in the vendor's stocked inventory table 1004 to illustrate the various data than can be pulled from the central database 803 in response to a query for a particular Product_ID. In an embodiment, the data is pulled through a relation to the other tables without having to redundantly include such data in the vendor's stocked inventory table 1004. Likewise, it will be appreciated that the illustration of redundant data among the other tables disclosed herein is for a similar explanatory purpose, and that a more normalized database structure may be implemented in practice to reduce such data redundancies.

As illustrated in FIG. 10A, the facilities table 1006 of the central database 803 comprises records, each containing a static field with the Facility_ID of a respective facility, and additional relevant information concerning that facility, such as a street address and/or global positioning system (GPS) coordinates thereof, and in an embodiment, environmental data for identifying whether the facility has environmentally controlled storage capabilities, for example, chilled storage zones and/or freezer storage zones, or only ambient storage zones. In an embodiment, if all facilities in the supply chain are equipped with an equal variety of environmentally distinct storage zones, then this environmental data is omitted from the facilities table 1006. The transport vehicle table 1007 of the central database 803 comprises records, each containing at least a static field with the Vehicle_ID of a respective transport vehicle of the supply chain ecosystem and a variable destination field for the Facility_ID of a facility to which the transport vehicle is subsequently destined to travel. In an embodiment, the transport vehicle table 1007 further comprises a field for environmental data related to the environmentally controlled storage capabilities of the transport vehicle. In an embodiment, if all the transport vehicles throughout the supply chain ecosystem are equipped with an equal variety of environmentally distinct storage zones, then this environmental data is omitted from the transport vehicle table 1007. In an embodiment, the transport vehicle table 1007 comprises the type of the transport vehicle, the current or last recorded GPS coordinates of the transport vehicle, and/or an estimated time of arrival (ETA) at the destination facility.

The storage bins table 1008 of the central database 803 stores the Bin_IDs of all the storage units, also referred to as “storage bins”, of the system 800 illustrated in FIG. 8, each in a respective record that also contains the Facility_ID of the facility at which the respective storage unit currently resides or the Vehicle_ID of the transport vehicle on which the respective storage unit currently resides; and the Location_ID of a particular storage location at which the storage unit resides in the indexed storage array of the facility or the transport vehicle, if the storage unit is currently stowed in one of the indexed storage arrays, or of a dynamic storage location on a robotic handler or a conveyor on which the storage unit is placed and is being moved within or out of the facility. In an embodiment where the storage units are configured as multi-compartment storage (MCS) bins, each storage unit record also comprises compartment fields for storing a respective compartment identifier (Compartment_ID) of each of the MCS bin's compartments. In embodiments where only single compartment storage (SCS) bins are used, the storage unit record does not contain compartment fields. In an embodiment, the storage bins table 1008 stores an environmental flag indicating the environmental condition or requirements of the contents of the storage unit. In an embodiment, the storage bin contents table 1009 of the central database 803 contains and allows tracking of the contents of each compartment of each storage bin.

The global storage locations table 1010 of the central database 803 lists all the indexed storage locations of the indexed storage arrays of all the facilities and the transport vehicles. Each record in this global storage locations table 1010, therefore, comprises the Location_ID of a respective storage location in the system 800, the Facility_ID of the facility at which the storage location resides, or the Vehicle_ID of the transport vehicle on which the storage location resides, an environmental status indicator reflecting the environmental control category to which that storage location belongs, and the Bin_ID of a storage or order bin currently stored at that storage location, if any. The environmental status indicator denotes residence of the storage location in an ambient storage zone, a chilled storage zone, or a freezer storage zone of a given facility or transport vehicle.

The indexed storage arrays of all facilities and all transport vehicles are, therefore, fully indexed for global mapping of stored bin locations throughout the system 800, as each individual indexed storage location throughout the system 800 has a footprint specifically sized and shaped to accommodate placement and storage of a respective singular storage unit therein, and has a respective location identifier or address (Location_ID) in the records of the central database 803 by which the exact whereabouts of any storage bin stowed in any indexed storage array is identifiable at any time, even during transit between the facilities due to the inclusion of such indexed storage arrays in the transport vehicles. Through the combination of the vendor's stocked inventory table 1004, the facilities table 1006, the transport vehicle table 1007, the storage bins table 1008, the storage bin contents table 1009, and the global storage locations table 1010, the locations of all inventory placed into the storage units and inducted into any of the indexed storage arrays compatible with the storage units are thus recorded and tracked. In an embodiment where the system 800 employs only ambient storage with no environmentally controlled storage environments comprising, for example, chilled storage zones and/or freezer storage zones, then the environmental data is omitted from the vendor's product table 1003 and the facilities table 1006, along with the environmental status being omitted from the global storage locations table 1010.

In addition to the storage units for holding vendor inventory, the system 800 also employs picked-order (PO) storage units, also referred to as “PO bins” of the same standardized size and configuration as the storage units, so that picked orders placed in these PO bins are likewise storable in the indexed storage locations found in the facilities, and on the transport vehicles travelling therebetween, on a 1:1 bin-to-location basis. Accordingly, the PO bins table 1011 of the central database 803 is of a structure similar to the storage bins table 1008. In this embodiment, the separate PO bin contents table 1012 of the central database 803 tracks the contents of each compartment of each PO bin.

The order numbers recorded in the PO bin contents table 1012 are retrieved and assigned from a separate customer orders table 1015, each record of which contains the order number of a respective customer order, a unique identifier (Customer_ID) of a customer for whom that customer order is to be fulfilled, a unique identifier (Vendor_ID) of the vendor who fulfills the customer order, and any shipping preferences applied to that customer order during creation thereof. In a related order line items table 1016, each record contains a line item number, the order number of the customer order to which that line item belongs, the Product_ID(s) of a product type required to fulfill that line item of the customer order, and a quantity of that product type to be fulfilled for that line item. The Customer_ID of each customer is also stored in a separate customer table 1014 along with all other customer account information, including the name, address, and billing information of each customer.

In addition to the multi-compartment PO bins in which picked orders are placed, in an embodiment, the system 800 also employs single-compartment finished-order (FO) storage units, also referred to as “FO bins”, in which individual customer orders are packed once packaged into a finished state ready for pickup by, or delivery to, the customer. In an embodiment, the FO bins are of a different smaller standardized size than the storage and PO bins, and are, for example, about half the size of those other bins. The smaller FO bins are not compatible with the indexed storage arrays of the mega facilities, the macro facilities, and the micro facilities or the transport vehicles travelling therebetween, and are instead sized and configured for a different type of indexed storage array used at the nano facilities. Each record of the FO bins table 1013 of the central database 803 comprises a static field containing the Bin_ID of a respective one of the FO bins, the order number of a particular customer order of which one or more ordered products reside in the FO bin; the Facility_ID of the facility at which the respective FO bin currently resides or the Vehicle_ID of the transport vehicle on which the respective FO bin currently resides; and the Location_ID of a particular storage location at which the FO bin resides in the indexed storage array of the facility or the transport vehicle, if the FO bin is currently stowed in one of the indexed storage arrays, or of a dynamic storage location on a robotic handler or a conveyor on which the storage bin is placed and is being moved within or out of the facility.

The supply shipment table 1017 of the central database 803 is populated with expected inventory supply shipments scheduled to deliver new inventory to the system 800, typically at the mega facilities thereof. The contents of the supply shipments are itemized in a separate shipment details table 1018, each record of which comprises a unique identifier (Case_ID) for each case of product in the expected supply shipment, the Shipment_ID of the shipment to which the case belongs, the Product_ID(s) of a product type contained in the case, and a quantity of the product type found in the case.

FIG. 10C illustrates a database schema of the local facility database 825 of the computerized control system (CCS) 817, according to an embodiment herein. In an embodiment of an organizational scheme of the local facility database 825, the local facility database 825 comprises a facility storage table 825b, in which only the respective storage locations of that particular facility's storage array are indexed, as opposed to the global storage locations table 1010 of the central database 803 illustrated in FIG. 10B, which instead provides a global index of all the storage locations throughout the entire system. Similar to the global storage locations table 1010, each record of the facility storage table 825b comprises a static field for the Location_ID of a respective storage location, an environmental status indicator reflecting the environmental control category, for example, ambient storage zone, chilled storage zone, or freezer storage zone, to which that storage location belongs, and the Bin_ID of a storage bin currently stored at that location, if any.

The local facility database 825 further comprises an automation equipment information table 825c comprising a static field for a unique identifier (Equipment_ID) of each piece of automation equipment, for example, a robotic storage/retrieval vehicle (RSRV) or a conveyor operable at a particular facility. The RSRV is indexed and defines a dynamic storage location for placing and locating a storage unit while moving the storage unit within or out of the facility. In an embodiment, the conveyor also defines a storage location onto which the storage unit is being transferred within the facility or from the facility to the transport vehicle and vice versa. The Equipment_ID is used as the Location_ID of the storage unit when the storage unit is being navigated by an RSRV or a conveyor within or out of the facility, to allow continuous tracking of the storage unit. The automation equipment information table 825c further comprises a variable field for the Bin_ID of a storage unit that is currently held on and moved by a particular RSRV or conveyor within and out of the facility. The automation equipment information table 825c also stores other information such as equipment type, for example, an RSRV or a conveyor, real-time location of the automation equipment, etc. In another embodiment, manual operations equipment, for example, a forklift, is also mapped to an Equipment_ID and defines a dynamic storage location. In this embodiment, the Equipment_ID of the manual operations equipment is used as the Location_ID of the storage unit when the storage unit is being manually operated on by the manual operations equipment within the facility to allow continuous tracking of the storage unit.

The local facility database 825 further comprises one or more on-site bins tables 825e that list the Bin_IDs of all storage units and/or order bins currently on location at that particular facility. In an embodiment, the on-site bins table 825e of the local facility database 825 comprises fields for storing an empty/occupied status of each storage unit, an environmental flag, a Location_ID of a respective storage location, a destination Facility_ID, and timing data. For facilities having multiple bin types, in an embodiment, each bin type has its own respective on-site bins table 825e in the local facility database 825. The local facility database 825 further comprises a workstation information table 825d containing unique identifiers (Workstation_IDs) of different workstations situated at that particular facility; and for each such workstation, a workstation type denoting the type of work operations performed at that workstation, for example, an induction workstation, a value-added service (VAS) workstation, a kitting workstation, a picking workstation, a packing workstation, an order management workstation, etc.; a location of the workstation in the facility, for example, in an addressed format configured to command travel of RSRVs thereto, and/or carrying or conveyance of storage units thereto by conveyors or other automated bin handling equipment; identification of particular work supplies stocked at that workstation, for example, packaging, labelling, and tagging supplies; and in an embodiment, one or more workstation category fields designating any specialized operating characteristics or capabilities provided at that workstation that distinguish the workstation from other workstations of the same type, for example, category fields denoting compatibility or incompatibility with particular classes of product such as food-grade workstations maintained to greater sanitary standards for exposed food handling; allergen-safe workstations at which allergenic products are prohibited, optionally organized by subcategory, for example, peanut-free, tree nut-free, gluten-free, shellfish-free, dairy-free, etc.; and hazardous goods workstations specifically for hazardous goods forbidden at other workstation categories. In an embodiment, the categorization is on a flagged basis, where only specialized workstations are flagged with a special categorization, and the lack of any such flag denotes a general-goods workstation where anything other than controlled-product classes, for example, hazardous goods, exposed food products, etc., are acceptable, regardless of potential allergen content. The local facility database 825 further comprises a facility information table 825a for storing the same or similar content to the respective record in the facilities table 1006 of the central database 803 illustrated in FIG. 10A. In an embodiment, the facility information table 825a optionally stores bin quantity data identifying the quantities of empty and occupied storage units currently residing in that facility.

The local facility database 825 further comprises a robot information table 825f for storing data associated with the RSRVs within the automated storage and retrieval system (ASRS), for example, the multi-zone ASRS 100 illustrated in FIGS. 1-3 and FIGS. 8-9. The processor of the CCS 817 retrieves data from the robot information table 825f for controlling operation of the RSRVs in the multi-zone ASRS 100. The robot information table 825f comprises data, for example, a unique identifier assigned to each RSRV, that is, Robot_ID, a location of the RSRV within the multi-zone ASRS 100 and the facility, the Bin_ID of the storage unit currently held on the RSRV, a time of entry of each RSRV into a particular storage zone of the multi-zone ASRS 100, a time of exit of each RSRV from a particular storage zone of the multi-zone ASRS 100, the type of storage zone where the RSRV traversed, time since the RSRV last exited a storage zone, duration of time spent in the last storage zone, an environmental factor, and a temperature factor. In an embodiment, the CCS 817 utilizes the environmental factor and the temperature factor for weighing the impact of exposure of the RSRV between two temperatures. During the selection of one of the RSRVs to assign to any retrieval task associated with a cooled storage zone, for example, a chilled storage zone or a freezer storage zone, the processor of the CCS 817 accesses the robot information table 825f of the local facility database 825 to prioritize the RSRVs of a longer absence from the cooled storage zone over the RSRVs of a more recent presence in the cooled storage zone. The CCS 817 records an exit time at which any of the RSRVs last exited the cooled storage zone in the robot information table 825f of the local facility database 825. During the selection of the RSRVs for any retrieval task associated with the cooled storage zone, the CCS 817 compares exit times of the RSRVs for prioritizing the RSRVs of the longer absence from the cooled storage zone over the RSRVs of the more recent presence in the cooled storage zone.

The robot information table 825f allows tracking of the location of the RSRVs within the multi-zone ASRS 100, the storage units held by the RSRVs, and information pertaining to the last journey of the RSRVs into environmentally controlled storage zones or temperature-controlled storage zones, also referred to herein as “temperature zones”, of the multi-zone ASRS 100. In the determination of the temperature factor for each RSRV, the time span between the current system time, that is, the CCS clock time and the Last_TempZone_Exit_Time helps determine when each RSRV last accessed an environmentally controlled storage zone. In an embodiment, the CCS 817 normalizes the time span according to a degree of exposure of the RSRV to a non-ambient temperature. For normalization, in an embodiment, the CCS 817 calculates the duration of time that the RSRV spent in an environmentally controlled storage zone by differencing the Last_TempZone_Exit_Time by the Last_TempZone_Entry_Time. When RSRVs have accessed an environmentally controlled storage zone at a similar time in the past, the calculation of the duration of time spent by each of the RSRVs helps weigh or prioritize the RSRVs that have spent less time in the environmentally controlled storage zone and hence are closer to ambient temperature. For example, if two RSRVs exit the same environmentally controlled storage zone at about the same time, by calculating the duration that each RSRV spent in the environmentally controlled storage zone, the CCS 817 optimally predicts which RSRV is closer to ambient temperature.

In another embodiment, if the receiving facility, for example, a micro-fulfillment center (MFC) has multiple environmentally controlled storage zones, the CCS 817 normalizes the temperature factor of the RSRVs based on the environment or temperature of the storage zone. Frozen environments impact the RSRVs to a much greater degree than chilled environments, and therefore, the CCS 817 adjusts the temperature factor of each RSRV to account for the environmental properties of each storage zone. The Last_TempZone_Type field in the robot information table 825f delineates the type of environmentally controlled storage zone, which can be used to lookup the environmental properties of the environmentally controlled storage zone to normalize the temperature factor based on the environment. The CCS 817 then uses the temperature factor to select the optimal RSRV for a task, for example, a pick task. If the pick task is in an environmentally controlled storage zone, for example, a chilled storage zone or a freezer storage zone, the CCS 817 selects an RSRV with a high temperature factor, that is, the RSRV that has spent the most time in the ambient storage zone since the last zone pick and normalizes the temperature factor based on time spent in the last environmentally controlled storage zone and harshness of the environmentally controlled storage zone. If the pick task is in the ambient storage zone, the CCS 817 selects RSRVs with low temperature factors. That is, the CCS 817 assigns an RSRV that has recently visited an environmentally controlled storage zone, for example, a chilled storage zone or a freezer storage zone, to execute a pick task to allow that RSRV to heat back up to ambient temperatures. The CCS 817 updates the Last_TempZone_Entry_Time and Last_TempZone_Exit_Time fields in the robot information table 825f when a storage unit retrieval task is completed. In an embodiment, the CCS 817 does not update the Last_TempZone_Entry_Time and Last_TempZone_Exit_Time fields in the robot information table 825f when the RSRV performs a switch of the storage units at the buffer spots of the multi-zone ASRS 100.

FIG. 10D exemplarily illustrates data stored in the robot information table 825f of the local facility database 825 of the computerized control system (CCS) 817 shown in FIG. 10C, according to an embodiment herein. Consider an example where the CCS 817 records data associated with a set of robotic storage/retrieval vehicles (RSRVs) operating within the multi-zone automated storage and retrieval system (ASRS) 100 illustrated in FIGS. 1-3 and FIG. 9. As illustrated in FIGS. 1-3, the multi-zone ASRS 100 comprises three environmentally controlled storage zones, also referred to herein as “temperature zones”, for example, an ambient storage zone and cooled storage zones, that is, a chilled storage zone having an environmental factor of 1.2 and a freezer storage zone having an environmental factor of 2.3 as illustrated in FIG. 10D. When the RSRVs identified by their respective unique identifiers, for example, A1, A5, D4, B1, F2, F3, C3, A3, and B2, traverse the temperature zones in accordance with commands issued by the CCS 817, the CCS 817 records the corresponding data, for example, Last_TempZone_Entry_Time, Last_TempZone_Exit_Time, and Last_TempZone_Type, associated with each of the RSRVs in the robot information table 825f as illustrated in FIG. 10D. The CCS 817 then computes the time span since each RSRV last exited a temperature zone by differencing the current system time, that is, the CCS clock time by the Last_TempZone_Exit_Time. For example, if the CCS clock time is 2:28:21 pm and the Last_TempZone_Exit_Time recorded for the RSRV identified by A1 is 2:23:25 pm, the CCS 817 computes the time span since A1 last exited the temperature zone as 296 seconds and records the time span in the robot information table 825f as illustrated in FIG. 10D. Moreover, the CCS 817 computes the duration of time spent in the last temperature zone by differencing the Last_TempZone_Exit_Time by the Last_TempZone_Entry_Time. For example, the CCS 817 computes the duration of time spent by A1 in the freezer storage zone as 32 seconds and records the duration in the robot information table 825f as illustrated in FIG. 10D. The CCS 817 then computes the temperature factor of each RSRV, for example, using the formula: time span divided by duration divided by environmental factor of the temperature zone. For example, the CCS 817 computes the temperature factor of A1 as 296/32/2.3 equals 4.02 as illustrated in FIG. 10D. Similarly, the CCS 817 computes the temperature factors of the other RSRVs as illustrated in FIG. 10D.

During the selection of the RSRVs for any retrieval task associated with a temperature zone, the CCS 817 prioritizes the RSRVs of longer absence from the temperature zone over the RSRVs of a more recent presence in the temperature zone. For example, from the data recorded in the robot information table 825f illustrated in FIG. 10D, the CCS 817 selects A1 as the RSRV for any retrieval task associated with a temperature zone having a temperature lower than ambient temperature such as a chilled storage zone or a freezer storage zone. That is, in this example, the CCS 817 selects A1 as the RSRV for any retrieval task associated with temperature zones that are colder than ambient temperature zones. When RSRVs have accessed a temperature zone at a similar time in the past, the calculation of the duration of time spent by each of the RSRVs in a particular temperature zone helps weigh or prioritize the RSRVs that have spent less time in the temperature zone and hence are closer to ambient temperature. For example, from the data recorded in the robot information table 825f illustrated in FIG. 10D, the CCS 817 determines that the RSRVs, F3 and C3, exit the chilled storage zone at about the same time, that is, 2:25:36 pm. By computing the duration that F3 and C3 each spent in the chilled storage zone, the CCS 817 optimally selects F3 as the RSRV as the duration that F3 spent in the chilled storage zone as recorded in the robot information table 825f illustrated in FIG. 10D is less than that of C3 and therefore the temperature of F3 is closer to ambient temperature. In another example, the CCS 817 uses the temperature factor to select the optimal RSRV for a pick task. If the pick task is in a temperature zone, for example, the chilled storage zone or the freezer storage zone, the CCS 817 selects an RSRV having a high temperature factor, that is, the RSRV that has spent the most time in the ambient storage zone since the last zone pick and normalizes the temperature factor based on time spent in the last temperature zone and harshness of the temperature zone. From the data recorded in the robot information table 825f illustrated in FIG. 10D, the CCS 817 selects A1 as the RSRV having a high temperature factor, for example, 4.02. Although A1 last exited the freezer storage zone, which has a harsher operating environment than the chilled storage zone, since the duration that A1 spent in the freezer storage zone is less than the duration that B1 spent in the chilled storage zone and since A1 has spent an additional 127 seconds in the ambient storage zone, the CCS 817 selects A1 over B1 in this example. If the pick task is in the ambient storage zone, from the data recorded in the robot information table 825f illustrated in FIG. 10D, the CCS 817 selects A3 having a low temperature factor, for example, 0.95, as A3 recently visited the freezer storage zone to execute a pick task and therefore needs to heat back up to ambient temperatures.

FIG. 10E illustrates a database schema of a local vehicle database 826 of the vehicle management system 814 shown in FIG. 8, according to an embodiment herein. As illustrated in FIG. 10E, each local vehicle database 826 comprises a vehicle information table 826a for storing the same or similar content to the respective record in the transport vehicle table 1007 of the central database 803 illustrated in FIG. 10A. In an embodiment, the vehicle information table 826a optionally stores bin quantity data identifying the quantities of empty and occupied storage units and/or order bins currently onboard that transport vehicle. The local vehicle database 826 further comprises a vehicle storage table 826b, in which only the respective storage locations of that particular transport vehicle's storage array are indexed. Similar to the facility storage table 825b of each local facility database 825, each record of the vehicle storage table 826b comprises static fields for the Location_ID of a respective storage location in the transport vehicle's indexed storage array, an environmental status indicator reflecting the environmental control category, for example, ambient storage zone, chilled storage zone, or freezer storage zone, to which that storage location belongs, and the Bin_ID of a storage unit currently stored at that storage location, if any. In an embodiment, the local vehicle database 826 further comprises an automation equipment information table 826c similar to the automation equipment information table 825c illustrated in FIG. 10C, for storing information of the automation equipment installed in the transport vehicle. The local vehicle database 826 further comprises one or more onboard bins tables 826d that list the Bin_IDs of all storage units, for example, order bins, supply bins, empty bins, etc., currently onboard that transport vehicle.

FIG. 11 illustrates a flowchart of a computer-implemented method for controlling operation of robotic storage/retrieval vehicles (RSRVs) in the multi-zone automated storage and retrieval system (ASRS), according to an embodiment herein. The multi-zone ASRS optimally coordinates the movement of the RSRVs for improving storage and retrieval of a large number of different product items having different temperature requirements. The method disclosed herein employs the computerized control system (CCS) configured to operably communicate with the RSRVs in the multi-zone ASRS comprising a first storage zone and a second storage zone. In an embodiment, the second storage zone is characterized by a harsher operating environment for the RSRVs than the first storage zone. For example, the second storage zone is a cooled storage zone having a lower environmental operating temperature than the first storage zone. Consider an example where the first storage zone is an ambient storage zone and the second storage zone is a cooled storage zone such as a chilled storage zone or a freezer storage zone. In the method disclosed herein, for a deposit process in the second storage zone involving a deposit of a first storage unit in the second storage zone to a first storage location in the second storage zone, the CCS divides 1101 the deposit process into a first entrance task of carrying the first storage unit into the second storage zone and a second placement task of placing the first storage unit into the first storage location. The CCS then assigns 1102 the first entrance task and the second placement task to a first RSRV and a second RSRV respectively, selected from among the RSRVs positioned outside the second storage zone. The CCS then issues 1103 commands to the first RSRV and the second RSRV to execute the first entrance task and the second placement task. In an embodiment, the first entrance task comprises a drop-off of the first storage unit in the second storage zone by the first RSRV, and a prompt exit of the first RSRV from the second storage zone after the drop-off. The drop-off performed by the first RSRV in the first entrance task comprises placement of the first storage unit at a buffer spot in the second storage zone for later retrieval of the first storage unit from the buffer spot by the second RSRV.

In an embodiment, the CCS assigns a retrieval task associated with the second storage zone to the second RSRV. The retrieval task comprises retrieving a second storage unit from a second storage location in the second storage zone. The second storage location from which to retrieve the second storage unit is selected from among any of the storage locations available upstream and positioned en route from a buffer spot in the second storage zone to the second storage locations in the second storage zone, and/or any of the storage locations available downstream and positioned en route from the second storage location in the second storage zone to an exit portal of the second storage zone.

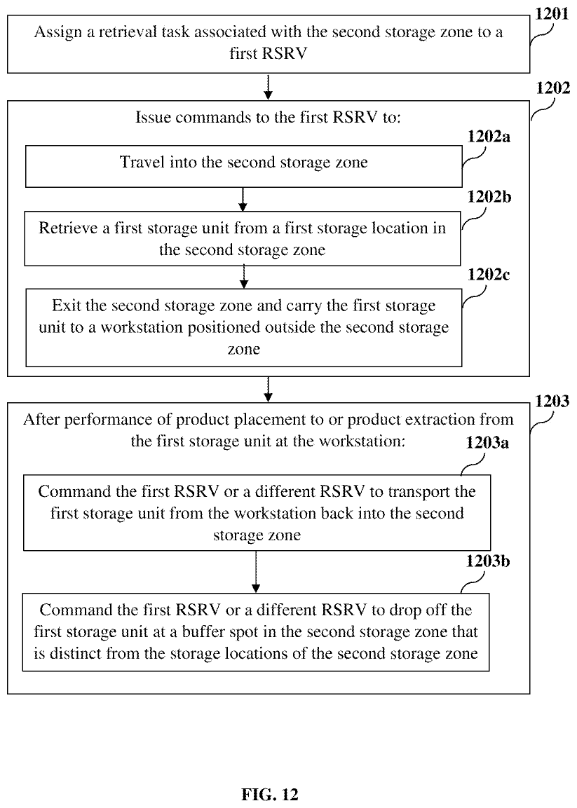

FIG. 12 illustrates a flowchart of a computer-implemented method for controlling operation of robotic storage/retrieval vehicles (RSRVs) in the multi-zone automated storage and retrieval system (ASRS), according to another embodiment herein. The method disclosed herein employs the computerized control system (CCS) configured to operably communicate with the RSRVs in the multi-zone ASRS comprising a first storage zone and a second storage zone. In an embodiment, the second storage zone is characterized by a harsher operating environment for the RSRVs than the first storage zone. For example, the second storage zone is a cooled storage zone having a lower environmental operating temperature than the first storage zone. In an embodiment of the computer-implemented method disclosed herein, the CCS assigns 1201 a retrieval task associated with a second storage zone to a first RSRV selected from among the RSRVs positioned outside the second storage zone. The CCS then issues 1202 commands to the first RSRV to travel 1202a into the second storage zone; retrieve 1202b a first storage unit from a first storage location in the second storage zone; and exit 1202c the second storage zone and carry the first storage unit to a workstation positioned outside the second storage zone. Prior to entering the second storage zone, the CCS issues commands to the first RSRV that is carrying an ambient storage unit to drop off the ambient storage unit at a buffer spot in the ambient, first storage zone. After dropping off the ambient storage unit at the buffer spot in the ambient, first storage zone, the first RSRV enters the second storage zone, retrieves the first storage unit from the first storage location in the second storage zone, exits the second storage zone, and carries the first storage unit to the workstation positioned outside the second storage zone in accordance with the commands issued by the CCS.

After performance of product placement to or product extraction 1203 from the first storage unit at the workstation, the CCS commands 1203a the first RSRV or a different RSRV to transport the first storage unit from the workstation back into the second storage zone, and to drop off 1203b the first storage unit at a buffer spot in the second storage zone that is distinct from the storage locations of the second storage zone. The CCS issues commands to the first RSRV or the different RSRV to promptly exit the second storage zone after dropping off the first storage unit at the buffer spot in the second storage zone. The CCS issues commands to another RSRV to enter the second storage zone from the first storage zone, pick up the first storage unit from the buffer spot in the second storage zone, and deposit the first storage unit into one of the storage locations in the second storage zone. The CCS issues commands to the other RSRV to, after depositing the first storage unit into one of the storage locations in the second storage zone, retrieve a second storage unit from a second storage location in the second storage zone different from that in which the first storage unit was deposited. The CCS selects one of the storage locations in the second storage zone into which to deposit the first storage unit from among any of the storage locations in the second storage zone available upstream and positioned en route from the buffer spot to the second storage location in the second storage zone from which the second storage unit is to be retrieved, and any of the storage locations available downstream and positioned en route to an exit of the second storage zone from the second storage location from which the second storage unit is to be retrieved.

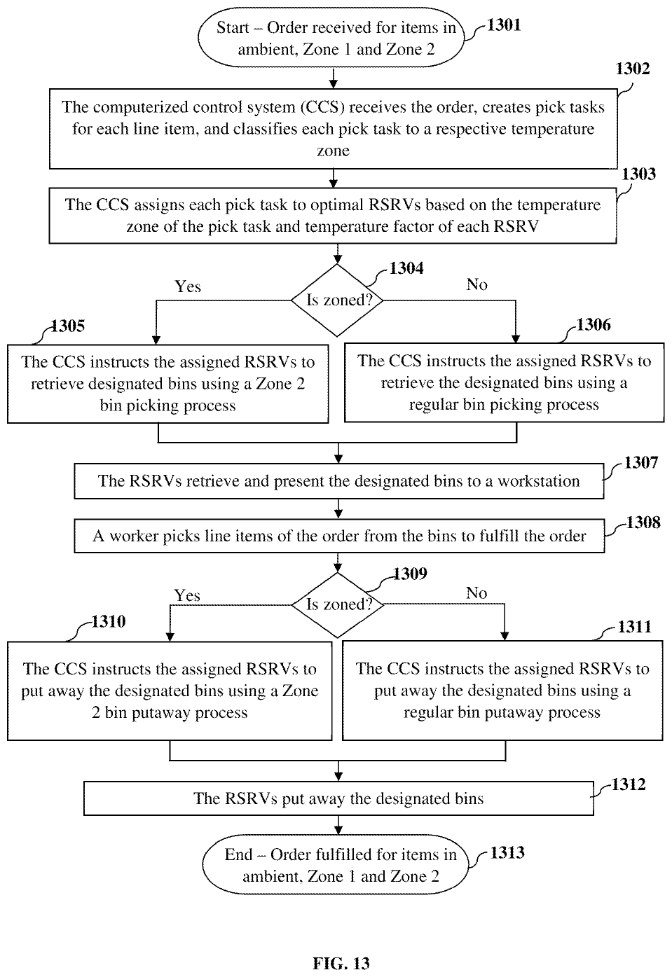

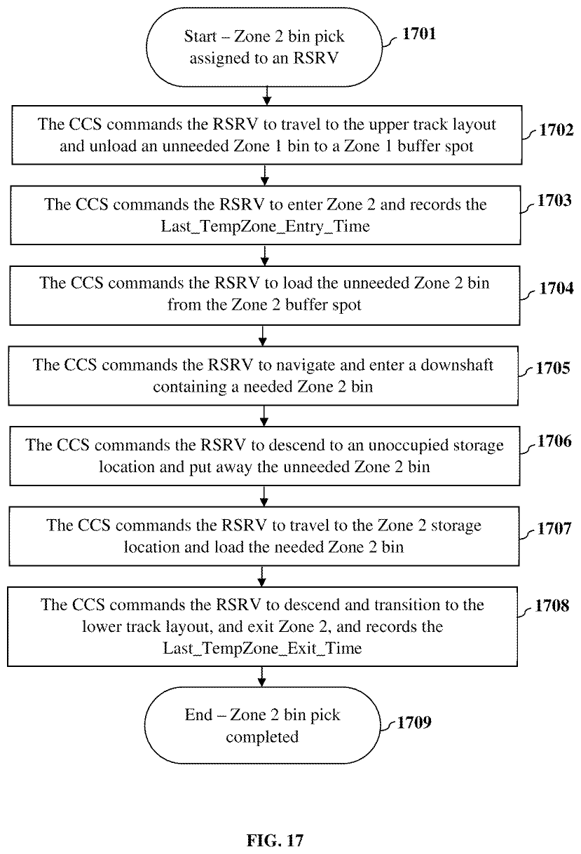

FIG. 13 illustrates a flowchart of a computer-implemented method for executing an order fulfillment workflow, according to an embodiment herein. Consider an example where a facility receives 1301 an order for product items stored in an ambient storage zone, Zone 1, and a cooled storage zone, Zone 2, of the multi-zone automated storage and retrieval system (ASRS). The computerized control system (CCS) of the multi-zone ASRS receives 1302 the order, creates pick tasks for each line item of the order, and classifies each pick task to a respective environmentally controlled storage zone, herein referred to as a “temperature zone”. The CCS assigns 1303 each pick task to optimal robotic storage/retrieval vehicles (RSRVs) based on the temperature zone of the pick task and a temperature factor computed for each RSRV. The CCS determines 1304 whether one or more of the line items of the order are zoned or stored in a cooled storage zone, Zone 2. If one or more of the line items of the order are zoned in Zone 2, the CCS instructs 1305 the assigned RSRVs to retrieve designated storage units, herein referred to as “bins”, using a Zone 2 bin picking process as disclosed in the detailed description of FIG. 17. If one or more of the line items of the order are not zoned in Zone 2, the CCS instructs 1306 the assigned RSRVs to retrieve the designated bins from the ambient storage zone, Zone 1, using a regular bin picking process. In an embodiment, in the regular bin picking process, the assigned RSRVs climb to the upper track layout of the three-dimensional (3D) gridded storage structure of the multi-zone ASRS; travel to downshafts of subsequently needed bins; put away unneeded bins; travel vertically to reach needed bins; and pick the needed bins. In the regular bin picking process, the bins are not exchanged at the buffer spots of the multi-zone ASRS for regular or direct putaway.

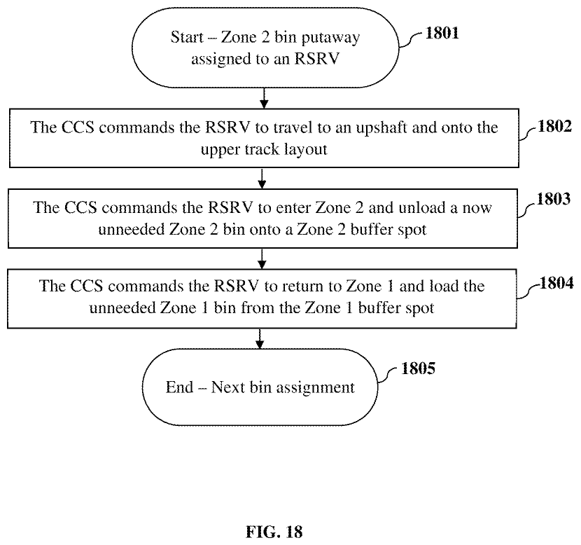

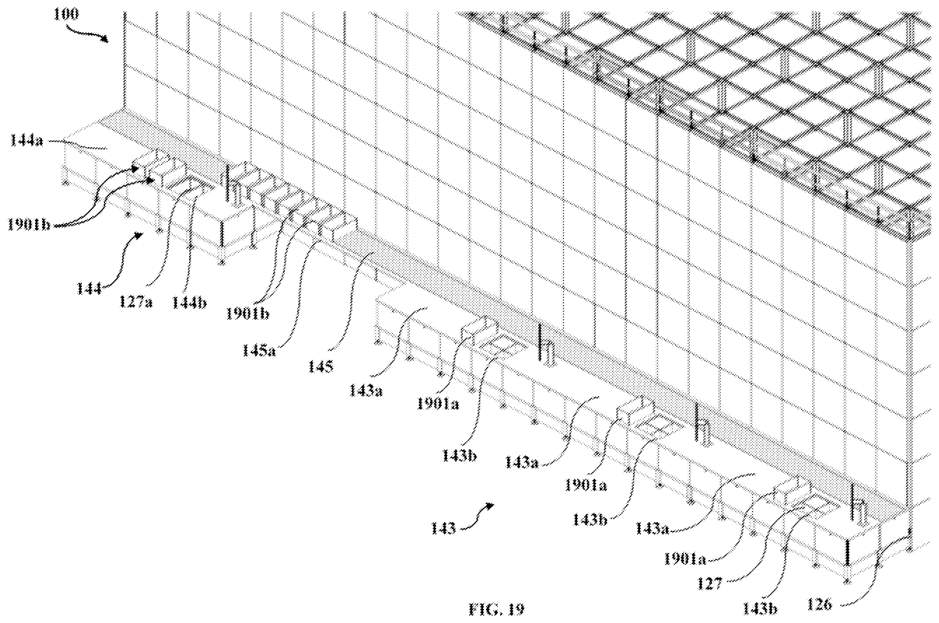

In accordance with the instructions received from the CCS, the RSRVs retrieve and present 1307 the designated bins to a workstation. Moreover, the CCS generates and issues instructions regarding the picking process to a worker at the workstation, for example, via a human-machine interface (HMI) provided at the workstation. In accordance with the instructions received from the CCS, the worker, for example, a human worker or a robotic worker, at the workstation picks 1308 the line items of the order from the bins to fulfill the order. The CCS determines 1309 whether the designation bins, that is, the previously retrieved designated bins or order bins containing the fulfilled order, are to be returned to or zoned in the cooled storage zone, Zone 2. If the designation bins are to be returned to or zoned in Zone 2, the CCS instructs 1310 the assigned RSRVs to put away the designated bins using a Zone 2 bin putaway process as disclosed in the detailed description of FIG. 18. If the designation bins are not to be returned to or zoned in Zone 2, the CCS instructs 1311 the assigned RSRVs to put away the designated bins in Zone 1 using a regular putaway process. In an embodiment, in the regular bin putaway process, the assigned RSRVs travel to the upper track layout of the 3D gridded storage structure of the multi-zone ASRS; travel to the downshafts of the subsequently needed bins; and put away the unneeded bins. In the regular putaway process, the bins are not exchanged at the buffer spots of the multi-zone ASRS for regular or direct put away. In accordance with the instructions received from the CCS, the RSRVs put away 1312 the designated bins. The process ends 1313 with the fulfillment of the order for line items stored in the ambient, Zone 1 and the cooled, Zone 2.

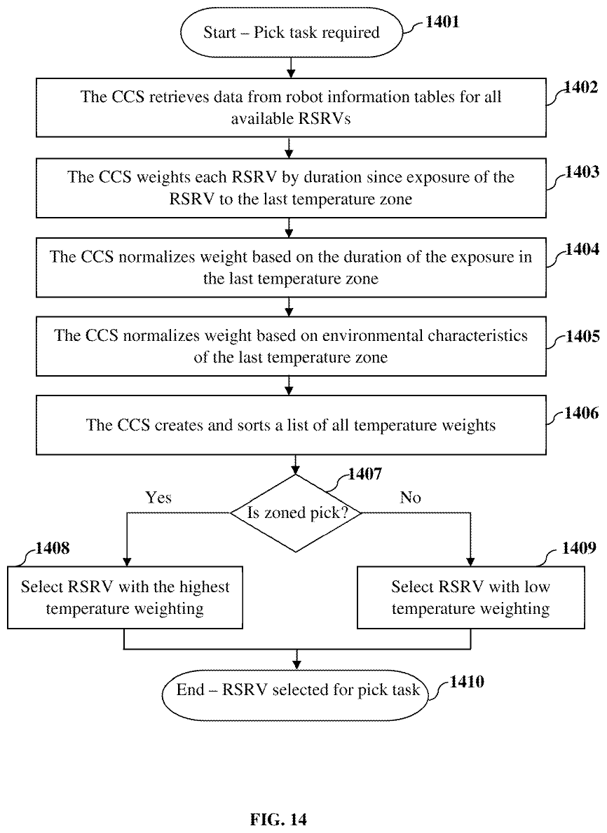

FIG. 14 illustrates a flowchart of a computer-implemented method for selecting a robotic storage/retrieval vehicle (RSRV) for a task to be executed in the multi-zone automated storage and retrieval system (ASRS), according to an embodiment herein. When a pick task 1401 is required, the computerized control system (CCS) of the multi-zone ASRS retrieves 1402 data from the robot information tables of the local facility database illustrated in FIG. 10C for all available RSRVs. The CCS weights 1403 each RSRV by duration since exposure of the RSRV to the last temperature zone. The CCS normalizes 1404 weight based on the duration of the exposure in the last temperature zone. The CCS normalizes 1405 weight based on environmental characteristics of the last temperature zone. The CCS creates and sorts 1406 a list of all temperature weights. The CCS determines 1407 whether the pick task is to be performed in a cooled storage zone. If the pick task is to be performed in a cooled storage zone, the CCS selects 1408 the RSRV with the highest temperature weighting. That is, the CCS selects the RSRV that has spent the most time in the ambient storage zone since the last zone pick. For example, the CCS selects the RSRV that is the warmest to perform a task in the cooled storage zone. If the pick task is to be performed in an ambient storage zone, the CCS selects 1409 the RSRV with a low temperature weighting. That is, the CCS selects the RSRV that has recently visited a cooled storage zone to execute a pick task to allow that RSRV to heat back up to ambient temperatures. The process ends 1410 when the RSRV is selected for the pick task.

FIG. 15 illustrates a top plan view of the multi-zone automated storage and retrieval system (ASRS) 100, showing travel routes of a robotic storage/retrieval vehicle (RSRV) and a storage unit configured by the computerized control system (CCS) for retrieving and returning the storage unit from a storage zone of the multi-zone ASRS 100, according to an embodiment herein. The CCS executes control over navigation of the RSRVs through the three-dimensional (3D) gridded storage structure 100a of the multi-zone ASRS 100 illustrated in FIGS. 1-4, interactive operations performed by the RSRVs on the storage units, tracking of storage units and inventory within the 3D gridded storage structure 100a, and receiving and processing of orders to be fulfilled from the 3D gridded storage structure 100a. In an embodiment, for performing the above disclosed functions, the CCS is integrated into a larger overall computerized inventory management system configured to manage inventory among a network of facilities within a larger supply chain or distribution ecosystem, of which the multi-zone ASRS 100 occupies, for example, a local order fulfillment center or a micro-fulfillment center (MFC) whose inventory is supplied from one or more larger regional distribution centers or macro distribution centers (MDCs). In an embodiment, the CCS, the cooperating RSRVs, and workstation componentry of the multi-zone ASRS 100 are at least partially embodied by the CCS, cooperating RSRVs, and workstation componentry disclosed in Applicant's PCT international application number PCT/CA2019/050815.

In addition to the access shafts 124, around which the storage columns 123 are clustered and are free of the shelving of the storage columns 123 to allow travel of the RSRVs 128 therethrough as illustrated in FIG. 4, the 3D gridded storage structure 100a comprises outer shafts 124a illustrated in FIG. 15 that reside at the outer perimeter of the 3D gridded storage structure 100a. The outer shafts 124a are free of shelving and are unoccupied by storage units to enable vertical travel of the RSRVs 128 therethrough via the racking teeth on the frame members 131 illustrated in FIG. 4, at these outer shafts 124a. The CCS is configured to command downward travel of the RSRVs 128 through the access shafts 124 from the upper track layout 122 of the 3D gridded storage structure 100a illustrated in FIGS. 1-4, when tasked with retrieval of storage units from the 3D gridded storage structure 100a for delivery to the workstations 114 and 115, and to command upward travel of the RSRVs 128 through the outer shafts 124a when tasked with return of the retrieved storage units back into the 3D gridded storage structure 100a from the workstations 114 and 115, or when tasked with induction of a new storage unit into the 3D gridded storage structure 100a for the first time. Navigation of the RSRVs 128, therefore, follows a vortex travel pattern, with the RSRVs 128 travelling upwardly from the lower track layout 126 to the upper track layout 122 in the outer shafts 124a at the outer perimeter of the 3D gridded storage structure 100a illustrated in FIGS. 1-4, and the RSRVs 128 travelling downwardly from the upper track layout 122 to the lower track layout 126 within the inner access shafts 124. In this method, returning and newly inducted storage units being carried up through the outer shafts 124a do not interfere with retrieval of a storage unit via the inner access shafts 124.

In accordance with the vortex travel pattern disclosed above, in an embodiment, the CCS generates and implements the following exemplary navigation scheme for minimizing the time spent by the RSRVs 128 in either the cooled, second storage zone 102 or the cooled, third storage zone 103. The CCS ensures that RSRVs 128 spend minimal time in cooled storage zones, for example, chilled storage zones 102 or freezer storage zones 103. In an embodiment, each RSRV 128 resides on the first track area 122a of the upper track layout 122 by default, thereby residing normally in the ambient, first storage zone 101. The CCS commands the RSRVs 128 to enter the cooled, second storage zone 102 or the cooled, third storage zone 103 when retrieval of a storage unit therefrom is required. FIG. 15 illustrates an exemplary travel route commanded of an RSRV 128 by the CCS to perform retrieval of a storage unit from the cooled, second storage zone 102. In FIG. 15, the solid line travel paths indicate travel of an RSRV 128 on the upper track layout 122 and the broken line travel path indicates travel of an RSRV 128 on the lower track layout 126. The numbered square blocks indicate buffer spots 112a and 112b of the first storage zone 101 and the second storage zone 102 of the multi-zone ASRS 100 respectively.

In the method disclosed herein, storage units are referred to as either “ambient bins”, denoting bins containing products storable in an ambient environment in ambient conditions and therefore designated for storage in the ambient, first storage zone 101, or “cool bins”, denoting bins requiring storage in a cooled environment, for example, in the chilled, second storage zone 102 or the freezer, third storage zone 103. The example illustrated in FIG. 15 relates to retrieval of a cool bin from the second storage zone 102. The similar process is followed for retrieval of a cool bin from the third storage zone 103. In the method disclosed herein, an “unneeded storage unit”, also referred to as an “unneeded bin”, refers to a bin that is currently not stored in a respective storage location of the 3D gridded storage structure 100a, and also not currently required at a workstation 114 or 115 for order fulfillment or another task, and therefore is slated for deposit into a storage location in the 3D gridded storage structure 100a until later required for order fulfillment or other purpose. This unneeded bin is, for example, a returning bin previously retrieved from storage and picked from at a workstation 114 or 115 as part of an order fulfillment task, or a freshly inducted bin containing new product inventory to be stored in the 3D gridded storage structure 100a for the first time. Also, as used herein, a “targeted bin” is a bin currently stored at a respective storage location in the 3D gridded storage structure 100a, and currently required at a workstation 114 or 115 for order fulfillment or other purpose. Various embodiments of the multi-zone ASRS 100 employ the 3D gridded storage structure 100a, associated fleet of RSRVs 128, and compatible storage units 127 or storage bins of equal or similar type to those disclosed in Applicant's international patent application numbers PCT/CA2016/050484, PCT/CA2019/050404, PCT/CA2019/050815, and PCT/CA2019/050816, the entireties of which are incorporated herein by reference.

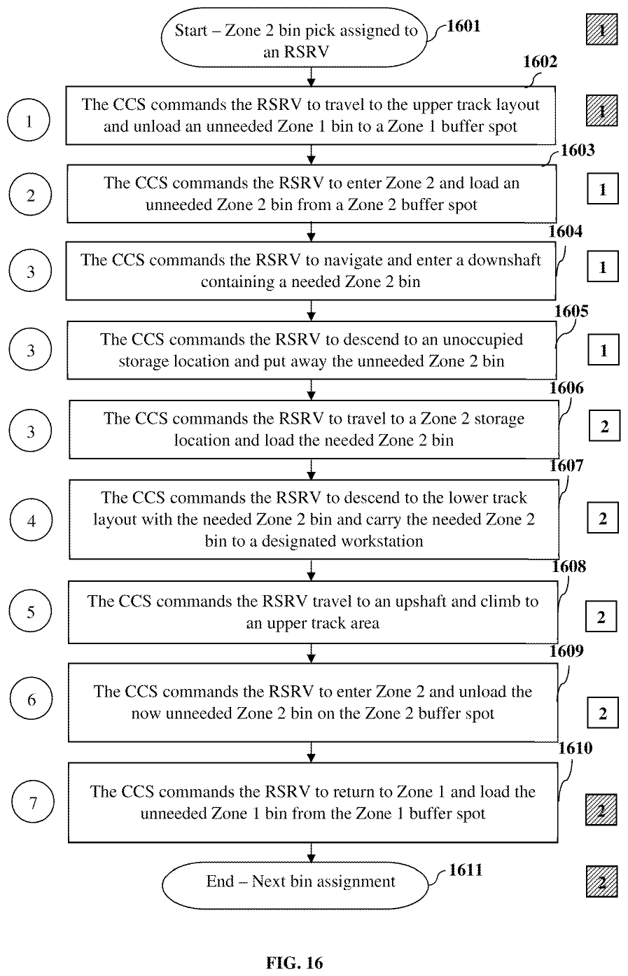

FIG. 16 illustrates a flowchart of a method executed by a robotic storage/retrieval vehicle (RSRV), in response to commands from the computerized control system (CCS), for retrieving and returning a storage unit, herein referred to as a “bin”, from a storage zone of the multi-zone automated storage and retrieval system (ASRS) 100 based on the configured travel routes shown in FIG. 15, according to an embodiment herein. In FIG. 16, the flowchart illustrates a control logic routine cooperatively executed between the RSRV and the CCS for retrieving and returning a bin from a storage zone of the multi-zone ASRS 100. In the flowchart illustrated in FIG. 16, the steps of the method performed are labelled with circled numbers on the left side of the flowchart. These circled numbers are also indicated in the three-dimensional (3D) gridded storage structure map of the multi-zone ASRS 100 illustrated in FIG. 15 to illustrate points in the travel path of the RSRV at which the steps of the method occur. The numbered square blocks on the right side of the flowchart indicate the buffer spots 112a and 112b of the multi-zone ASRS 100 illustrated in FIG. 15, near which the steps of the method occur. In the method disclosed herein, an RSRV resides on the first track area 122a of the upper track layout 122 illustrated in FIG. 15, and in the illustrated example, carries an unneeded, ambient bin slated for deposit in a storage location of the ambient, first storage zone 101 (Zone 1). At step 1601, the CCS selects this RSRV from among available RSRVs currently residing in the ambient, first storage zone 101 and not already tasked with retrieval of a storage bin from any storage zone.

The CCS selects one of the available RSRVs for a cool bin retrieval task based on an assessment of which of the available RSRVs has been in ambient conditions for the longest period of time, that is, which RSRV has been outside the cooled, second storage zone 102 (Zone 2) and third storage zone 103 (Zone 3) the longest. In an embodiment, the CCS tracks presence and absence of each RSRV in the cooled storage zones 102 and 103 by recording an exit time at which the RSRV exits either cooled storage zone 102 or 103, and storing the exit time in records of the robot information table of the local facility database of the CCS illustrated in FIG. 10C. When retrieval of a cool bin is required, the CCS compares the stored exit times of the available RSRVs to determine which RSRV has been absent from the cooled storage zones 102 and 103 the longest, that is, which RSRV has been in the ambient conditions of the first storage zone 101 and the workstations 114 and 115 the longest, and selects this RSRV for the cool bin retrieval task. In other embodiments, alternative or additional means for performing or contributing to prioritized selection of an RSRV for a cool bin retrieval task are employed, for example, using one or more temperatures sensors on each RSRV to select an RSRV based at least partly on current operating temperatures of the RSRVs, prioritizing those of higher operating temperatures over those of lower operating temperatures, the latter of which indicates a more recent presence in one of the cooled storage zones 102 and 103. In an embodiment, the CCS also uses differences in operating temperature in the selection of an RSRV for cool bin retrieval tasks irrespective of exit time or other measures of presence or absence in a cooled storage zone 102 or 103. For example, the CCS prioritizes hotter-running RSRVs whose elevated temperatures may be attributed to other factors such as relative bin weights and travel distances of prior retrieval tasks, and that may benefit from exposure to the cooled storage zones 102 and 103 to prevent overheating.

Moreover, at step 1602, having selected an RSRV to assign to the cool bin retrieval task, the CCS commands that RSRV to travel up to the upper track layout 122 from the lower track layout 126 through one of the outer shafts 124a, unless the RSRV is already on the upper track layout 122. The CCS then commands the RSRV to travel to a spot on the upper track layout 122 that neighbors one of the buffer spots 112a of the first storage zone 101 near the entrance portal 108a of the second storage zone 102 illustrated in FIGS. 1-3, and then to unload the ambient bin currently carried on the RSRV to the buffer spot 112a.

Having unloaded this unneeded ambient bin to this buffer spot 112a of the first storage zone 101 positioned near the second storage zone 102, at step 1603, the CCS commands the RSRV to enter the upper attic space of the cooled, second storage zone 102 via the nearby upper entrance portal 108a, and to travel to a pickup spot adjacent to one of the buffer spots 112b of the second storage zone 102, where an unneeded cool bin resides, having been previously deposited at the buffer spot 112b by another RSRV as will similarly be performed later by the currently assigned RSRV at step 1608. At step 1603, the CCS commands the RSRV to load the unneeded cool bin from the buffer spot 112b of the second storage zone 102 onto the upper support platform of the RSRV.

At step 1604, the CCS commands the RSRV now carrying the unneeded cool bin to travel to the spot in the second track area 122b of the upper track layout 122 that overlies the access shaft 124 by which the storage column 123 containing the targeted cool bin is accessible. The CCS identifies an available or unoccupied storage location in one of the storage columns 123 neighboring this access shaft 124, for example, at a level of the 3D gridded storage structure equal to or above the storage location of the targeted cool bin, and at step 1605, commands the RSRV carrying the unneeded cool bin to descend down the access shaft 124 to the level of the available storage location and to deposit the unneeded cool bin into the available storage location. At step 1606, the CCS commands the now bin-less RSRV to travel through the same access shaft 124, for example, in a descending direction, presuming an available storage location for the unneeded cool bin was available at a higher level in the same access shaft 124, to the storage location at which the targeted cool bin resides, and to retrieve the targeted cool bin from this storage location and load the targeted cool bin onto the upper support platform of the RSRV.

As disclosed above, the selected available storage location into which the unneeded cool bin is deposited resides, for example, at an equal level to or higher level than the storage location where the targeted cool bin resides such that the selected available storage location resides upstream of the storage location of the targeted cool bin in the overall travel path of the RSRV from the buffer spot 112b of the second storage zone 102, through the same access shaft 124 from which the targeted cool bin is located, and to a lower exit portal 109a illustrated in FIG. 3, through which the RSRV eventually exits the cooled, second storage zone 102. In this method, the selected available storage location resides en route from the buffer spot 112b of the second storage zone 102 to the storage location of the targeted cool bin, whereby the RSRV does not have to reverse direction at any point along its overall travel path to travel in an ascending, upstream direction back up to the storage location of the targeted cool bin after having deposited the unneeded cool bin.

In another example, the selected available storage location is alternatively positioned a lower level than the storage location of the targeted cool bin, for example, in situations where there are no open upstream storage locations unoccupied by stored cool bins. In this example, the selected available storage location resides downstream of the storage location of the targeted cool bin in the overall travel path of the RSRV, and therefore, the RSRV is configured to temporarily reverse direction after depositing the unneeded cool bin to travel in an ascending upstream direction from the deposited storage location of the unneeded cool bin back up to the storage location of the targeted cool bin. Despite necessitating such momentary backtracking of the RSRV in the upstream direction, the available downstream storage location still resides on the same overall travel path of the RSRV from the buffer spot 112b of the second storage zone 102 to the lower exit portal 109a through the same access shaft 124 by which the targeted cool bin is accessible, but is positioned en route from the storage location of the targeted cool bin to the lower exit portal 109a rather than en route from the buffer spot 112b of the second storage zone 102 to the storage location of the targeted cool bin. Regardless of upstream or downstream relation to the storage location of the targeted cool bin, the CCS keeps the overall occupancy time of the RSRV inside the second storage zone 102 low by selecting an available storage location for the unneeded cool bin by avoiding the need for the RSRV to travel between and transition into and out of multiple access shafts 124 in the cooled, second storage zone 102.

At step 1607, after the RSRV deposits the unneeded cool bin and retrieves the targeted cool bin, the CCS commands the bin-carrying RSRV to descend the access shaft 124 down to the lower track layout 126, exit the cooled, second storage zone 102 via the lower exit portal 109a in the full-span barrier wall 104, and travel through the ambient, first storage zone 101 to the targeted workstation 114 or 115 to which the order being fulfilled has been assigned by the CCS. The targeted workstation is the single-point workstation 114 or the multi-point workstation 115 as exemplarily illustrated in FIG. 15. The CCS commands the travel of the RSRV through the workstation 114 or 115 to the access spot underlying the picking port 117a or 117b, and once product has been picked from the retrieved cool bin carried on the RSRV, commands re-entry of the RSRV into the ambient, first storage zone 101 of the multi-zone ASRS 100 at the lower track layout 126 thereof.

At step 1608, the CCS commands the RSRV to travel upwardly through one of the outer shafts 124a of the 3D gridded storage structure, thereby carrying the retrieved cool bin to the upper track layout 122 of the 3D gridded storage structure. At step 1609, the CCS commands (a) re-entry of the RSRV back into the cooled, second storage zone 102 via the entrance portal 108a thereof, thereby carrying the previously retrieved and now unneeded cool bin back into the cooled, second storage zone 102; (b) movement of the RSRV to a spot adjacent to an available one of the buffers spots 112b of the second storage zone 102; and (c) offloading of the now unneeded cool bin from the RSRV to that available buffer spot 112b for later pickup by another RSRV tasked with subsequent retrieval of another targeted cool bin from the second storage zone 102. At step 1610, the CCS commands the now bin-less RSRV to exit the cooled, second storage zone 102 and return to the ambient, first storage zone 101 through the upper exit portal 109a of the second storage zone 102 at the upper track layout 122 of the 3D gridded storage structure. When the RSRV returns to the ambient, first storage zone 101 at the upper track layout 122, the CCS commands the RSRV to pickup an unneeded ambient bin from one of the buffer spots 112a in the first storage zone 101, thereby freeing up that buffer spot 112a for receipt of another unneeded ambient bin by another RSRV assigned to another cool bin retrieval task. In an embodiment, for the next bin assignment 1611, the CCS assigns the RSRV that picked up the unneeded ambient bin to an ambient bin retrieval task, during which the RSRV is configured to deposit the currently carried unneeded ambient bin in an available storage location accessible off the same access shaft 124 by which the targeted ambient bin is to be retrieved. This available storage location may reside upstream or downstream of the storage location at which the targeted ambient bin of the ambient bin retrieval task resides.

The foregoing method minimizes time spent by any one RSRV in the cooled storage zone 102 or 103 containing the targeted cool bin, in that the CCS assigns a cool bin retrieval task to an RSRV that starts outside the cooled storage zone 102 or 103 in the ambient, first storage zone 101, wherein the assigned RSRV deposits a previously buffered cool bin in an available storage location accessed off the same access shaft 124 as the targeted cool bin the RSRV has been tasked to retrieve, and on the back end, the RSRV returns the retrieved cool bin only to a buffer spot 112b or 112c on the upper track area 122b or 122c of the cooled storage zone 102 or 103 illustrated in FIG. 15, and not to an available storage location that would require travel of the RSRV further into the cooled storage zone 102 or 103. In this method, the unneeded cool bin is buffered in the appropriate environmentally controlled storage zone without having the same RSRV incur added time in the cooled storage zone 102 or 103 to carry the unneeded cool bin down an access shaft 124 for deposit into an available storage location. Instead, on the return path of the overall bin retrieval and return process, the RSRV only briefly enters the cooled storage zone 102 or 103 to drop off the now-unneeded bin to a buffer spot 112b or 112c, and then promptly exits the cooled storage zone 102 or 103 without travelling down any access shaft 124 or retrieving another targeted cool bin.

While the illustrated embodiment uses drive-through workstations 114 and 115 in which the retrieved bins from which product is to be picked are carried through the workstations 114 and 115 on the RSRVs, other embodiments alternatively employ drop-off workstations, for example, conveyor-only workstations, in which case the return path of the bin retrieval and return process is performed by a different RSRV that performed the retrieval task. In an embodiment, the same brief drop-off of the returning cool bin at a buffer spot 112b or 112c of the cooled storage zone 102 or 103 and prompt re-exit of the RSRV after such drop-off are used to minimize time spent by the RSRV in the harsher operating conditions of the cooled storage zones 102 and 103, regardless of whether this RSRV returning the unneeded cool bin to the cooled storage zone 102 or 103 is the same RSRV that previously retrieved that same bin. The subsequent reliance on a different RSRV or the same RSRV once ambiently reacclimatized after spending sufficient time outside the cooled storage zones 102 and 103, to deposit the buffered cool bin in an available storage location positioned en route to its retrieval of another targeted cool bin also helps minimize the time spent by the RSRV in the cooled storage zones 102 and 103 by using one trip through an access shaft 124 of the cooled storage zone 102 or 103 to both retrieve a newly targeted cool bin and deposit a previously returned cool bin. These techniques for minimizing the time spent by the RSRVs in the cooled storage zones 102 and 103 allows use of a universal fleet of standardized RSRVs of a same type that would be used in a purely ambient ASRS without having to incur the cost of specialized cold climate RSRVs specifically configured to optimally handle the harsher operating conditions inside the cooled storage zones 102 and 103.

While the detailed embodiments herein relate to multiple zones of the 3D gridded storage structure being characterized by ambient and cooled environmental conditions, in other embodiments, similar division of the 3D gridded storage structure into isolated storage zones and strategic navigation of the RSRVs to minimize time spent by the RSRVs in one or more storage zones are employed regardless of the particular environmental differences that represent a harsher environment in one or more storage zones relative to the remaining other storage zones. For example, in an embodiment, the multi-zone ASRS 100 is configured with an ambient zone accompanied by a warmed zone that is heated to elevated temperatures above the ambient conditions, for example, for fulfilling food or meal orders with warmed food items from the heated storage zone, in which case the elevated temperatures of the warmed zone denote a harsher operating environment for the RSRVs, exposure time to which is therefore limited using some or all of the techniques disclosed herein. In addition or alternative to temperature, an example of another environmental condition that may be varied between storage zones is humidity, where one or more humidity-controlled storage zones are each configured to operate in a respective humidity range, and are accompanied by one ambient humidity storage zone that lacks any dedicated humidity control beyond any humidity control equipment of the facility that controls the surrounding environment outside the 3D gridded storage structure.

In another example, the different storage zones need not necessarily differ from one another in terms of temperature-controlled environments, and in various embodiments, may focus more on physical isolation of the storage zones from one another due to different categories of product stored therein, for example, high-security goods stored in a fully enclosed second storage zone 102 or third storage zone 103 versus low-security goods stored in a more environmentally open first storage zone 101, whether the security is defined, for example, by value, safety in product items such as firearms, ammunition, pharmaceuticals, etc., or combinations thereof. Another example is physical isolation of allergenic and non-allergenic foods and products such as nuts, allergens, etc., to prevent cross-contamination. In another example, different vendors or customers may demand physical separation of their supplied or ordered goods from those of others to ensure accuracy in inventory management and order tracking. In another example, flammable or otherwise hazardous goods are isolated from others in one of the enclosed storage zones, and one or more enclosed storage zones differ from any one or more other storage zones in terms of safety related equipment such as increased ventilation for storage of odorous and/or noxious substances, and/or inclusion of added or specialized fire suppression equipment to augment existing fire suppression means of the facility, for example, for particularly flammable or hazardous goods. Where flammable goods are being stored in the contained storage zones 102 and 103, in an embodiment, the boundary walls thereof employ particularly fire-retardant construction techniques and materials.

While the illustrated embodiment of the multi-zone ASRS 100 uses open-top storage units to hold inventory within the 3D gridded storage structure, in other embodiments, various storage units capable of storing inventory are stored in the 3D gridded storage structure similarly divided into isolated storage zones, regardless of the particular shape and scale of those storage units and the corresponding configuration and scale of the 3D gridded storage structure, and therefore, the term “storage unit” is used herein to refer to any variety of inventory holders, for example, bins, totes, trays, boxes, pallets, gaylords, etc. While the 3D gridded storage structure in the illustrated embodiment employs both upper and lower track layouts 122 and 126 respectively residing above and below the 3D gridded storage structure comprising the 3D array of storage locations, other embodiments comprise grids with a singular track layout either above or below the 3D array. As disclosed above, the workstations need not necessarily be of a travel-through type in which the RSRVs fully enter the workstations, and therefore, the workstations accordingly need not be positioned directly adjacent a track layout, for example, 126, of the 3D gridded storage structure, or connected thereto by an extension track, as alternative conveyance may alternatively be employed to handle the storage units between the RSRV drop-off points and access points of the workstations where workers interact with the storage units.

Also, while the embodiments employ a cooperative 3D gridded storage structure and RSRV configurations by which the RSRVs travel in their entirety up and down through access shafts 124 in which the RSRVs are operable in four different working positions to laterally access storage columns 123 on any side of any access shaft 124, other embodiments employ a stack-and-dig approach of the type in which the storage units are stacked directly atop one another and retrieved in an overhead manner by robotic handlers, each having a wheeled chassis that remains atop an upper track layout and travels in only two horizontal dimensions, and relies on a lowerable crane to interact with only the uppermost storage units of the stacks from a directly overhead relation thereto. While in the illustrated embodiment, an access location from which each storage unit is retrieved or deposited refers to a space in the neighboring access shaft 124 from which the RSRV laterally reaches into the storage location to or from which the storage unit is deposited or retrieved, in another embodiment, the access location from which a storage unit is extracted or deposited is the spot of the upper track layout overlying a storage column 123 in which storage units are stacked or stackable.

FIG. 17 illustrates a flowchart of a method executed by a robotic storage/retrieval vehicle (RSRV), in response to commands from the computerized control system (CCS), for retrieving a storage unit, herein referred to as a “bin”, from a storage zone of the multi-zone automated storage and retrieval system (ASRS), according to an embodiment herein. Consider an example where the multi-zone ASRS comprises an ambient, first storage zone, Zone 1, and a cooled, second storage zone, Zone 2. At step 1701, the CCS assigns a bin pick task to an RSRV selected as disclosed in the detailed description of FIGS. 15-16. At step 1702, the CCS commands the RSRV to travel to the upper track layout of the three-dimensional (3D) storage structure of the multi-zone ASRS and unload an unneeded bin to a buffer spot in the first storage zone. At step 1703, the CCS commands the RSRV to enter the second storage zone, and records the time of entry of the RSRV into the second storage zone, that is, the Last_TempZone_Entry_Time, in the robot information table of the local facility database as illustrated in FIG. 10C. At step 1704, the CCS commands the RSRV to load an unneeded bin from a buffer spot in the second storage zone. At step 1705, the CCS commands the RSRV to navigate and enter an access shaft or a downshift containing a needed bin in the second storage zone. At step 1706, the CCS commands the RSRV to descend to an unoccupied storage location and put away the unneeded bin. At step 1707, the CCS commands the RSRV to travel to the storage location containing the needed bin in the second storage zone and load the needed bin. At step 1708, the CCS commands the RSRV carrying the needed bin to descend and transition to the lower track layout of the 3D gridded storage structure and exit the second storage zone. The CCS records the time of exit of the RSRV from the second storage zone, that is, the Last_TempZone_Exit_Time, in the robot information table of the local facility database. The CCS records the Last_TempZone_Entry_Time and the Last_TempZone_Exit_Time of each assigned RSRV in the robot information table of the local facility database for prioritizing the RSRVs of longer absence from the second storage zone over the RSRVs of a more recent presence in the second storage zone. The process ends 1709 with the completion of the bin pick task in the second storage zone.

After an unneeded bin is retrieved from a buffer spot in the second storage zone, the CCS selects the storage location to put away the unneeded bin based on vacant or unoccupied storage locations contained in the storage column containing a needed bin. After putting away the unneeded bin in a vacant storage location of the storage column, the RSRV travels to the needed bin, picks the needed bin from the storage location, and exits the second storage zone.

FIG. 18 illustrates a flowchart of a method executed by a robotic storage/retrieval vehicle (RSRV), in response to commands from the computerized control system (CCS), for returning a storage unit, herein referred to as a “bin”, from a storage zone of the multi-zone automated storage and retrieval system (ASRS), according to an embodiment herein. Consider an example where the multi-zone ASRS comprises an ambient, first storage zone, Zone 1, and a cooled, second storage zone, Zone 2. At step 1801, the CCS assigns a bin putaway task to an RSRV selected as disclosed in the detailed description of FIGS. 15-16. At step 1802, the CCS commands the RSRV to travel to an access shaft or an upshaft and onto the upper track layout of the three-dimensional (3D) storage structure of the multi-zone ASRS. At step 1803, the CCS commands the RSRV to enter the second storage zone of the multi-zone ASRS and unload an unneeded bin onto a buffer spot in the second storage zone. At step 1804, the CCS commands the RSRV to return to the first storage zone and load the unneeded bin from the buffer spot in the first storage zone. The process ends 1805 with the assignment of the next task, for example, the next bin putaway task of the unneeded bin in the first storage zone.

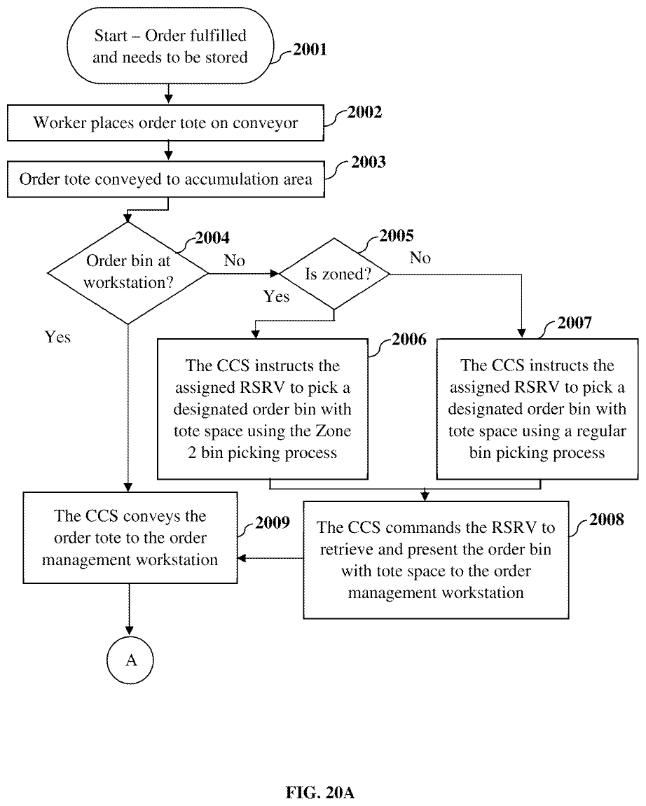

FIG. 19 illustrates a partial perspective view of the multi-zone automated storage and retrieval system (ASRS) 100, showing workstations 143 and 144 attached to the multi-zone ASRS 100 via a conveyor system 145, according to an embodiment herein. In this embodiment, the conveyor system 145 is operably coupled to the lower track layout 126 of the three-dimensional (3D) gridded storage structure of the multi-zone ASRS 100. The conveyor system 145 extends outwardly from one of the perimeter sides of the 3D gridded storage structure. One or more single-point workstations, for example, an order picking workstation 143 and an order management workstation 144, are directly attached to the conveyor system 145 as illustrated in FIG. 19.

As exemplarily illustrated in FIG. 19, empty order totes 1901a are stacked manually on the countertops 143a next to picking ports 143b of the order picking workstation 143. Upon opening an order, in accordance with instructions received from the computerized control system (CCS) of the multi-zone ASRS 100, a worker, for example, a human worker or a robotic worker, at the respective picking port 143b of the order picking workstation 143 picks product items defined in the order from a storage unit 127 presented at the respective picking port 143b and places the product items in a respective order tote 1901a. On completing the picking process and fulfilling the order, in accordance with instructions received from the CCS, the worker places the order tote 1901b containing the picked order on the conveyor system 145. Similarly, other workers at the other order picking workstations 143 place the other order totes 1901b containing respective picked orders on the conveyor system 145. The conveyor system 145 conveys the order totes 1901b containing the picked orders to a tote accumulation area 145a of the conveyor system 145, proximal to the order management workstation 144 as illustrated in FIG. 19. At the order management workstation 144, already picked orders contained in the order totes 1901b are stored and retrieved using order bins 127a of the multi-zone ASRS 100. Each of the order bins 127a are configured to nest or store at least one order tote 1901b therein. For example, the order bin 127a illustrated in FIG. 19 is configured to store two order totes 1901b. Removal of the order totes 1901b that are ready for pickup from the order bin 127a at the order management workstation 144 creates empty tote space or capacity for newly completed orders. The removed order totes 1901b may be placed on a countertop 144a of the order management workstation 144. The CCS anticipates the capacity being created at the order management workstation 144 and conveys the order totes 1901b destined for storage accordingly. If there are no orders being picked up, the CCS anticipates no capacity at the order management workstation 144, and therefore searches for and identifies an order bin 127a with empty tote space. When the order management workstation 144 has capacity, that is, when there are order bins 127a with available tote space for storing the order totes 1901b at the order management workstation 144, the conveyor system 145 conveys the order totes 1901b to the order management workstation 144, where a worker, for example, a human worker or a robotic worker, in accordance with instructions received from the CCS, has already removed order totes 1901b that are ready for pickup and therefore, created tote space for the newly completed orders to be stored in the multi-zone ASRS 100. In accordance with instructions received from the CCS, the worker at the order management workstation 144 moves the order totes 1901b from the conveyor system 145 into an order bin 127a presented at a placement port 144b of the order management workstation 144. When a customer arrives for pickup, the order totes 1901b are retrieved at the order management workstation 144, removed from the order bin 127a, placed on outbound racks, and subsequently freshly picked orders in order totes 1901b are stored in the order bin 127a. In an embodiment, the outbound racks are wheeled tote racks positioned adjacent to the order management workstation 144. When all the tote spaces in the order bin 127a are filled with orders to be picked up, an empty outbound rack is manually wheeled to the order management workstation 144. A customer pickup creates an empty tote space in the order bin 127a and allows a 1:1 exchange. Once delivered to customers, in an embodiment, the empty order totes 1901a are manually collected and stacked next to the order picking workstation 143. The conveyor system 145 is, therefore, used to convey freshly picked orders in order totes 1901b from the order picking workstation 143 to the order management workstation 144.

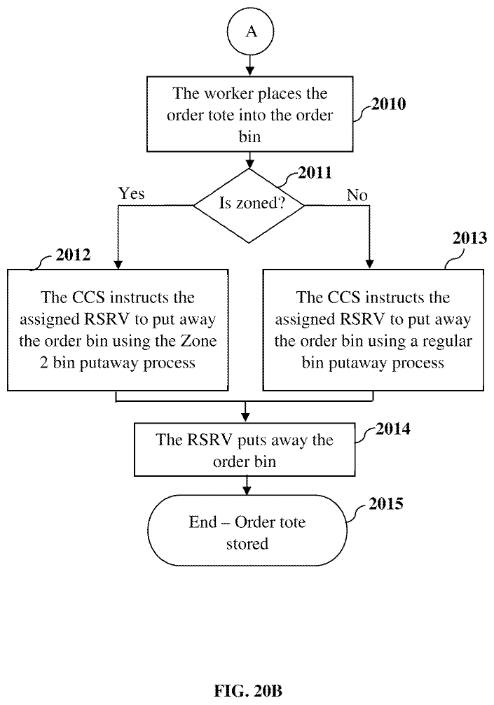

FIGS. 20A-20B illustrate a flowchart of a computer-implemented method for fulfilling and storing an order in the multi-zone automated storage and retrieval system (ASRS), according to an embodiment herein. Consider an example where an order is fulfilled and needs to be stored 2001 in the multi-zone ASRS 100 illustrated in FIG. 19. The order is picked and placed in an order tote at the order picking workstation 143 of the multi-zone ASRS 100 as illustrated in FIG. 19. In accordance with instructions received from the computerized control system (CCS) of the multi-zone ASRS 100, a worker places 2002 the order tote with the fulfilled order on the conveyor system 145 illustrated in FIG. 19. The conveyor system 145 conveys 2003 the order tote to the tote accumulation area 145a of the conveyor system 145, proximal to the order management workstation 144 as illustrated in FIG. 19. The CCS determines 2004 whether an order bin 127a is received at the placement port 144b of the order management workstation 144 illustrated in FIG. 19, for storing the order tote therein. Availability of an order bin at the order management workstation 144 indicates there is an empty tote space available in the order bin for placing the order tote. If an order bin is not received at the order management workstation 144, which indicates there is no pickup order and hence no empty tote space in an order bin for placing an order tote, then the CCS issues commands to an assigned robotic storage/retrieval vehicle (RSRV) to retrieve an order bin with available tote space from one of the storage zones of the multi-zone ASRS 100.

As illustrated in FIG. 20A, if the order bin is not received at the order management workstation 144, the CCS determines 2005 whether the order tote containing the order is to be zoned or stored in a cooled, second storage zone, Zone 2, of the multi-zone ASRS 100. If the order tote containing the order is to be zoned, the CCS instructs 2006 the assigned RSRV to pick a designated order bin with tote space using the Zone 2 bin picking process as disclosed in the detailed descriptions of FIGS. 16-17. If the order tote is not to be zoned, the CCS instructs 2007 the assigned RSRV to pick a designated order bin with tote space using a regular bin picking process from an ambient, first storage zone as disclosed in the detailed description of FIG. 13. After picking the designated order bin, the CCS commands the RSRV to retrieve and present 2008 the order bin with tote space to the order management workstation 144. If the order bin is received at the order management workstation 144, which indicates that there is an order bin with tote space available to store the order tote therein, the conveyor system 145 conveys 2009 the order tote to be stored from the tote accumulation area 145a to the order management workstation 144. In accordance with instructions received from the CCS, the worker at the order management workstation 144 places 2010 the order tote into the order bin. The CCS determines 2011 whether the order bin with the order tote should be zoned or stored in the cooled, second storage zone of the multi-zone ASRS 100. If the order bin with the order tote should be zoned in the cooled, second storage zone, the CCS instructs 2012 the assigned RSRV to put away the order bin using the Zone 2 bin putaway process as disclosed in the detailed descriptions of FIG. 16 and FIG. 18. If the order bin with the order tote should not be zoned in the cooled, second storage zone and instead stored in the ambient, first storage zone, the CCS instructs 2013 the assigned RSRV to put away the order bin using a regular bin putaway process as disclosed in the detailed description of FIG. 13. The RSRV proceeds to put away 2014 the order bin, thereby storing 2015 the order tote in the multi-zone ASRS 100.

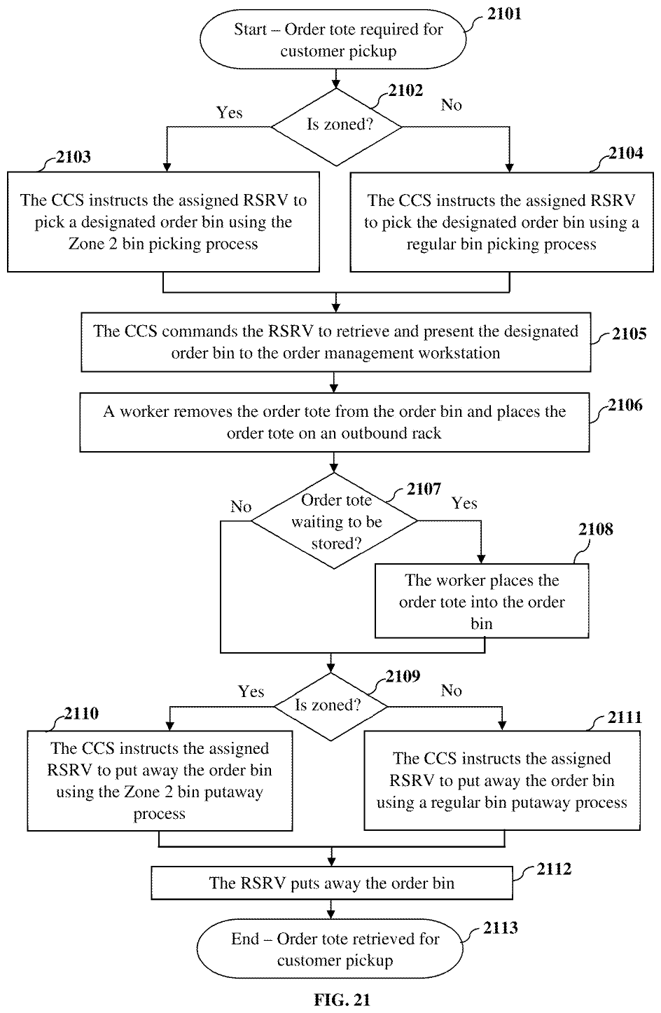

FIG. 21 illustrates a flowchart of a computer-implemented method for retrieving an order from the multi-zone automated storage and retrieval system (ASRS) for pickup by a customer, according to an embodiment herein. The order is stored in an order tote that is stored within an order bin 127a of the multi-zone ASRS 100 as illustrated in FIG. 19. When an order tote is required for pickup 2101 by a customer, the computerized control system (CCS) determines 2102 whether the order tote is zoned or stored in a cooled, second storage zone, Zone 2, of the multi-zone ASRS 100. If the order tote is zoned or stored in the cooled, second storage zone, the CCS instructs 2103 the assigned RSRV to pick a designated order bin containing the order tote using the Zone 2 bin picking process disclosed in the detailed descriptions of FIGS. 16-17. If the order tote is not zoned or stored in the cooled, second storage zone and is instead stored in the ambient, first storage zone of the multi-zone ASRS 100, the CCS instructs 2104 the assigned RSRV to pick the designated order bin containing the order tote using the regular bin picking process as disclosed in the detailed description of FIG. 13. The CCS commands 2105 the RSRV to retrieve and present the designated order bin to the order management workstation 144 illustrated in FIG. 19. In accordance with instructions received from the CCS, a worker at the order management workstation 144 removes 2106 the order tote from the order bin and places the order tote on an outbound rack. The CCS determines 2107 whether an order tote is waiting to be stored. In an embodiment, the order tote pickup process and the order tote storing process is a 1:1 exchange. Therefore, determining whether an order tote is waiting to be stored maps to determining whether an order bin is received at the order management workstation 144 as disclosed in the detailed descriptions of FIG. 19 and FIGS. 20A-20B. That is, as order totes are removed from the order bin for customer pickup, thereby creating tote spaces in the order bin, orders that have been freshly picked, placed into order totes at the order picking workstation 143, and conveyed to the order management workstation 144 illustrated in FIG. 19 are optimally stored within that same order bin to minimize multiple presentations of RSRVs at the order management workstation 144 to perform both tasks with the 1:1 exchange.

If the order tote is waiting to be stored, in accordance with instructions received from the CCS, the worker places 2108 the order tote into the order bin. The CCS determines 2109 whether the empty or tote-occupied order bin should be zoned or stored in the cooled, second storage zone of the multi-zone ASRS 100. If the order bin should be zoned in the cooled, second storage zone, the CCS instructs 2110 the assigned RSRV to put away the order bin using the Zone 2 bin putaway process as disclosed in the detailed descriptions of FIG. 16 and FIG. 18. If the order bin should not be zoned in the cooled, second storage zone and instead stored in the ambient, first storage zone, the CCS instructs 2111 the assigned RSRV to put away the order bin using a regular bin putaway process as disclosed in the detailed description of FIG. 13. The RSRV proceeds to put away 2112 the order bin, thereby allowing retrieval 2113 of the order tote for customer pickup.

FIG. 22 illustrates a flowchart of a computer-implemented method for executing an inventory replenishment workflow between a supply facility and a receiving facility as shown in FIG. 8, according to an embodiment herein. The embodiments herein disclose a method for inducting product inventory at a receiving facility, for example, a micro-fulfillment center, from a supply facility, for example, a macro distribution center, of which at least the receiving facility is equipped with a respective automated storage and retrieval system (ASRS) of a type compatible with a predetermined type of storage unit, herein referred to as a “bin”. In an embodiment, the ASRS is the multi-zone ASRS disclosed above. In FIG. 22, the flowchart illustrates an inventory replenishment routine cooperatively executed by the computerized facility management system (FMS) of the supply facility and the computerized control system (CCS) of one of multiple receiving facilities for fulfilling an inventory replenishment order for the receiving facility. In the method disclosed herein, a supply shipment is received at the receiving facility, on a transport vehicle. The supply shipment contains a quantity of incoming bins shipped from the supply facility. The incoming bins contain therein new product inventory for the receiving facility from the supply facility. The incoming bins from the transport vehicle are exchanged for outgoing bins from the receiving facility, thereby loading the outgoing bins onto the transport vehicle for transit from the receiving facility to the supply facility. The new product inventory is inducted into the ASRS of the receiving facility. Both the incoming bins and the outgoing bins are of the same predetermined type compatible with at least the ASRS of the receiving facility. In an embodiment, the incoming bins are exchanged for the outgoing bins in equal quantity. In an embodiment, the outgoing bins comprise one or more empty bins. Before exchanging the incoming bins and the outgoing bins, at least one previously non-empty bin from the ASRS of the receiving facility is converted into at least one empty bin by consolidating content from at least one previously non-empty bin into one or more other non-empty bins from the ASRS of the receiving facility. Before conversion of at least one previously non-empty bin into at least one empty bin, the CCS operable to control the ASRS of the receiving facility identifies a need for at least one empty bin via execution of automated steps operable to control the ASRS of the receiving facility as follows. Prior to receipt of the supply shipment at the receiving facility, the CCS receives an incoming communication identifying a required quantity of outgoing bins to be exchanged for the incoming bins from the supply facility. The CCS queries a database in which bin inventory and product inventory of the ASRS of the receiving facility are tracked and managed to identify a currently available quantity of candidate outgoing bins. Subject to a determination that the currently available quantity of candidate outgoing bins is less than the required quantity of outgoing bins, the CCS initiates the conversion of at least one previously non-empty inventory bin into at least one empty bin. To initiate the conversion, the CCS automatically queries the database to identify at least two non-empty, less-than-full bins of sufficiently low content to allow consolidation thereof into a less number of bins. Moreover, the CCS commands at least one robotic storage/retrieval vehicle (RSRV) of the ASRS of the receiving facility to retrieve at least two non-empty, less-than-full bins and deliver the two non-empty, less-than-full bins to a workstation. Furthermore, the CCS commands a first RSRV to retrieve an emptiest bin of at least two non-empty, less-than-full bins and commands at least one additional RSRV to retrieve a remainder of the two non-empty, less-than-full bins. The workstation comprises multiple bin access spots. The CCS commands delivery of the emptiest bin to a placement port of the workstation used for consolidation, and commands delivery of the remainder of the two non-empty, less-than-full bins to a separate picking port of the workstation.

In an embodiment, the receiving facility comprises a bin exchange area 119 comprising an inbound lane and an outbound lane as illustrated in FIG. 1, FIG. 6A, FIG. 15, and FIG. 24. The inbound lane leads toward the ASRS from a shipping dock of the receiving facility to handle inbound flow of the incoming bins from the transport vehicle to the ASRS. The outbound lane leads outward from the ASRS toward the shipping dock to handle outbound flow of the outgoing bins from the ASRS to the transport vehicle. Each lane of the bin exchange area 119 comprises a conveyor 120, 121 as illustrated in FIG. 1, FIG. 6A, FIG. 15, and FIG. 24.

Each bin has assigned thereto a unique bin identifier (Bin_ID). The CCS controls the exchange of the incoming bins for the outgoing bins as follows. The CCS receives a notification of an arrival or an approach of the transport vehicle at or near the receiving facility. The CCS commands an RSRV to deliver an outgoing bin from the ASRS of the receiving facility to the outbound lane of the bin exchange area 119. The CCS commands the same RSRV that delivered the outgoing bin to the outbound lane to pickup an incoming bin at the inbound lane and carry the incoming bin to a destination through the ASRS. The destination to which the RSRV is commanded to carry the incoming bin is an available storage location within the ASRS. In an embodiment, the outgoing bins comprise one or more occupied bins. In another embodiment, at least one of the occupied bins contains one or more customer returns. In another embodiment, at least one of the occupied bins contains one or more expired inventory items. In another embodiment, at least one of the occupied bins contains one or more recalled inventory items. In another embodiment, at least one of the occupied bins contains one or more inventory transfers.

The flowchart illustrated in FIG. 22 comprises the steps of an inventory replenishment workflow by which new inventory required at the receiving facility is sourced from the supply facility, and during which the aforementioned exchange of incoming bins, herein referred to as “supply bins”, for outgoing bins is managed and executed. When a replenishment order is required 2201, at step 2202, the CCS of the receiving facility calculates replenishment stock required based on demand forecast, for example, stock keeping unit (SKU) run rates, and existing inventory held at the receiving facility. The CCS determines the products and quantities required to replenish depleted inventory based on current inventory levels and product run rates. Based on the calculation, at step 2203, the CCS generates and transmits a replenishment order over a communication network, for example, the internet or other wide area network, to the FMS of the supply facility. In an embodiment, such communication takes place directly between facilities, or via an intermediary such as a cloud-based platform. Based on the replenishment order details, the intermediary selects the supply facility from among multiple candidates in the network of facilities, for example, according to inventory records in a database such as the central database 803 of the central computing system 801 illustrated in FIG. 8, and relative proximity to the receiving facility. At step 2204, the supply FMS calculates shipment details for the replenishment order, including the required quantity and configuration of the supply bins required to hold and transport the required replenishment inventory according to the details of the replenishment order. In this context, “configuration” refers to a method in which particular products and quantities are distributed among multiple supply bins to optimize the space and bin quantity efficiency of the shipment. In an embodiment, steps 2204 and 2205 are performed by the CCS of the receiving facility, the results of which are sent to the supply FMS. In another embodiment, steps 2202, 2203, 2204, and 2205 are performed by a cloud-based platform or the central computing system 801, the results of which are sent to the CCS and the supply FMS via a communication network.

At step 2205, the supply FMS sends some or all of these shipment details, and at least the quantity of supply bins to the CCS of the receiving facility, before or during actual fulfillment of the replenishment order at the supply facility. In an embodiment, the CCS at the receiving facility optionally performs a bin consolidation process at step 2206 to optimize a quantity of outgoing bins to be exchanged for the incoming supply bins, for example, to best accomplish or approximate a 1:1 exchange ratio, and/or make optimal use of a bin capacity of the transport vehicle. In the bin consolidation process, the CCS issues commands for bin consolidation to create empty bins of a specified quantity. In an embodiment, the bin consolidation process is performed to increase the quantity of empty bins on hand at the receiving facility, or to consolidate customer returns, expired inventory, recalled inventory, or inventory transfers from a current number of bins occupied thereby into a smaller number of bins. In parallel with performance of the consolidation process at the receiving facility, the supply facility fulfills the replenishment order at a workstation of the ASRS of the supply facility by picking and compiling the required replenishment inventory from the ASRS into supply bins for shipment to the receiving facility according to the calculated and transmitted bin quantity and configuration. That is, at step 2207, the supply FMS triggers the assembly of the supply bins according to quantity and configuration. At step 2208, the supply FMS issues commands for loading the supply bins onto a transport vehicle at a loading dock of the supply facility. The now-filled supply bins at the supply facility are loaded into a storage array of the transport vehicle, on an automated or manual basis, and at step 2209, the transport vehicle travels from the supply facility to the receiving facility for auto-induction 2210 at the receiving facility.

FIG. 23 illustrates a flowchart of a computer-implemented method for executing consolidation of storage units, also referred to as “bins”, at a receiving facility for inventory replenishment, according to an embodiment herein. In FIG. 23, the flowchart illustrates a bin consolidation sequence or process for consolidating inventory from multiple inventory bins at a receiving facility, for example, a micro-fulfillment center, thereby creating empty bins that are exchangeable for full supply bins from a supply facility, for example, a macro distribution center. At a facility, for example, the receiving facility comprising an automated storage and retrieval system (ASRS) in which product items are stored in bins, the computerized control system (CCS) executes a method for freeing up a subset of the bins. In the method disclosed herein, from a database in which the bins and product items are tracked and managed, the CCS identifies, from among the bins, at least two non-empty, less-than-full bins currently holding product items therein. The CCS commands at least one robotic storage/retrieval vehicle (RSRV) of the ASRS to retrieve at least two non-empty, less-than-full bins for delivery thereof to a workstation. The CCS instructs one or more human or robotic workers to consolidate the product items from at least two non-empty, less-than-full bins into a lesser quantity of bins, thereby converting at least one of the two non-empty, less-than-full bins into at least one empty bin. In an embodiment, the CCS instructs one or more human or robotic workers to consolidate the product items from a first one or more of the non-empty, less-than-full bins into a second one or more of the non-empty, less-than-full bins, thereby converting the first one or more non-empty, less-than-full bins into one or more empty bins and converting the second one or more non-empty, less-than-full bins into one or more now-fuller bins. In another embodiment, the CCS generates instructions for an automated, partially automated or human transfer of at least one of the now-fuller bins to a loading dock for exchange of the now-fuller bins for at least a subset of incoming bins arriving or expected on a transport vehicle at the loading dock. In another embodiment, the CCS generates instructions for automated, partially automated, or human transfer of one or more empty bins to the loading dock of the facility for exchange of the empty bins for another subset of the incoming bins. In another embodiment, the CCS generates instructions for automated, partially automated or human transfer of at least one empty bin to a loading dock of the receiving facility for exchange of the one empty bin for at least one incoming bin arriving or expected at the loading dock.

In an embodiment, prior to identifying at least two non-empty, less-than-full bins currently holding items therein, the CCS at the receiving facility, at which replenishment inventory is required, receives an incoming communication identifying a required quantity of outgoing bins needed from the supply facility for delivery elsewhere; queries a database to identify a currently available quantity of candidate outgoing bins; and compares the currently available quantity of candidate outgoing bins against the required quantity of outgoing bins, thereby determining a need to create one or additional empty bins. The incoming communication is received from the supply facility to which a replenishment order was previously transmitted to request the replenishment inventory therefrom. The incoming communication identifies a quantity of supply bins in which the replenishment inventory will be transported to the receiving facility, and for which the outgoing bins from the receiving facility are to be exchanged.

The flowchart illustrated in FIG. 23 comprises the steps of the bin consolidation process optionally performed at the receiving facility in step 2206 of the inventory replenishment workflow illustrated in FIG. 22. The CCS at the receiving facility receives 2301 a bin count of a replenishment order from the facility management system (FMS) of the supply facility. At step 2302, the CCS determines the number of outgoing bins required to best compensate the supply facility for its bin loss, that is, ideally to provide outgoing bins at a 1:1 ratio for the incoming supply bins. At this step, the CCS performs an accounting of any customer return bins, expired inventory bins, and inventory transfer bins destined for the supply facility, or routable therethrough to a final destination. If the number of bins destined for the supply facility is less than the required total number of outgoing bins, the CCS subtracts this identified number of occupied outgoing bins from the required total number of outgoing bins to determine the quantity of required empty bins needed to fulfill the overall outgoing bin requirement. In the method illustrated in FIG. 23, the CCS prioritizes customer order fulfillment at the receiving facility over the need for bin compensation at the supply facility, such that bin consolidation and empty bin retrieval does not interrupt customer order fulfillment processes that use the ASRS resources such as RSRVs and workstations of the receiving facility, and therefore, at step 2303, the CCS determines whether a suitable workstation, for example, a two-point workstation, and RSRVs are available to perform a bin consolidation task. If such ASRS resources are not currently available, that is, if the ASRS resources are tied up by order fulfillment tasks, then bin consolidation is delayed until such resources are freed up.

If sufficient resources are determined to be available at step 2303, then at step 2304, the CCS determines whether there is already a sufficient quantity of empty bins available in the ASRS of the receiving facility to fulfill the bin compensation needs. If there is a sufficient quantity of empty bins available in the ASRS of the receiving facility to fulfill the bin compensation needs, then no bin consolidation is required and the process is terminated 2311. If there is an insufficient quantity of empty bins available in the ASRS of the receiving facility to fulfill the bin compensation needs, then the CCS checks for the presence of multiple inventory bins containing the same product, also referred to as “common stock keeping unit (SKU) bins”, and upon confirming such a presence, checks whether among the common SKU bins there are multiple less-than-full bins, of which a remaining quantity in an emptiest of the less-than-full bins is accommodatable by available capacity in one or more of the other less-than-full bins. If there are multiple less-than-full bins, then at steps 2305 and 2306, the CCS commands one RSRV to retrieve the emptiest bin for delivery to the two-point workstation, and commands one or more additional RSRVs to retrieve one or more other less-than-full bins that have the capacity to receive the product quantity from the emptiest bin, and deliver and present the same to the same two-point workstation in sequence. At step 2307, the CCS commands the RSRV carrying the emptiest bin to travel to the picking port of the two-point workstation, and at step 2308, the CCS commands the RSRV(s) carrying one or more other less-than-full bins to sequentially queue up at the placement port of the two-point workstation. At step 2309, the CCS instructs a human or robotic worker to pick the remaining product items in the emptiest bin therefrom and place the remaining product items in one or more other less-than-full bins as the other less-than-full bins are sequentially indexed to the placement port. At step 2310, the CCS updates the local facility database to change a recorded status of the previously emptiest bin to “empty”. The process is then re-iterated from step 2303 onward until enough bins have an empty status to fulfill the bin compensation needs of the replenishment order. The bin consolidation process therefore converts a first set of one or more non-empty, though less-than-full and near-empty, bins into fully-empty bins to be exchanged for incoming supply bins slated to arrive from the supply facility, while a second set of non-empty less-than-full bins are converted into now-fuller bins due to the addition of product items thereto from the now fully-empty bins.

In an embodiment, picking of the replenishment order, or at least shipping thereof from the supply facility, is made conditional on the availability of sufficient outgoing bins at the receiving facility, such that the FMS of the supply facility may await a “sufficient outgoing bin count” confirmation signal from the CCS of the receiving facility before picking or shipping the replenishment order. This represents prioritized fulfillment of in-stock customer orders than can be fulfilled without delay based on already on-hand inventory at the receiving facility during peak order hours, and delaying of inbound transport of the replenishment order until off-peak hours where the lower order frequency frees up more ASRS resources at the receiving facility to enable completion of the bin consolidation process on which the shipment of the replenishment order is conditional. In other embodiments, other prioritization schemes are employed. While the forgoing example of the bin consolidation process is performed on common SKU bins containing the same product, in other embodiments, bin consolidation is also performed in instances of mixed SKU bins containing different products therein. In these embodiments, subdivided multi-SKU bins whose interiors are each divided into multiple compartments are employed, in which case an occupied or empty status of each compartment is used to gauge the overall emptiness and available capacity of a less-than-full bin that qualifies for bin consolidation.

The 1:1 bin swap is implemented for predictable, consistent, balanced bin flow between facilities. In another embodiment, in an example scenario where the supply bin count of a replenishment order is less than a bin capacity of the transport vehicle, and there is a large quantity of occupied outgoing bins awaiting transport to a destination other than the supply facility, but on a route in which the supply facility serves as a cross-dock or through-point, then outgoing empty bins are swapped at a 1:1 ratio to the incoming bins to not shortchange the supply facility for its loss of the incoming bins, while using the extra available vehicle capacity to ship out some of the excess occupied bins, or even to swap the outgoing empty bins at less than 1:1 and increase the quantity of outgoing occupied bins if the need to offload them from the receiving facility exceeds the need to compensate the supply facility with empty bins.

In other embodiments, the same consolidation of useful product inventory in the ASRS of the receiving facility is performed for purposes other than specifically creating empty inventory bins for exchange with incoming supply bins, that is, for purposes other than compensating the bin loss of a supply facility from which those incoming supply bins are arriving. For example, picking an order for a large quantity of a single product from a multitude of inventory bins each containing a less-than-full or near-empty quantity of that product is much less time and resource efficient than fulfilling that order from a lesser quantity of full or near-full inventory bins. Accordingly, the same identification of at least two non-empty, less-than-full common SKU bins for consolidation can be used in combination in subsequent execution of steps 2305-2310 illustrated in FIG. 23, even when the motivation for the consolidation is not a compensatory empty bin requirement driving the preceding decision steps 2302 and 2304 in the method illustrated in FIG. 23. In an embodiment, a bin consolidation process motivated by the aforementioned picking efficiency is performed during off-peak hours so as not to tie up ASRS resources such as RSRVs and workstations that could otherwise be busy with order fulfillment tasks, the availability of which are checked at step 2303 in the method illustrated in FIG. 23.

In other embodiments, the same bin consolidation process, instead of generating empty outgoing bins by consolidating useful product inventory of the receiving facility, is used to consolidate customer returns, expired inventory, recalled inventory, and inventory transfers, generally categorized as unwanted goods, from less-than-full bins currently stored in the ASRS of the receiving facility to reduce the quantity of bins occupied by such unwanted goods. For example, this is useful if the quantity of stored bins occupied by such unwanted goods exceeds the quantity of expected incoming supply bins, and/or exceeds the capacity of the transport vehicle on which the incoming supply bins are expected and on which it would be desirable to ship out at least some of the unwanted goods. The consolidation process can therefore be used to reduce the number of bins storing unwanted goods to a quantity equal to the transport vehicle bin capacity or equal to the quantity of incoming supply bins expected on the transport vehicle, if the initial number of bins containing unwanted goods originally exceeded such vehicle capacity or incoming bin quantity. Alternatively, if the initial number of bins containing unwanted goods is already less than the vehicle capacity or incoming supply bin quantity, then the consolidation process can be used to decrease the number of bins storing unwanted goods to free up more room for empty outgoing bins on the transport vehicle, whether the empty bins loaded onto the transport vehicle are already-empty bins stored in the ASRS of the receiving facility, one or more empty bins created by this consolidation of unwanted goods, and/or one or more empty bins created by the consolidation of useful product inventory in the method disclosed in the detailed description of FIG. 23. In another embodiment, the consolidation of unwanted goods is executed independent of the details of any replenishment order, for the purpose of minimizing the number of stored bins occupied by such unwanted goods in the ASRS.

In consolidation of unwanted goods, the method illustrated in FIG. 23 executes the same search of the database for at least two non-empty, less-than-full bins suitable for consolidation, but particularly looking for those bins that are flagged as containing unwanted goods, as opposed to useful product inventory. Such search may or may not be performed among common SKU bins depending on the scenario. For example, in cases of expired product, particularly where the nature of the expired products does not demand sortation, separation, or specialized handling, for example, hazardous versus non-hazardous goods, compostables versus non-compostables, recyclables versus non-recyclables, expired items of different SKUs and product categories are optionally consolidated in the same bins as one another. In the case of customer returns or recalled inventory, in an embodiment, the search is made among bins whose contents are related by SKU, manufacturer/supplier, and/or the intended destination for those customer returns or recalled inventory. In the case of inventory transfers, in an embodiment, the search is made among bins whose contents are related by the intended destination for the inventory being transferred, whether also related by SKU. While the term SKU is used herein, other unique product identifiers are used in various embodiments, for example, including universal product codes (UPCs) that are not vendor specific. Accordingly, the ASRS is optionally used for storing inventory of multiple vendors, and fulfilling orders received by, or on behalf of, such multiple vendors. Once such two or more consolidation-eligible bins are identified, the consolidation process then proceeds along the lines of steps 2305-2310 of the method illustrated in FIG. 23. Unlike with the consolidation of useful product inventory, in an embodiment, one or more resulting bins with the consolidated unwanted inventory, rather than being stored back in the ASRS, is optionally ejected from the ASRS or workstation as an occupied outgoing bin to be exchanged for one or more incoming supply bins arriving on the transport vehicle, for example, via the bin exchange process disclosed below.

FIG. 24 illustrates a top plan view of the multi-zone automated storage and retrieval system (ASRS) 100, showing travel routes of a robotic storage/retrieval vehicle (RSRV) and a storage unit configured by the computerized control system (CCS) for executing an exchange and induction of storage units, according to an embodiment herein. As illustrated in FIG. 24, the multi-zone ASRS 100 comprises a two-lane bin exchange area 119. The bin exchange area 119 comprises an outbound conveyor 121 spanning outward from the lower track layout of the three-dimensional (3D) gridded storage structure of the multi-zone ASRS 100 at one side thereof, and at the ambient, first storage zone thereof in the illustrated multi-zone embodiment. The bin exchange area 119 further comprises a neighboring inbound conveyor 120 residing in adjacent parallel relation to the outbound conveyor 121 at the same side of the 3D gridded storage structure. An inner end of each conveyor 120, 121 is positioned closely adjacent or just inside the 3D gridded storage structure at a short elevation above the lower track layout thereof, whereby an RSRV on the lower track layout of the 3D gridded storage structure is configured to hand off an outgoing empty inventory bin to the outbound conveyor 121, for example, via a transfer table installed on a perimeter-adjacent spot of the lower track layout at the inner end of the outbound conveyor 121, and then receive an incoming supply bin from the inbound conveyor 120, for example, via another transfer table likewise installed on a perimeter-adjacent spot of the lower track layout at the inner end of the inbound conveyor 120. The spots on the lower track layout of the 3D gridded storage structure at which the incoming supply bins and the outgoing empty inventory bins enter and exit the 3D gridded storage structure, for example, on transfer tables, at the inner ends of the inbound conveyor 120 and the outbound conveyor 121, are exemplarily referred to as inbound and outbound bin ports 146, 147 of an induction station at which the replenishment inventory first enters the 3D gridded storage structure. Though the following example refers particularly to an outgoing empty inventory bin, the other types of outgoing bins disclosed above, for example, customer return bins, expired/unneeded inventory bins, etc., may be exchanged for incoming supply bins in the same manner via the bin exchange area 119.

FIG. 25 illustrates a flowchart of a computer-implemented method for executing an exchange and induction of storage units, herein referred to as “bins”, based on the configured travel routes shown in FIG. 24, according to an embodiment herein. The process of exchanging bins at an induction station and bin exchange area is illustrated in FIG. 25. In FIG. 25, the flowchart illustrates a bin exchange routine and a bin induction routine cooperatively executed by the computerized control system (CCS) of a receiving facility, for example, a micro-fulfillment center, and the computerized vehicle management system of an arriving transport vehicle from a supply facility, for example, a macro distribution center. The encircled numbers positioned adjacent to the steps of the flowchart illustrated in FIG. 25 represent points along the illustrated bin travel paths in the plan view map of FIG. 24, with the solid line path representing travel atop the upper track layout of the three-dimensional (3D) gridded storage structure of an automated storage and retrieval system (ASRS), for example, the multi-zone ASRS 100 illustrated in FIG. 24, and the broken line travel path representing travel on the lower track layout of the 3D gridded storage structure. The square boxes marked with “R” indicate actions taken with respect to a replenishment/supply bin, and the square boxes marked with “E” indicate actions taken with respect to an empty inventory bin or other outgoing bin.

The bin exchange and induction process illustrated in FIG. 25 starts 2501 with the arrival of a transport vehicle carrying incoming supply bins at a receiving facility. At step 2502, the vehicle management system (VMS) of the transport vehicle carrying the incoming supply bins notifies the CCS of the receiving facility of the arrival of the transport vehicle at, or approaching proximity to, the receiving facility via a wide area wireless network, and optionally through a cloud-based platform. A sequence of steps involving management of incoming supply bins are executed in parallel relation to a sequence of steps involving management of the outgoing empty inventory bins.

Starting with the supply bin management sequence on the left side of FIG. 25, at step 2503, a first incoming supply bin is unloaded from the transport vehicle onto the inbound conveyor 120 illustrated in FIG. 24, for example, from a platform of a cargo carousel of the transport vehicle, and in an embodiment on a fully automated basis or optionally on a manually aided basis. At step 2504, the Bin_ID of the supply bin being loaded onto the inbound conveyor 120 is communicated to the CCS, for example, by the VMS which in a local computer readable memory thereof had previously recorded the Bin_ID of each supply bin loaded at a respective storage location, for example, a carousel platform, in the storage array of the transport vehicle, whereby unloading of the respective supply bin from each such location of the storage array of the transport vehicle triggers or involves forwarding of the Bin_ID of that supply bin to the CCS of the receiving facility. Instead of being forwarded by the VMS on the basis of the unique Location_ID of the storage location from which the supply bin is being offloaded from the transport vehicle, in an embodiment, the Bin_ID of the incoming supply bin is scanned or wirelessly read from the supply bin by a suitably positioned and automated reader, or by a human operated reader, as the supply bin is being loaded onto the inbound conveyor 120.

Meanwhile, in the empty bin management sequence on the right side of FIG. 25, at step 2509, the CCS commands an RSRV to retrieve from the 3D gridded storage structure a first of the empty bins previously identified or created in the bin consolidation process disclosed in the detailed description of FIG. 23, and thereby designated for exchange with the incoming supply bins. In response, at step 2510, the RSRV travels from the upper track layout of the 3D gridded storage structure to an access shaft neighboring the storage column that contains this empty bin, transitions into this access shaft, descends therein to the level at which the storage location of the empty bin resides, extracts the empty bin from this storage location, and then carries this extracted empty inventory bin down to the lower track layout of the 3D gridded storage structure, and travels thereon to the induction station at step 2511. Meanwhile, in the supply bin management sequence, at step 2505, the first supply bin unloaded from the transport vehicle is being conveyed toward the induction station on the inbound conveyor 120 and arrives at the inbound port 146 of the induction station.

Returning to the empty bin management sequence, the RSRV carrying the first extracted empty inventory bin on the lower track layout of the 3D gridded storage structure unloads this empty bin to the outbound port 147 of the induction station at step 2512. Returning to the supply bin management sequence, at step 2506, the same RSRV that just dropped off the first empty inventory bin at the outbound port 147 of the induction station then loads the first supply bin onto itself, and at step 2507 travels to an available storage location in the 3D gridded storage structure and deposits the supply bin therein. In an embodiment, following the vortex travel patterns disclosed above, this depositing of the supply bin comprises first carrying the supply bin up an outer shaft 124a of the 3D gridded storage structure to the upper track layout, then travelling thereon to the spot overlying an access shaft 124 neighboring the available storage location as illustrated in the solid-line travel path of FIG. 24, and then descending down this access shaft 124 to the level of the available storage location to deposit the supply bin therein. Upon confirming successful deposit of the supply bin, at step 2508, the CCS updates its local facility database to register the Bin_ID of the now-deposited supply bin with the Location_ID of the storage location in which the supply bin was just deposited, whereby the location of the particular replenishment inventory items loaded into the supply bin at the supply facility is registered, thereby completing the induction of these inventory items into the ASRS of the receiving facility. In an embodiment, the particular inventory contents of the supply bin are identified using data stored locally on a dynamically updateable computer-readable memory on the supply bin itself, and read by the CCS anytime during the bin exchange and induction process. In another embodiment, the particular inventory contents of the supply bin are stored in association with the Bin_ID in the database of the cloud platform, from which the CCS accesses this data to update its own local facility database. In another embodiment, the local facility database is omitted, and the cloud database is updated by the CCS to update the location status of the supply bin with a unique Facility_ID of the receiving facility, and the Location_ID of the storage location in which the supply bin was just deposited at the receiving facility. The redundancy of a local facility database enables operation of the ASRS even in the event of communication outages with the cloud platform.

Meanwhile, at step 2513 in the empty bin management sequence, since having been dropped off at the outbound port 147 of the induction station, the first empty bin is being conveyed toward the loading dock of the receiving facility on the outbound conveyor 121 illustrated in FIG. 24. Upon reaching the outer end of the outbound conveyor 121 at the loading dock, the empty bin is loaded onto the transport vehicle at step 2514, being placed at a particular storage location within the storage array thereof. Before or at this point, the VMS receives the unique Bin_ID of this empty bin from the CCS, or by scanning or wireless reading of the Bin_ID from the empty bin itself by a suitable reader of the VMS as the empty bin is being loaded onto the transport vehicle. At step 2515, the VMS registers the Bin_ID in association with the Location_ID of the particular storage location at which the empty bin is placed in the storage array of the transport vehicle, thereby enabling the same optional vehicle-reporting of this Bin_ID to the supply facility by the transport vehicle upon arrival thereat with the shipment of empty bins intended to fully or partially compensate for the supply bins previously shipped therefrom on the same transport vehicle. The process ends 2516 with the successful exchange of the incoming supply bins and the outgoing empty bins.

FIG. 26 illustrates a top perspective view of a transport vehicle 813 arriving at a receiving facility 14 for executing an exchange and induction of storage units 127, also referred to as “storage bins”, according to an embodiment herein. The transport vehicle 813 is used to transport storage units 127 between a supply facility, for example, a macro distribution center, and a receiving facility 14, for example, a micro-fulfillment center. The transport vehicle 813, similar to the larger three-dimensional (3D) gridded storage structure of the automated storage and retrieval system (ASRS) of the receiving facility 14, comprises a 3D array of a predetermined number of storage locations therein, each sized and configured for receipt of a respective storage unit therein, and each having a respective location address assigned thereto for use in electronic tracking of the particular storage unit placed in any storage location at any time. In an embodiment, instead of a smaller scale version of the 3D grid-based ASRS used by the facilities, the illustrated embodiment employs a set of cargo carousels 815 in a rear cargo area of the transport vehicle 813, for example, a trailer of a semi-trailer truck, or a rear cargo hold of a box truck or van, as disclosed in Applicant's PCT international application number PCT/IB2020/051721, the entirety of which is incorporated herein by reference. Each cargo carousel 815 comprises a pair of continuous-loop belts or chains that run longitudinally of the trailer in laterally spaced apart relation to one another, and are each entrained around a pair of respective sheaves or sprockets operable to drive the belt or chain around its continuous loop path. A series of platforms is suspended between the two continuous loops at regular intervals therealong for the purpose of seated support of a respective storage unit 127 on each platform. Driven operation of the belts/chains thus displaces platforms longitudinally of the cargo area of the transport vehicle 813 in opposite directions in top and bottom halves of the closed loop path, thereby enabling movement of each platform to a loading/unloading position at the rear end of the cargo carousel 815 that resides just inside a rear loading door of the cargo area.

In addition to the local computerized facility management system (FMS) 805 at each facility and the computerized control system (CCS) 817 at the receiving facility 14, the overall computerized inventory management system further comprises a cloud-based computer platform or the central computing system 801, and the computerized VMS 814 on each transport vehicle 813 as illustrated in FIG. 8. The cloud-based computer platform hosts a database, for example, the central database 803 illustrated in FIG. 8 and FIGS. 10A-10B, that stores the Bin_IDs of all storage units 127 in the supply chain ecosystem and product catalogues of the inventory stored in the supply chain ecosystem. Each such VMS 814 comprises a mobile wide area wireless or cellular communications device communicable with the cloud-based computer platform, and in an embodiment, also comprises a local wireless network to which wireless communication units on the storage units 127 are configured to connect. The VMS 814 is operable to receive the Bin_IDs of any storage unit 127 being loaded therein whether by scanning of a barcode, reading of a radio-frequency identifier (RFID), or wireless communication with a mobile data storage device on the storage unit 127 by which data concerning contents of the storage unit 127 are dynamically updated during filling of the storage unit 127 at any facility, and then read upon receipt of the storage unit 127 by any transport vehicle 813 or facility. During loading of the transport vehicle 813 at any facility, the VMS 814 records the transfer of the identified storage units 127 from the facility to the transport vehicle 813 in the database of the cloud-based computer platform, for example, by transmitting a unique identifier of the transport vehicle 813, Vehicle_ID, to the cloud-based computer platform, where the database is updated to change the current location of that storage unit 127 from a Facility_ID of the facility the storage unit 127 is departing, to a Vehicle_ID of the transport vehicle 813 on which the storage unit 127 is now travelling. In an embodiment, this recordal of the bin transfer from the facility to the transport vehicle 813 is performed by the CCS 817 of the facility the storage unit 127 is leaving, rather than the VMS 814, for example, by reading and recording the Vehicle_ID of the transport vehicle 813 at the loading dock, and reading and recording the Bin_IDs of the storage units 127 being loaded onto the transport vehicle 813, and updating the cloud computing database accordingly.

The carousels 815 of the transport vehicle 813 form a dynamic array of storage locations, in that each platform denotes a respective storage location, but each storage location is movable into different positions within the trailer by operation of the carousel 815. This differs from the static array of storage locations at the facilities, where each storage location in the 3D gridded storage structure is at a fixed static position therein and not at a dynamically movable position. The use of a dynamic storage array in the transport vehicle 813 enables convenient loading thereof from the rear loading door of the trailer. However, in other embodiments, a different type of storage array is used in the transport vehicle 813, for example, a miniaturized version of the RSRV-served gridded storage structure used in each facility, or another human or robot-served storage array with storage locations, for example, shelves, cubbies, etc., suitably sized to specifically fit the standardized size and shape of the storage units 127. The transport vehicle 813 is equipped with a global positioning system (GPS) device that tracks the movement and location of the transport vehicle 813, and a mobile cellular communication device that communicates the current location of the transport vehicle 813 to the cloud-based computer platform. Querying of the cloud database for a Bin_ID, for example, based on the cataloged product currently stored in that storage unit 127, therefore, reports on the current location of that storage unit 127 based on the GPS coordinates of the transport vehicle 813 on which the storage unit 127 is travelling.

In various embodiments, supply bins from the supply facility for replenishing stock at the receiving facility 14 are exchanged for outgoing bins from the receiving facility 14, whereby the ASRS of the supply facility is not continually shorted in its on-hand supply of storage bins. In an embodiment, the exchange is typically performed at a one-to-one ratio. In an embodiment, the outgoing bins include at least some empty inventory bins from the ASRS. In another embodiment, the outgoing bins additionally or alternatively include one or more customer return bins, each containing one or more customer-returned products for the purpose of shipping the customer return to the supply facility, where the customer return can be inspected and handled on the larger premises of the supply facility, or can be shipped even further upstream toward another returns-handing facility, whether part of the facility network or external thereto, for example, to an outside supplier or manufacturer. In addition or alternative to empty inventory bins and customer return bins, outgoing bins from the receiving facility 14 comprise inventory transfer bins containing unneeded or slow-moving inventory to be shipped upstream to the supply facility, for example, for redistribution to another facility in the network at a locale with greater market demand for such items.

In another embodiment, the outgoing bins from the receiving facility 14 comprise expired-inventory bins containing expired inventory to be transported upstream to the supply facility for disposal thereat, or redistribution therefrom to a suitable disposal site or other final destination, for example after consolidation with expired inventory from other facilities replenished by that same supply facility. In another embodiment, the outgoing bins from the receiving facility 14 comprise recalled-inventory bins containing inventory that has been recalled by a supplier or a manufacturer and can be routed upstream thereto via the supply facility. The outgoing bins from the receiving facility 14 can therefore be categorized generally into two groups, empty bins free of any content and occupied bins having items therein, for example, customer returns, expired inventory, recalled inventory, and inventory transfers.

The multi-zone ASRS 100 exemplarily illustrated in FIGS. 1-3, FIG. 6A, FIGS. 8-9, FIG. 15, FIG. 19, and FIG. 24, employed at a facility, for example, the receiving facility, is a freestanding, high density storage and retrieval system with multiple environmentally controlled storage zones, also referred to as “temperature zones”. The freestanding aspect of the multi-zone ASRS 100 eliminates the need to construct walk-in temperature zones to buildings and install separate ASRSs operating independently within each temperature zone. The multi-zone ASRS 100 comprises vertical barrier walls that vertically separate the temperature zones of the multi-zone ASRS 100. The access portals configured in the vertical barrier walls of the multi-zone ASRS 100 allow horizontal movement, for example, entry and exit movements, of the robotic storage/retrieval vehicles (RSRVs) between the temperature zones. The multi-zone ASRS 100 integrates temperature zones that are accessible by all the RSRVs such that each storage unit of all temperature zones can be accessed by any workstation. The workstations of the multi-zone ASRS 100 are configured to receive product items from all the temperature zones. The RSRVs are not specific to temperature zones and spend minimal time in chilled/freezer temperature zones. This minimizes the cost and complexity of installing and operating an ASRS across multiple temperature zones. In an embodiment, the multi-zone ASRS 100 does not store storage units in differing temperature zones. That is, while storage units associated with a cooled storage zone are routed from the cooled storage zone through an ambient storage zone to access a workstation, the multi-zone ASRS 100 does not store these storage units in the ambient storage zone. The self-contained nature of the multi-zone ASRS 100 allows all components to be integrated within the footprint of the two-dimensional (2D) lower track layout of the 3D gridded storage structure of the multi-zone ASRS 100, thereby precluding the need for walk-in coolers to be pre-constructed or additional components to be installed around the 3D gridded storage structure and expanding the 2D footprint of the multi-zone ASRS 100.

Having vertical delineated temperature zones that are in direct communication with the ambient storage zone constrains the number of temperature transitions to one. The method that RSRVs access storage units in each temperature zone minimizes time spent in temperature zones and maximizes throughput performance. Using the access portals on the 2D upper track layout of the 3D gridded storage structure to enter the temperature zones and the access portals on the 2D lower track layout to exit temperature zones minimizes route contention and route length. This reduces the journey time in temperature zones, which minimizes exposure to non-ambient temperatures. As a result, the physical temperature change of the RSRVs is minimized, which lowers the requirements for corrective measures of adverse effect, for example, fogging of a camera, when the RSRVs transition temperature gradients. Spending as little time as possible in non-ambient temperatures allows one RSRV variant to work in all temperature zones, while also lowering RSRV design requirements since operation is not exclusive to harsh environments.

Since all workstations are attached to the 2D lower track layout, which is continuous to all temperature zones, all RSRVs and therefore all storage units from each temperature zone are accessible at all workstations. Order pickers can therefore work in the comfort of ambient temperatures while picking goods that are chilled or frozen. Orders containing items from multiple temperature zones can also be assembled at a single workstation, rather than conducting picking operations from each temperature zone and having to consolidate all lines items to fulfill the order. The insulated workstation variant illustrated in FIGS. 6A-6B, that attaches directly to the non-ambient temperature zone allows exclusive picking of chilled or frozen items without the zoned storage unit leaving the temperature zone. For applications where changing temperature is a concern, the insulated workstation attached directly to the temperature zone can be used. This constrains the temperature of stored goods, while also allowing the worker to pick items in ambient temperature.

The storage geometry of the multi-zone ASRS 100 is useful in chilled and frozen environments since the central void of downshafts acts as ducts between a cold air reservoir in the upper track layout and the lower track layout of the 3D gridded storage structure of the multi-zone ASRS 100, thereby allowing the multi-zone ASRS 100 to act as a self-contained, freestanding freezer or cooler. Each storage unit is in communication with the downshaft which optimizes access to cold air to chill its contents. Each storage unit is also shelved which allows for voids between storage units further increasing air flow to the contents of each storage unit.

Moreover, orders, once picked, can be assembled in advance and stored within the multi-zone ASRS 100 until customers arrive for order pickup. The integrated workflow of the order management disclosed herein allows workers to both remove orders for pickup and induct orders for storage with a single presentation of an RSRV at a workstation. This 1:1 exchange of order totes minimizes RSRV touches and therefore lowers the number of RSRVs required in the system to meet throughput requirements.

Furthermore, the embodiments herein also employ a 1:1 exchange technique of forward and reverse storage units during auto-induction at the receiving facility, for example, a micro-fulfillment center, and a supply facility, for example, a servicing distribution center, during the replenishment process. As the forward flow rate is identical to the reverse flow rate and physical and logical custody of each storage unit is directly transferred between entities, shipping and receiving processes and associated staging areas can be eliminated in the micro-fulfillment and distribution center sites, which substantially reduces labor, real estate and resource requirements while streamlining logistics, making operations orderly and easier to monitor in real time over the chaotic approaches used in conventional supply chains. This eliminates the buffer overflow of materials and therefore staging areas, while further increasing the orderliness and predictability of the supply chain network. Storage units flowing in a reverse direction can be loaded with goods to be transported up the hierarchy of facilities to support customer returns, making reverse logistics cost effective over conventional methods. To support this, upon replenishment requests, the forward quantity of storage units is calculated and known to allow the receiving facility to use consolidation and return processes to create the corresponding number of reverse storage units. The consolidation process both streamlines replenishment and frees up space within the storage structure to maximize density.

Where databases are described such as the central database 803, the local facility databases 808 and 825, and the local vehicle database 826 illustrated in FIGS. 8-9 and FIGS. 10A-10E, it will be understood by one of ordinary skill in the art that (i) alternative database structures to those described may be employed, and (ii) other memory structures besides databases may be employed. Any illustrations or descriptions of any sample databases disclosed herein are illustrative arrangements for stored representations of information. In an embodiment, any number of other arrangements are employed besides those suggested by tables illustrated in the drawings or elsewhere. Similarly, any illustrated entries of the databases represent exemplary information only; one of ordinary skill in the art will understand that the number and content of the entries can be different from those disclosed herein. In another embodiment, despite any depiction of the databases as tables, other formats including relational databases, object-based models, and/or distributed databases are used to store and manipulate the data types disclosed herein. In an embodiment, object methods or behaviors of a database are used to implement various processes such as those disclosed herein. In another embodiment, the databases are, in a known manner, stored locally or remotely from a device that accesses data in such a database. In embodiments where there are multiple databases, the databases are integrated to communicate with each other for enabling simultaneous updates of data linked across the databases, when there are any updates to the data in one of the databases.

The embodiments disclosed herein are configured to operate in a network environment comprising one or more computers that are in communication with one or more devices via a communication network. In an embodiment, the computers communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors that are adapted to communicate with the computers. In an embodiment, each of the computers is equipped with a network communication device, for example, a network interface card, a modem, or other network connection device suitable for connecting to a network. Each of the computers and the devices executes an operating system. While the operating system may differ depending on the type of computer, the operating system provides the appropriate communications protocols to establish communication links with the network. Any number and type of machines may be in communication with the computers.

The embodiments disclosed herein are not limited to a particular computer system platform, processor, operating system, or communication network. One or more of the embodiments disclosed herein are distributed among one or more computer systems, for example, servers configured to provide one or more services to one or more client computers, or to perform a complete task in a distributed system. For example, one or more of embodiments disclosed herein are performed on a client-server system that comprises components distributed among one or more server systems that perform multiple functions according to various embodiments. These components comprise, for example, executable, intermediate, or interpreted code, which communicate over a network using a communication protocol. The embodiments disclosed herein are not limited to be executable on any particular system or group of systems, and are not limited to any particular distributed architecture, network, or communication protocol.

The foregoing examples and illustrative implementations of various embodiments have been provided merely for explanation and are in no way to be construed as limiting of the embodiments disclosed herein. While the embodiments have been described with reference to various illustrative implementations, drawings, and techniques, it is understood that the words, which have been used herein, are words of description and illustration, rather than words of limitation. Furthermore, although the embodiments have been described herein with reference to particular means, materials, techniques, and implementations, the embodiments herein are not intended to be limited to the particulars disclosed herein; rather, the embodiments extend to all functionally equivalent structures, methods and uses, such as are within the scope of the appended claims. It will be understood by those skilled in the art, having the benefit of the teachings of this specification, that the embodiments disclosed herein are capable of modifications and other embodiments may be effected and changes may be made thereto, without departing from the scope and spirit of the embodiments disclosed herein.

What is claimed is:

1. A multi-zone automated storage and retrieval system comprising:
a plurality of storage locations configured to accommodate placement and storage of storage units therein;
a first storage zone comprising a first group of the storage locations;
a second storage zone comprising a second group of the storage locations;
at least one barrier isolating the second storage zone from the first storage zone;
one or more portals opening through the at least one barrier between the first storage zone and the second storage zone;
at least one track layout comprising a first track area occupying the first storage zone, a second track area occupying the second storage zone, and one or more connective track segments interconnecting the first track area and the second track area through the one or more portals configured in the at least one barrier; and
one or more robotic storage/retrieval vehicles (RSRVs) configured to deposit and retrieve the storage units to and from the storage locations, wherein the one or more RSRVs are further configured to travel on the at least one track layout on both the first track area and the second track area to respectively access the first group of the storage locations and the second group of the storage locations therefrom, and wherein the one or more RSRVs are further configured to travel between the first track area and the second track area via the one or more connective track segments connected therebetween.

2. The multi-zone automated storage and retrieval system of claim 1, wherein the first storage zone and the second storage zone differ from one another in one of environmental control equipment installed therein and operating characteristics of the environmental control equipment.

3. The multi-zone automated storage and retrieval system of claim 1, wherein one of the first storage zone and the second storage zone is a cooled storage zone having, a lower environmental operating temperature than another of the first storage zone and the second storage zone.

4. The multi-zone automated storage and retrieval system of claim 1, wherein the at least one track layout comprises an upper track layout positioned above the storage locations, and wherein the at least one barrier comprises an upper portion standing upright from the upper track layout, and wherein at least one of the one or more portals is configured to open through the at least one barrier at the upper portion thereof to accommodate a connective track segment of the upper track layout that interconnects the first track area and the second track area of the upper track layout.

5. The multi-zone automated storage and retrieval system of claim 1, wherein the at least one track layout comprises a lower track layout positioned below the storage locations, and wherein the at least one barrier comprises a lower portion standing upright from the lower track layout, and wherein at least one of the one or more portals is configured to open through the at least one barrier at the lower portion thereof to accommodate a connective track segment of the lower track layout that interconnects the first track area and the second track area of the lower track layout.

6. The multi-zone automated storage and retrieval system of claim 5, wherein the storage units stored in the first group of the storage locations and the second group of the storage locations are accessible by any one of a plurality of workstations attached to the lower track layout that extends continuous to the first storage zone and the second storage zone.

7. The multi-zone automated storage and retrieval system of claim 1, further comprising:
a third storage zone isolated from both the first storage zone and the second storage zone by at least one additional barrier, wherein the third storage zone comprises a third group of the storage locations; and
at least one additional portal opening through the at least one additional barrier between the third storage zone and at least one of the first storage zone and the second storage zone, wherein the at least one additional portal is configured to accommodate travel of the one or more RSRVs therethrough.

8. The multi-zone automated storage and retrieval system of claim 7, wherein the at least one additional portal comprises portals opening to the both the first storage zone and the second storage zone.

9. The multi-zone automated storage and retrieval system of claim 7, wherein the at least one track layout comprises an upper track layout positioned above the storage locations, and wherein the at least one additional barrier comprises an upper portion standing upright from the upper track layout.

10. The multi-zone automated storage and retrieval system of claim 9, wherein the at least one additional portal comprises at least one upper portal opening through the at least one additional barrier at the upper portion thereof.

11. The multi-zone automated storage and retrieval system of claim 7, wherein the first storage zone, the second storage zone, and the third storage zone differ from one another in one of environmental control equipment installed therein and operating characteristics of the environmental control equipment, and wherein the first storage zone, the second storage zone, and the third storage zone are accessible by the one or more RSRVs.

12. The multi-zone automated storage and retrieval system of claim 1, further comprising one or more buffer spots, wherein each of the one or more buffer spots is positioned at a location on the at least one track layout and accessible by the one or more RSRVs from the at least one track layout, and wherein the each of the one or more buffer spots is configured to temporarily hold one of the storage units thereon.

13. The multi-zone automated storage and retrieval system of claim 12, wherein at least one of the one or more buffer spots is positioned proximal to a respective one of the one or more portals.

14. The multi-zone automated storage and retrieval system of claim 12, wherein the one or more buffer spots comprise a plurality of buffer spots, wherein at least one of the buffer spots is positioned in each of the first storage zone and the second storage zone.

15. The multi-zone automated storage and retrieval system of claim 12, further comprising a computerized control system in operable communication with the one or more RSRVs, wherein the computerized control system comprises a network interface coupled to a communication network, at least one processor coupled to the network interface, and a non-transitory, computer-readable storage medium communicatively coupled to the at least one processor, wherein the non-transitory, computer-readable storage medium is configured to store computer program instructions, which when executed by the at least one processor, cause the at least one processor to:
as part of a retrieval task associated with the second storage zone requiring retrieval of a targeted one of the storage units stored in the second storage zone:
assign the retrieval task associated with the second storage zone to a first one of the one or more RSRVs selected from among the one or more RSRVs located in the first storage zone; and
issue commands to the selected first one of the one or more RSRVs to:
travel into the second storage zone via one of the one or more portals opening thereinto from the first storage zone; and
during the travel, prior to entering the second storage zone through the one of the one or more portals, drop off one of the storage units currently carried on the selected first one of the one or more RSRVs at one of the one or more buffer spots in the first storage zone.

16. The multi-zone automated storage and retrieval system of claim 15, wherein the computer program instructions, which when executed by the at least one processor of the computerized control system, further cause the at least one processor to:
in additional steps of the retrieval task associated with the second storage zone, further issue commands to the selected first one of the one or more RSRVs to:
upon entry into the second storage zone, pick up a buffered one of the storage units from one of the one or more buffer spots in the second storage zone;
travel from the one of the one or more buffer spots in the second storage zone toward an access location in the second storage zone from which the targeted one of the storage units stored in the second storage zone is retrievable; and
prior to retrieving the targeted one of the storage units at the access location, deposit the picked up one of the storage units into an available one of the storage locations in the second storage zone.

17. The multi-zone automated storage and retrieval system of claim 16, wherein the computer program instructions, which when executed by the at least one processor of the computerized control system, further cause the at least one processor to select the available one of the storage locations in the second storage zone from among any of the storage locations available upstream and positioned en route from the one of the one or more buffer spots in the second storage zone to the access location, and/or any of the storage locations available downstream and positioned en route from the access location to an exit one of the one or more portals.

18. The multi-zone automated storage and retrieval system of claim 15, wherein the computer program instructions, which when executed by the at least one processor of the computerized control system, further cause the at least one processor to:
complete the retrieval task associated with the second storage zone by issuing commands to the selected first one of the one or more RSRVs to retrieve the targeted one of the storage units stored in the second storage zone and perform delivery of the targeted one of the storage units to a workstation to facilitate picking of product from the targeted one of the storage units at the workstation;
subsequent to the completion of the retrieval task associated with the second storage zone and picking of the product from the targeted one of the storage units carried by the selected first one of the one or more RSRVs, issue commands to one of: the selected first one of the one or more RSRVs and a different one of the one or more RSRVs, to deposit the targeted one of the storage units onto one of the one or more buffer spots in the second storage zone and then exit the second storage zone; and
as part of a subsequent retrieval task associated with the second storage zone and assigned to a second one of the one or more RSRVs selected from the selected first one of the one or more RSRVs and a different one of the one or more RSRVs, to retrieve another targeted one of the storage units stored in the second storage zone, issue commands to the second one of the one or more RSRVs to:
enter the second storage zone;
pick up the deposited one of the storage units from the one of the one or more buffer spots in the second storage zone;
travel from the one of the one or more buffer spots in the second storage zone toward an access location in the second storage zone from which the another targeted one of the storage units is retrievable; and
prior to retrieving the another targeted one of the storage units at the access location, deposit the picked up one of the storage units from the one of the one or more buffer spots in the second storage zone into an available one of the storage locations in the second storage zone.

19. The multi-zone automated storage and retrieval system of claim 18, wherein the computer program instructions, which when executed by the at least one processor of the computerized control system, further cause the at least one processor to select the available one of the storage locations in the second storage zone from among any of the storage locations available upstream and positioned en route from the one of the one or more buffer spots in the second storage zone to the access location, and/or any of the storage locations available downstream and positioned en route from the access location to an exit one of the one or more portals.

20. The multi-zone automated storage and retrieval system of claim 1, further comprising a computerized control system in operable communication with the one or more RSRVs, wherein the computerized control system comprises a network interface coupled to a communication network, at least one processor coupled to the network interface, and a non-transitory, computer-readable storage medium communicatively coupled to the at least one processor, wherein the non-transitory, computer-readable storage medium is configured to store computer program instructions, which when executed by the at least one processor, cause the at least one processor to assign a task of depositing an unneeded one of the storage units stored in the second storage zone into one of the storage locations in the second group, to one of the one or more RSRVs that is assigned to retrieve a needed one of the storage units stored in the second storage zone from the second group of the storage locations.

21. The multi-zone automated storage and retrieval system of claim 1, further comprising a computerized control system in operable communication with the one or more RSRVs, wherein the computerized control system comprises a network interface coupled to a communication network, at least one processor coupled to the network interface, and a non-transitory, computer-readable storage medium communicatively coupled to the at least one processor, and wherein the second storage zone is characterized by a harsher operating environment for the one or more RSRVs than the first storage zone, and wherein the non-transitory, computer-readable storage medium is configured to store computer program instructions, which when executed by the at least one processor, cause the at least one processor to, during selection of one of the one or more RSRVs to assign to any retrieval task associated with the second storage zone, prioritize the one or more RSRVs of a longer absence from the second storage zone over the one or more RSRVs of a more recent presence in the second storage zone.

22. The multi-zone automated storage and retrieval system of claim 21, wherein the computer program instructions, which when executed by the at least one processor of the computerized control system, further cause the at least one processor to record an exit time at which any of the one or more RSRVs last exited the second storage zone, and during the selection of the one of the one or more RSRVs for the any retrieval task associated with the second storage zone, compare exit times of the one or more RSRVs for prioritizing the one or more RSRVs of the longer absence from the second storage zone over the one or more RSRVs of the more recent presence in the second storage zone.

23. The multi-zone automated storage and retrieval system of claim 1, wherein the at least one barrier isolating the second storage zone from the first storage zone comprises an upright barrier wall separating the first storage zone and the second storage zone, and wherein the one or more connective track segments span through the one or more portals from one side of the upright barrier wall to another side of the upright barrier wall.

24. The multi-zone automated storage and retrieval system of claim 1, wherein the at least one track layout is positioned above the storage locations, and wherein the second storage zone comprises an enclosed attic space positioned above the at least one track layout and isolated from the first storage zone.

25. The multi-zone automated storage and retrieval system of claim 24, wherein the enclosed attic space is delimited by boundary walls of the second storage zone, wherein at least one of the boundary walls is separate and discrete from building walls of a facility that accommodates the multi-zone automated storage and retrieval system, and wherein the enclosed attic space is isolated from the first storage zone and from a surrounding space of the facility.

26. The multi-zone automated storage and retrieval system of claim 25, wherein the boundary walls of the enclosed attic space are separate and discrete from the building walls of the facility.

27. The multi-zone automated storage and retrieval system of claim 25, wherein the boundary walls are mounted to frame members of a gridded storage structure of the multi-zone automated storage and retrieval system that delimits the second group of the storage locations.

28. The multi-zone automated storage and retrieval system of claim 24, wherein the first storage zone is free of the enclosed attic space and is open to a surrounding environment of the facility that accommodates the multi-zone automated storage and retrieval system.

29. The multi-zone automated storage and retrieval system of claim 24, further comprising environmental control equipment mounted in the enclosed attic space of the second storage zone.

30. The multi-zone automated storage and retrieval system of claim 1, wherein the storage locations are arranged in storage columns configured to receive the placement of the storage units therein, and wherein the one or more RSRVs are configured to travel on the at least one track layout between access locations at which different storage columns are accessible by the one or more RSRVs to deposit and retrieve the storage units into and from the storage columns.

31. The multi-zone automated storage and retrieval system of claim 30, wherein the access locations comprise unoccupied access shafts around which the storage columns are clustered and through which the one or more RSRVs are configured to travel to access multiple levels of the storage columns, wherein each of the unoccupied access shafts is neighbored by at least one of the storage columns to and from which the storage units are placeable and retrievable by the one or more RSRVs from within the each of the unoccupied access shafts.

32. The multi-zone automated storage and retrieval system of claim 1, wherein the storage units containing product inventory are received at a receiving facility on a transport vehicle from a supply facility and automatically inducted into the multi-zone automated storage and retrieval system (ASRS) at the receiving facility, and wherein the multi-zone ASRS is of a type compatible with a predetermined type of each of the storage units, and wherein the storage units containing the product inventory are exchanged for outgoing storage units from the receiving facility, thereby loading the outgoing storage units onto the transport vehicle for transit from the receiving facility, and wherein both the storage units containing the product inventory and the outgoing storage units are of the same predetermined type compatible with the multi-zone ASRS of the receiving facility.

33. A computer-implemented method for controlling operation of robotic storage/retrieval vehicles (RSRVs) in a multi-zone automated storage and retrieval system (ASRS), the multi-zone ASRS comprising a plurality of storage locations configured to accommodate placement and storage of storage units therein, a first storage zone comprising a first group of the storage locations, and a second storage zone isolated from the first storage zone and comprising a second group of the storage locations, the method employing a computerized control system in operable communication with the RSRVs, wherein the computerized control system comprises a network interface coupled to a communication network, at least one processor coupled to the network interface, and a non-transitory, computer-readable storage medium communicatively coupled to the at least one processor, wherein the non-transitory, computer-readable storage medium is configured to store computer program instructions, which when executed by the at least one processor, cause the at least one processor to:
for a deposit process in the second storage zone involving a deposit of a first one of the storage units in the second storage zone to a first one of the storage locations in the second storage zone, divide the deposit process into a first entrance task of carrying the first one of the storage units into the second storage zone and a second placement task of placing the first one of the storage units into the first one of the storage locations;
assign the first entrance task and the second placement task to a first RSRV and a second RSRV respectively, selected from among the RSRVs positioned outside the second storage zone; and
issue commands to the first RSRV and the second RSRV to execute the first entrance task and the second placement task.

34. The computer-implemented method of claim 33, wherein the first entrance task comprises a drop-off of the first one of the storage units in the second storage zone by the first RSRV, and a prompt exit of the first RSRV from the second storage zone after the drop-off.

35. The computer-implemented method of claim 34, wherein the drop-off performed by the first RSRV in the first entrance task comprises placement of the first one of the storage units at a buffer spot in the second storage zone for later retrieval of the first one of the storage units from the buffer spot by the second RSRV.

36. The computer-implemented method of claim 33, wherein the computer program instructions, which when executed by the at least one processor, cause the at least one processor to assign a retrieval task associated with the second storage zone to the second RSRV, wherein the retrieval task comprises retrieving a second one of the storage units from a second one of the storage locations in the second storage zone, and wherein the second one of the storage locations from which to retrieve the second one of the storage units is selected from among any of the storage locations available upstream and positioned en route from a buffer spot in the second storage zone to the second one of the storage locations in the second storage zone, and/or any of the storage locations available downstream and positioned en route from the second one of the storage locations in the second storage zone to an exit portal of the second storage zone.

37. The computer-implemented method of claim 33, wherein the second storage zone is characterized by a harsher operating environment for the RSRVs than the first storage zone.

38. The computer-implemented method of claim 33, wherein the second storage zone is a cooled storage zone having a lower environmental operating temperature than the first storage zone.

39. A computer-implemented method for controlling operation of robotic storage/retrieval vehicles (RSRVs) in a multi-zone automated storage and retrieval system (ASRS), the multi-zone ASRS comprising a plurality of storage locations configured to accommodate placement and storage of storage units therein, a first storage zone comprising a first group of the storage locations, and a second storage zone isolated from the first storage zone and comprising a second group of the storage locations, the method employing a computerized control system in operable communication with the RSRVs, wherein the computerized control system comprises a network interface coupled to a communication network, at least one processor coupled to the network interface, and a non-transitory, computer-readable storage medium communicatively coupled to the at least one processor, wherein the non-transitory, computer-readable storage medium is configured to store computer program instructions, which when executed by the at least one processor, cause the at least one processor to:
(a) assign a retrieval task associated with the second storage zone to a first RSRV selected from among the RSRVs positioned outside the second storage zone;
(b) issue commands to the first RSRV to:
travel into the second storage zone;
retrieve a first one of the storage units from a first one of the storage locations in the second storage zone; and
exit the second storage zone and carry the first one of the storage units to a workstation positioned outside the second storage zone; and
(c) after performance of one of product placement to and product extraction from the first one of the storage units at the workstation, command one of the first RSRV and a different one of the RSRVs to transport the first one of the storage units from the workstation back into the second storage zone, and to drop off the first one of the storage units at a buffer spot in the second storage zone that is distinct from the storage locations of the second storage zone.

40. The computer-implemented method of claim 39, wherein the computer program instructions, which when executed by the at least one processor, further cause the at least one processor to issue commands to the one of the first RSRV and the different one of the RSRVs to promptly exit the second storage zone after dropping off the first one of the storage units at the buffer spot in the second storage zone.

41. The computer-implemented method of claim 39, wherein the computer program instructions, which when executed by the at least one processor, further cause the at least one processor to issue commands to another one of the RSRVs to enter the second storage zone from the first storage zone, pick up the first one of the storage units from the buffer spot in the second storage zone, and deposit the first one of the storage units into one of the storage locations in the second storage zone.

42. The computer-implemented method of claim 41, wherein the computer program instructions, which when executed by the at least one processor, further cause the at least one processor to issue commands to the another one of the RSRVs to, after depositing the first one of the storage units into the one of the storage locations in the second storage zone, retrieve a second one of the storage units from a second one of the storage locations in the second storage zone different from that in which the first one of the storage units was deposited.

43. The computer-implemented method of claim 42, wherein the computer program instructions, which when executed by the at least one processor, further cause the at least one processor to select the one of the storage locations in the second storage zone into which to deposit the first one of the storage units from among any of the storage locations in the second storage zone available upstream and positioned en route from the buffer spot to the second one of the storage locations in the second storage zone from which the second one of the storage units is to be retrieved, and any of the storage locations available downstream and positioned en route to an exit of the second storage zone from the second one of the storage locations from which the second one of the storage units is to be retrieved.
